(19) United States
(12) Patent Application Publication
(10) Pub. No.: US 2007/0086732 A1
(43) Pub. Date: Apr. 19, 2007

(54) INFORMATION STORAGE MEDIUM, INFORMATION RECORDING METHOD, INFORMATION PLAYBACK METHOD, INFORMATION RECORDING APPARATUS, AND INFORMATION PLAYBACK APPARATUS

(76) Inventors: Shinichi Kikuchi, Kawasaki-shi (JP); Masahiro Nakashika, Kawasaki-shi (JP); Yasufumi Tsumagari, Yokohama-shi (JP); Hiroyuki Kamio, Tachikawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/562,801

(22) Filed: Nov. 22, 2006

Related U.S. Application Data
(63) Continuation of application No. 11/157,914, filed on Jun. 22, 2005.

(30) Foreign Application Priority Data
Jun. 23, 2004 (JP) 2004-185343

(51) Int. Cl. H04N 7/00

(52) U.S. Cl. 386/95

(57) ABSTRACT

A recordable/reproducible disc has a management area and data area. This data area separately records data of a digital stream signal as one or more objects. The management area is configured to record prescribed management information, which includes object management information and playback order management information. In this configuration, the management area is configured to have marker information independently of the playback order management information.

### CROSS-REFERENCE TO RELATED APPLICATIONS

This application is based upon and claims the benefit of priority from prior Japanese Patent Application No. 2004-185343, filed Jun. 23, 2004, the entire contents of which are incorporated herein by reference.

### BACKGROUND OF THE INVENTION

1. Field of the Invention

The present invention relates to an information storage medium (or data structure), an information recording/playback method, and an information recording/playback apparatus, which are suited to record/play back a digital stream signal used in digital TV broadcast or the like.

2. Description of the Related Art

In recent years, TV broadcast has entered the era of digital broadcasts having programs of high-definition AV information as principal broadcast contents. The current digital broadcast (and nascent terrestrial digital broadcast) adopts an MPEG2 transport stream (to be abbreviated as MPEG-TS hereinafter). In the field of digital broadcast using moving pictures, MPEG-TS will be used as a standard format in the future. At the start of such digital TV broadcast, market needs for a streamer that can directly record digital TV broadcast contents are increasing.

As an example of a streamer that utilizes an optical disc such as a DVD-RAM or the like, “a recording/playback apparatus” (Jpn. Pat. Appln. KOKAI Publication No. 6-225239) is known. Also, as an example of an apparatus that can record entry points in the recording contents, Jpn. Pat. Appln. KOKAI Publication No. 2000-322875 is known.

Different digital broadcast schemes are adopted in respective countries and broadcast stations: for example, DVB (Digital Video Broadcasting) in Europe; ATSC (Advanced Television Systems Committee) in U.S.A.; and ARIB (Association of Radio Industries and Businesses) in Japan.

In DVB, the video format is MPEG2, the resolutions are 1152*1440i, 1080*1920(i, p), 1035*1920, 720*1280, (576, 480)*(720, 544, 480, 352), and (288, 240)*352, the frame frequencies are 30 Hz and 25 Hz, the audio format includes MPEG-1 audio and MPEG-2 Audio, and the sampling frequencies are 32 kHz, 44.1 kHz, and 48 kHz.

In ATSC, the video format is MPEG2, the resolutions are 1080*1920(i, p), 720*1280p, 480*704(i, p), and 480*640(i, p), the frame frequencies are 23.976 Hz, 24 Hz, 29.97 Hz, 30 Hz, 59.94 Hz, and 60 Hz, the audio format includes MPEG1 Audio Layer 1 & 2 (DirecTV) and AC3 Layer 1 & 2 (Primstar), and the sampling frequencies are 48 kHz, 44.1 kHz, and 32 kHz.

In ARIB, the video format is MPEG2, the resolutions are 1080i, 720p, 480i, and 480p, the frame rates are 29.97 Hz and 59.94 Hz, the audio format includes AAC (MPEG-2 Advanced Audio Coding), and the sampling frequencies are 48 kHz, 44.1 kHz, 32 kHz, 24 kHz, 22.05 kHz, and 16 kHz.

In this manner, streams to be decoded by the apparatus side have many different variations for respective areas, and if all these variations are supported, the arrangement of a recording/playback apparatus (e.g., a DVD recorder) becomes considerably heavy (or complicated). As a result, the apparatus cost increases.

Also, various other broadcast formats may still emerge, and actual device (recorder) design cannot support all such formats. For this reason, a recorder must select and equip certain broadcast formats that it can support. Hence, a broadcast format which is not assumed cannot often be recorded as an uncognizable stream.

Furthermore, when the storage size of the storage medium becomes large, a long period of time is required to view the recorded title. Hence, user's convenience upon viewing the title is of utmost importance. Also, as for stream signals, when various formats or types are mixed, attribute information, identification information, and the like for various formats or types are required.

In case of an apparatus which records a digital stream signal transmitted via a communication means, the following problems may occur. That is, when a recorded signal is played back and is noisy, it cannot often be determined whether a playback apparatus has a trouble or the recorded signal itself has existing noise. Such case may invite user's misunderstanding.

As a recent use method of a recorder, markers (entry points) are put for respective commercial messages or at predetermined time intervals, and are used as references of skip processes upon playback or those for edit processes in many examples. For example, with increasing importance of markers, the use frequency of markers increases and the number of markers used per title increases.

### BRIEF SUMMARY OF THE INVENTION

An information storage medium according to an embodiment of the present invention (100 in FIG. 1) is configured to record a predetermined digital stream signal (141 in FIG. 1). In this medium (recordable/reproducible optical disc), the information storage medium has a management area (130 in FIG. 1) and data area (133 in FIG. 1, etc.). The data area (133) can record data of the digital stream signal separately as one or more objects (141). The management area (130) is configured to record predetermined management information (HDVR_MG in FIGS. 4 and 7, HDVR_MG in FIG. 30, etc.). The management information includes object management information (ESOBI in FIGS. 2 and 11, etc.) and playback order management information (EX_ORG_PGCI/EX_UD_PGCI in FIG. 30, EX_PGCI in FIG. 31, etc.). In such configuration, the management area (130) is configured to have marker (entry point) information (EPIT in FIG. 30, etc.) independently of the playback order management information (EX_PGCI).

More specifically, even when entry point information (EPI) is set at the end in management information as a table (EPIT) independently of the playback order management information (PGCI) to add an entry point (EP), such addition does not influence other areas (other kinds of management information need not be rewritten due to addition of an EP).

In order to support recording/playback of stream signals, EPI, resume mark information indicating playback start information after pausing, and packet identification information (PID) of a stream to be played back as representative picture information can be set.

Also, stream management information can be generated in a PTM base in case of a cognizable stream (TYPE A), or a PATS (packet arrival time stamp) base in case of an uncognizable stream (TYPE B).

Marker (entry point) information (EPI) can be freely generated and added irrespective of the playback management information (PGCI).

Even when stream signals of various formats or types are mixed, they can be easily managed.

### BRIEF DESCRIPTION OF THE SEVERAL VIEWS OF THE DRAWING

FIG. 1 is a view for explaining the data structure according to an embodiment of the present invention;

FIG. 2 is a view for explaining the relationship among a playback management information layer, object management information layer, and object layer in the data structure according to the embodiment of the present invention;

FIG. 3 is a view for explaining the file structure according to the embodiment of the present invention;

FIG. 4 is a view for explaining an example of the configuration of a field (HDVR_MGI) of one management information (HDVR_MG) recorded on AV data management information recording area 130;

FIG. 5 is a view for explaining an example of the configuration of DISC_RSM_MRKI;

FIG. 6 is a view for explaining an example of the configuration of EX_DISC_REP_PICI;

FIG. 7 is a view for explaining an example of the configuration of another field (EX_PL_SRPT) of one management information (HDVR_MG) in the data structure according to the embodiment of the present invention;

FIG. 8 is a view for explaining an example of the configuration of another field (M_AVFIT) of one management information (HDVR_MG) in the data structure according to the embodiment of the present invention;

FIG. 9 is a view for explaining an example of the configuration of RVOB_TMAPI;

FIG. 10 is a view for explaining an example of the configuration of ESTR_FI;

FIG. 11 is a view for explaining an example of the configuration of SFI file HR_SFIxx.IFO included in a DVD_HDVR directory;

FIG. 12 is a view for explaining an example of the configuration of ESOBI_GI included in ESOBI;

FIG. 13 is a view for explaining various kinds of information included in the ESOBI_GI;

FIG. 14 is a view for explaining an example of the configuration of ESOB_ESI included in the ESOBI;

FIG. 15 is a view for explaining an example of the configuration of ESOB_V_ESI included in the ESOB_ESI and an example of the configuration of video attribute V_ATTR included in this ESOB_V_ESI;

FIG. 16 is a view for explaining an example of the configuration of ESOB_A_ESI included in the ESOB_ESI and an example of the configuration of audio attribute AUDIO_ATTR included in this ESOB_A_ESI;

FIG. 17 is a view for explaining an example of the configuration of ESOB_OTHER_ESI included in the ESOB_ESI;

FIG. 18 is a view for explaining another example of the configuration of copy control information (copyright protection information) CP_CTL_INFO included in the ESOB_OTHER_ESI;

FIG. 19 is a view for explaining an example of the configuration of DCNI included in the ESOBI;

FIG. 20 is a view for explaining an example of the configuration of ESOB_TMAP (TYPE A);

FIG. 21 is a view for explaining an example of the configuration of ASOB_TMAP (TYPE B);

FIG. 22 is a view for explaining an example of the configuration of time map file HR_VTMAP.IFO/HR_STMAPx.IFO included in the DVD_HDVR directory;

FIG. 23 is a view for explaining an example of the configuration of EX_VTMAPTI and the like;

FIG. 24 is a view for explaining an example of the configuration of the contents of RVOBU_ENT;

FIG. 25 is a view for explaining an example of the configuration of TYPE A of STMAPTI;

FIG. 26 is a view for explaining an example of the configuration of TYPE B of STMAPTI;

FIG. 27 is a view for explaining an example of the configuration of ES_TMAP_GI and ES_TMAPI;

FIG. 28 is a view for explaining an example of the configuration of the contents of ESOBU_ENT (TYPE A);

FIG. 29 is a view for explaining an example of the configuration of the contents of ESOBU_ENT (TYPE B);

FIG. 30 is a view for explaining an example of the configuration of PGC information (ORG_EX_PGC information and EX_playlist information/UD_EX_PGCT information) included in HDVR_MG;

FIG. 31 is a view for explaining an example of the configuration of EX_PGC information;

FIG. 32 is a view for explaining an example of the configuration of EX_CELL information (EX_CI);

FIG. 33 is a view for explaining an example of the configuration of EPIT information;

FIG. 34 is a view for explaining another example of the configuration of EPIT information;

FIG. 35 is a view for explaining still another example of the configuration of EPIT information;

FIG. 36 is a view for explaining yet another example of the configuration of EPIT information;

FIG. 37 is a view for explaining an example of the configuration of a data unit (ESOBU) for a stream object shown in FIG. 1 or 2;

FIG. 38 is a view for explaining an example of the configuration of PKT_GRP_GI included in a packet group header;

FIG. 39 is a view for explaining an example of the configuration of each copy control information CCI included in DCI_CCI;

FIG. 40 is a view for explaining an example of the configuration of FIRST_PATS_EXT;

FIG. 41 is a view for explaining an example of the configuration of manufacturer's management information (MNI);

FIG. 42 is a block diagram for explaining an example of an apparatus for recording and playing back AV information (digital TV broadcast program and the like) on and from an information storage medium (optical disc, hard disc, or the like) using the data structure according to the embodiment of the present invention;

FIG. 43 is a flowchart (overall operation process flow) for explaining an example of the overall operation of the recording/playback apparatus (recorder);

FIG. 44 is a flowchart (edit operation process flow) for explaining an example of an edit process (ST28);

FIG. 45 is a flowchart for explaining an example of a video recording operation (part 1) of the recording/playback apparatus;

FIG. 46 is a flowchart for explaining an example of a video recording operation (part 2) of the recording/playback apparatus;

FIG. 47 is a flowchart (buffer fetch process flow) for explaining an example of a buffer fetch process (ST130);

FIG. 48 is a flowchart for explaining a PKT_GRP_GI process (ST1329);

FIG. 49 is a flowchart (ESI setting process flow) for explaining a stream information (ESI) generation process (ST120);

FIG. 50 is a flowchart (stream file information generation process flow with a GPI setting process and TMAP setting process) for explaining an example of a stream file information (STR_FI) generation process in a video recording end process (ST150);

FIG. 51 is a flowchart for explaining an example the GPI setting process (ST1530);

FIG. 52 is a flowchart for explaining an example the TMAP setting process (ST1540);

FIG. 53 is a flowchart for explaining an RVOB/ESOB structure setting process (ST15400);

FIG. 54 is a flowchart for explaining a CP_CTL_INFO generation process (ST1220);

FIG. 55 is a flowchart (program setting process flow) for explaining an example of a program chain (PGC) generation process (including a program setting process) in the video recording end process (ST150);

FIG. 56 is a flowchart (overall playback operation flow) for explaining an example of a playback operation of the apparatus;

FIG. 57 is a flowchart for explaining a decoder setting process (ST217);

FIG. 58 is a flowchart for explaining an example (part 1) of a process (ST220) upon cell playback;

FIG. 59 is a flowchart for explaining an example (part 2) of a process (ST220) upon cell playback;

FIG. 60 is a flowchart for explaining an example of a data transfer process (ST2220) from a buffer to a decoder;

FIG. 61 is a flowchart for explaining an example of a reception error process (ST22220);

FIG. 62 is a view for explaining a display example in the reception error process;

FIG. 63 is a flowchart for explaining an example of a GP switching setting process (ST2240);

FIG. 64 is a flowchart for explaining an example of a discontinuity process (ST22230);

FIG. 65 is a flowchart for explaining an example of a SKIP process (ST2250);

FIG. 66 is a flowchart for explaining an example of an EP edit process (ST282A);

FIG. 67 is a view for explaining display in the EP edit process operation;

FIG. 68 is a flowchart for explaining an example of a menu display process; and

FIG. 69 is a view for explaining a screen display example in the menu display process.

### DETAILED DESCRIPTION OF THE INVENTION

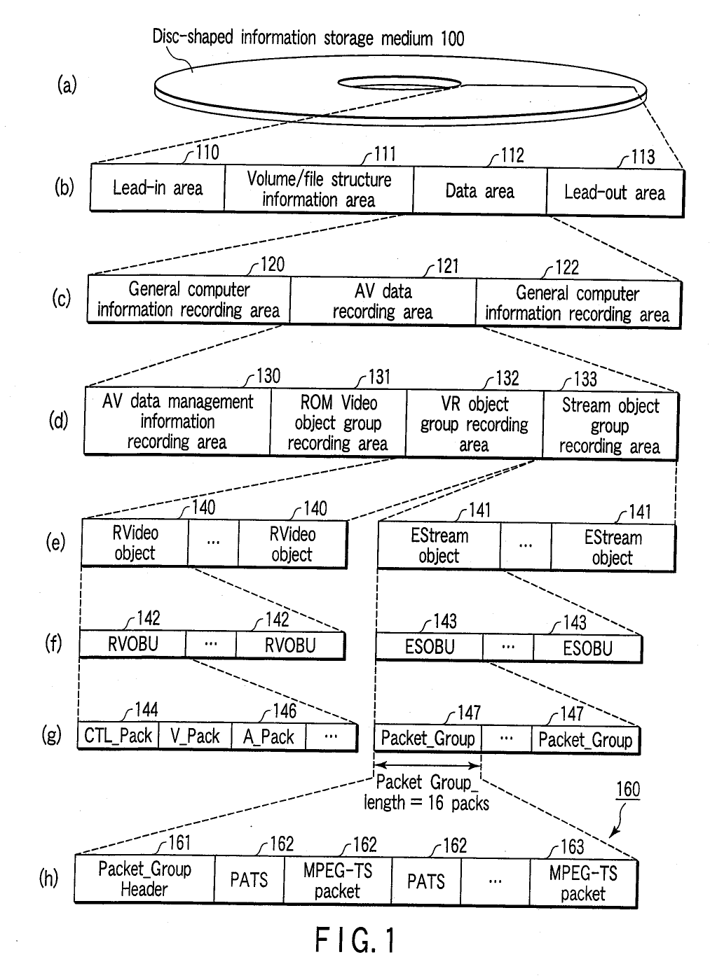

Preferred embodiments of an information storage medium, information recording method, information playback method, information recording apparatus, and information playback apparatus according to the present invention will be described hereinafter with reference to the accompanying drawings. FIG. 1 is a view for explaining the data structure according to an embodiment of the present invention. As disc-shaped information storage medium 100 (FIG. 1(a)), recordable optical discs such as a DVD-RAM, DVD-RW, DVD-R, and the like, and recordable magnetic discs such as a hard disc and the like are available. The following explanation will be given taking an optical disc such as a DVD-RAM or the like using a laser of 405 nm to 650 nm as an example.

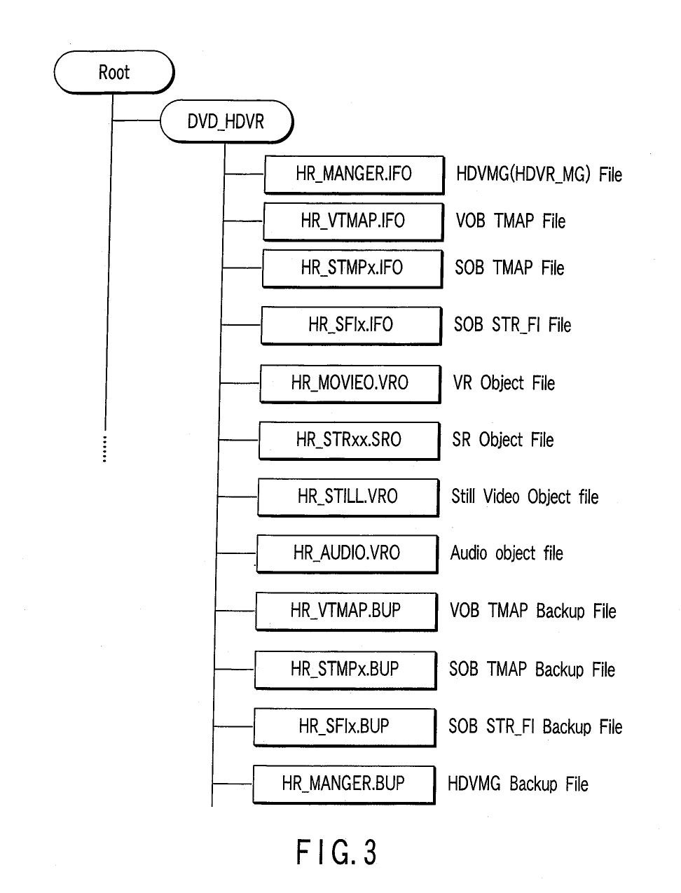

Disc 100 has lead-in area 110, volume/file structure information area 111, data area 112, and lead-out area 113 from its inner periphery side toward the outer periphery side (FIG. 1(b)). Volume/file structure information area 111 stores a file system. The file system includes information indicating the recording locations of files (to be described later with reference to FIG. 3). Recorded contents are stored in data area 112 (FIG. 1(c)).

Data area 112 is divided into areas 120 that record general computer data, and area 121 that records AV data. AV data recording area 121 includes AV data management information area 130 that stores a file (VMG file) used to manage AV data, ROM video object group recording area 131 that records read-only video object data, VR object group recording area 132 that records object data (RVOBS) files (VRO files) complying with the video recording standard, and Stream object group recording area 133 that records stream objects (ESOBS: Extended Stream Object Stream) compatible to digital broadcast (FIG. 1(d)). In this embodiment, stream objects of digital broadcast are recorded as stream objects (ESOBS) 141 as files independent from VR objects (FIG. 1(e)).

Each stream object 141 is formed of one or more data units (ESOBU: Extended Stream OBject Unit) 143 each of which serves as an access unit to disc 100 (FIG. 1(f)). Note that one ESOBU is a data unit delimited by pictures at given time intervals which are designated by a value in object management information. Alternatively, one ESOBU may be a data unit delimited by one or more GOPs. Each data unit (ESOBU) 143 includes one or more pack groups (Packet Group) 147, each of which includes a group of a plurality of TS packets (FIG. 1(g)).

In this embodiment, each packet group 147 includes, e.g., a group of 16 packs (or 16 LBs (Logical Blocks)). If one pack size (or one LB size) is 2 kbytes, the size of each packet group 140 is 32 kbytes. This size is equal to the ECC block size in the video recording standard.

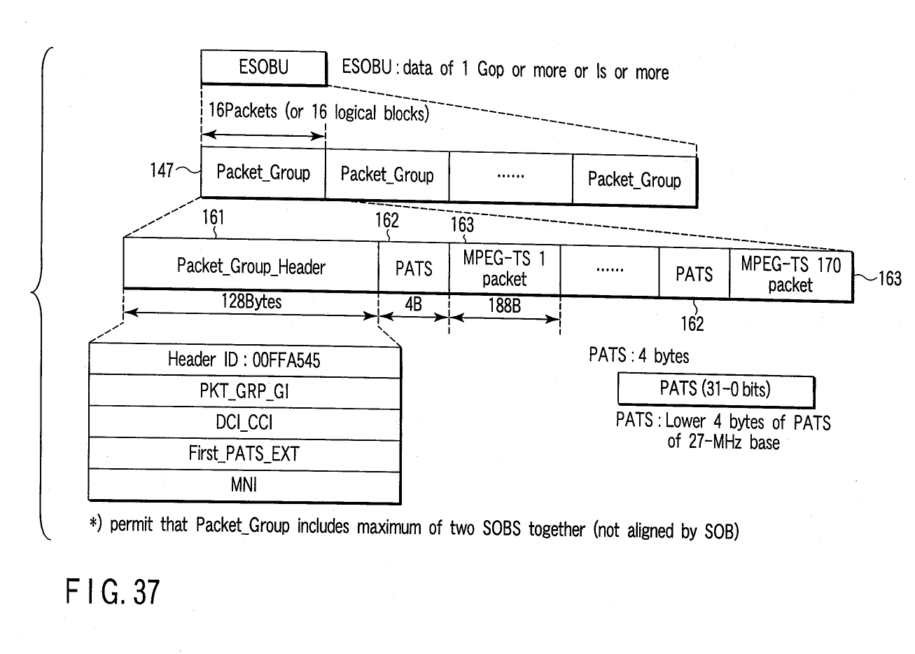

Each packet group 147 forms packet recording area (DVD-TS packet recording area) 160 in stream recording (SR) (FIG. 1(h)). DVD-TS packet recording area 160 can be formed of packet group header 161, and a plurality of pairs (e.g., 170 pairs) of packet arrival time information (PAT) 163 and MPEG-TS packets 162 (FIG. 1(h)). The contents of packet group 147 will be described in detail later with reference to FIG. 37.

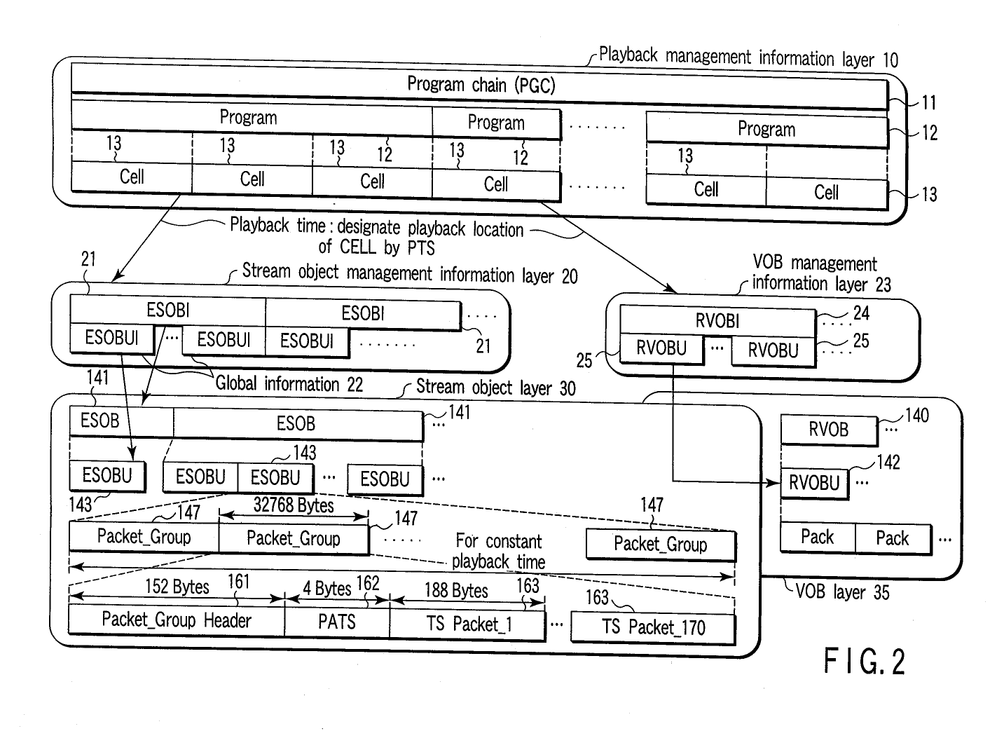

FIG. 2 is a view for explaining the relationship among a playback management information layer, object management information layer, and object layer in the data structure according to the embodiment of the present invention. Management information (VMG file) recorded on AV data management information recording area 130 in FIG. 1 has playback management information layer 10 used to manage the playback sequences of both the recorded contents based on the video recording standard and the stream recording recorded contents based on the present invention. That is, a group of one or more cells 13 each of which serves as a playback unit of stream-recorded objects form program 12, and a group of one or more cells 13 each of which serves as a playback unit of video-recorded objects form another program 12. A sequence (playback sequence) of these programs 12 is managed by management information (PGCI) of program chain (PGC) 11.

Even when the user wants to start playback from the middle of either cell 13 on the stream recording side or cell 13 on the video recording side, he or she can designate the playback location using a playback time (PTS). That is, when playback is to start from the middle of cell 13 on the stream recording side using the playback time (PTS), stream object ESOB 141 in stream object layer 30 is designated via stream object information ESOBI 21 in stream object management information layer 20, and stream object unit ESOBU 143 in stream object layer 30 is designated via stream object unit information ESOBUI 22 in stream object management information layer 20. When ESOB 141 and its ESOBU 143 are designated, the playback start location is specified. (ESOBUI in this case may be restated as global information 22.)

This ESOBU 143 is formed of one or more packet groups 147. ESOBU 143 is a data unit corresponding to, e.g., 1 or more GOPs. Alternatively, ESOBU 143 may be delimited into units each corresponding to a data size for a given playback time designated by a value in object management information. In this way, overflow of each information field is prevented.

Each packet group 147 includes 16 packs (or 16 LBs) (32768 bytes), and has packet group header 161 at its head position. After packet group header 161, a plurality of pairs (170 pairs in this example) of PAT 163 and TS packets 162 are allocated. These TS packets 162 store stream-recorded contents.

On the other hand, when playback is to start from the middle of cell 13 on the video recording side using the playback time (PTS), video object RVOB 140 in video object layer 35 is designated via video object information RVOBI 24 in video object (RVOB) management information layer 23, and video object unit RVOBU 142 in video object layer 35 is designated via video object unit information RVOBUI 25 in video object management information layer 23. When RVOB 140 and its RVOBU 142 are designated, the playback start location is specified. RVOBU 142 includes a plurality of packs, which store video-recorded contents.

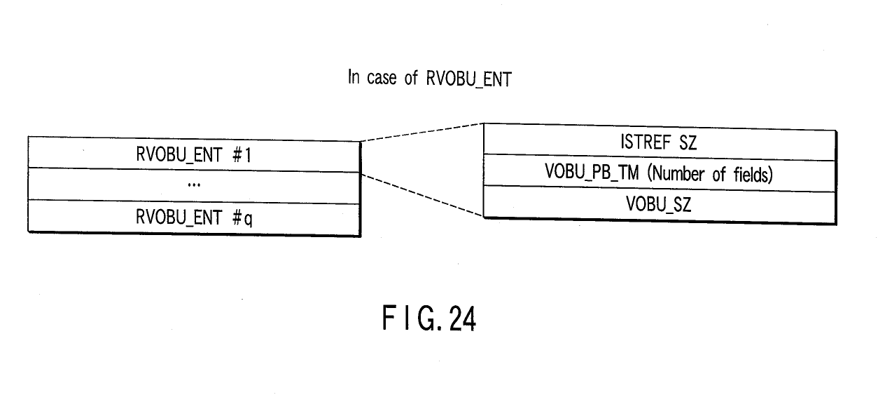

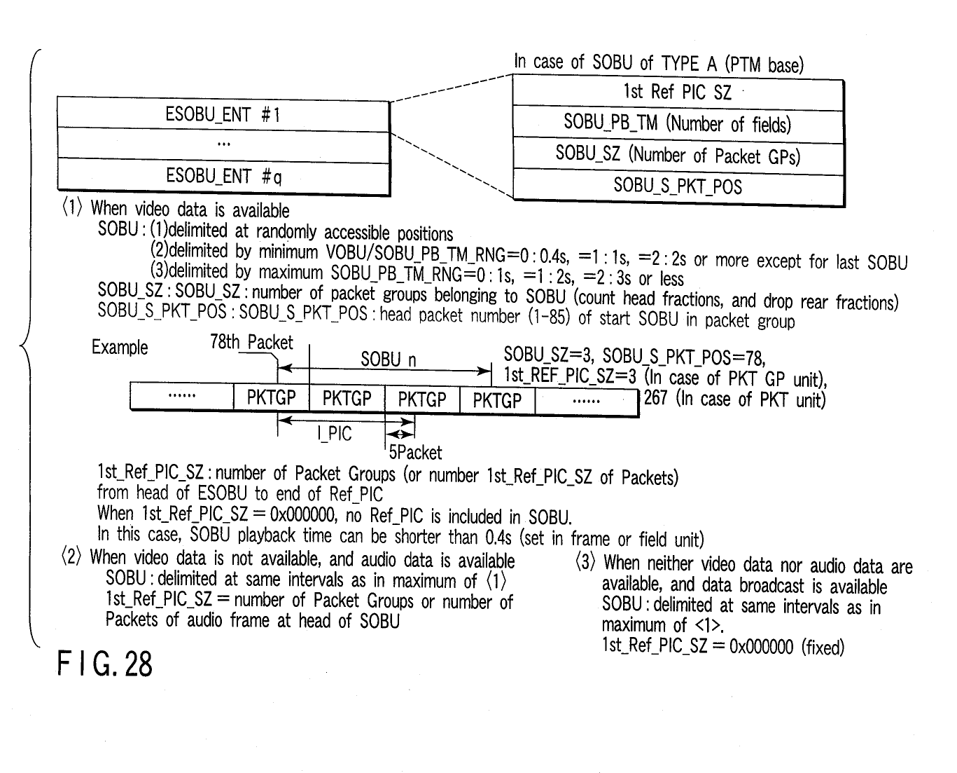

When playback is to start from the middle of cell 13 on the stream recording side, the playback start location can be designated using a time in units of the number of fields by ESOBU_PB_TM (corresponding to SOBU_PB_TM in FIG. 28). On the other hand, when the playback is to start from the middle of cell 13 on the video recording side, the playback start location can be designated by RVOBU_PB_TM (corresponding to SOBU_PB_TM in FIG. 24) in time map information (TMAPI) specified by the video recording standard.

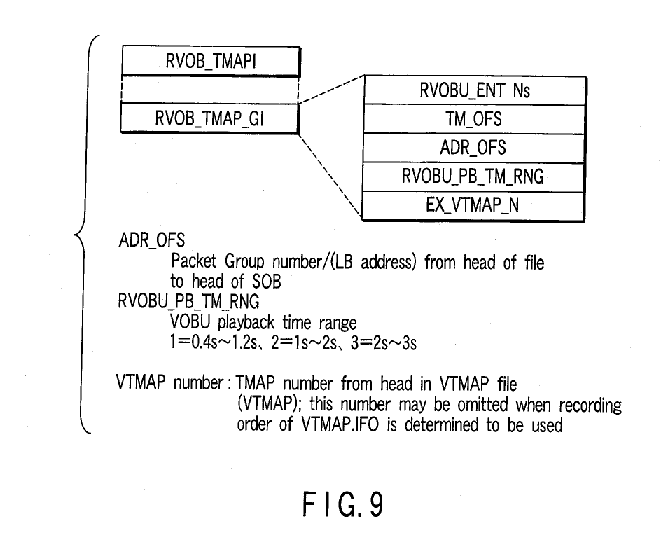

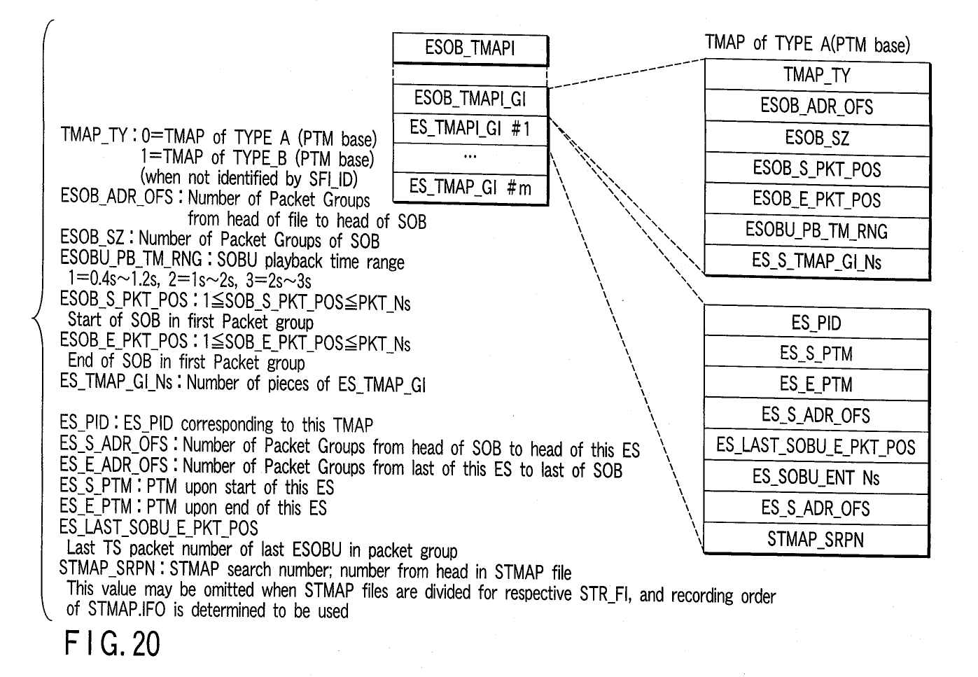

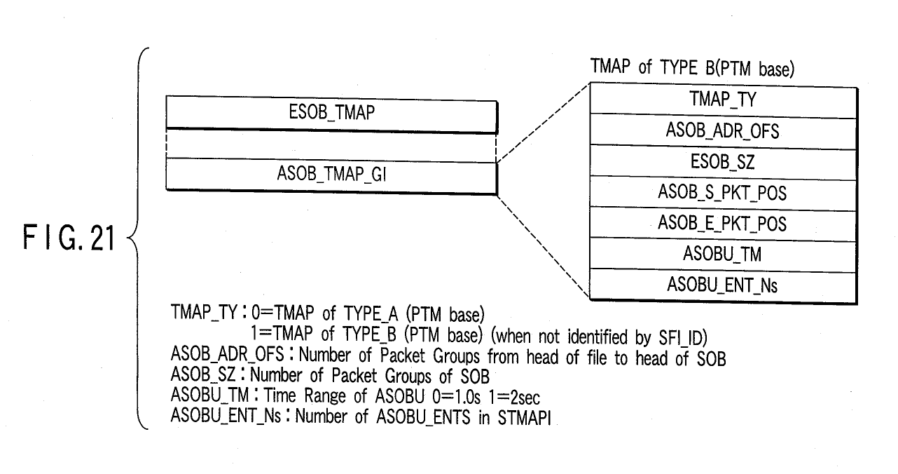

The contents of FIG. 2 can be summarized as follows. That is, the structure of each ESOBU (Extended Stream Object Set) includes one or more ESOB (Stream OBject) data. Each ESOB corresponds to, e.g., one program. This ESOB includes one or more ESOBU (Stream OBject Unit) data, each of which corresponds to object data for a given time interval or one or more GOPs. Note that “a given time interval” corresponds to RVOBU_PB_TM_RNG in FIG. 9 (VR), ESOBU_PB_TM_RNG in FIG. 20 (TYPE A of SR), and ASOBU_TM in FIG. 21 (TYPE B of SR). Note that ASOBU_TM changes depending on the playback time range of RVOBU/ESOBU.

However, when the transfer rate is low, one GOP data cannot often be sent within 1 sec (1 s) (DVD-VR that MPEG-encodes an analog video input inside the apparatus can freely set the data unit configuration since it adopts internal encoding, but digital broadcast cannot specify the next incoming data since encoding is done by a broadcast station). On the other hand, the transfer rate may be high, and I-picture data may be sent frequently. In such case, ESOBU is delimited frequently, and ESOBU management information increases accordingly, thus ballooning the whole management information. For this reason, it is appropriate to delimit ESOBUs according to the embodiment of the present invention by a given time interval (a minimum limitation is to delimit ESOBUs by picture data except for the last ESOBU of the ESOB) or by one or more GOPs.

One ESOBU includes one or more packet groups, each of which is basically formed of 16 packs (one Pack=one sector: 2048-byte size). Each packet group includes a packet group header and (170) TS packets. The arrival time of each TS packet can be detected from PAT 163 which forms a pair with each TS packet 162.

The management information will be described below with reference to FIGS. 3 to 36. FIG. 3 is a view for explaining the file structure according to the embodiment of the present invention. Data in disc 100 in FIG. 1 includes volume/file structure information area 111 which stores a file system, and data area 112 which actually records data files. The file system stored in volume/file structure information area 111 includes information indicating the recording locations of files, as shown in FIG. 3. Data area 112 is divided into areas 120 and 122 that record general computer data, and area 121 that records AV data. AV data recording area 121 includes AV data management information area 130 that stores an HDVMG (or HDVR_MG) file (and its backup file) used to manage recorded AV data, ROM video object group recording area 131 that records object data (VOBS) files complying with the DVD-Video (ROM Video) standard, VR object group recording area 132 that records object data (RVOBS) files (VRO files) complying with the video recording standard, stream object group recording area 133 that records stream objects (ESOBS) compatible to digital broadcast, and the like.

Note that different directories are prepared in correspondence with formats (e.g., VIDEO-TS for DVD-Video (ROM Video) and DVD-RTAV for DVD-RTR (recordable/reproducible DVD), and the digital broadcast compatible DVD standard to be described below is recorded in, e.g., a DVD_HDVR directory.

That is, as shown in FIG. 3, the DVD_HDVR directory records a VMG file (HR_MANGER.IFO and its backup HR_MANGER.BUP) used to manage data, a VRO file (HR_MOVIEO.VRO) as an object file used to record analog AV information such as analog broadcast, analog line input data, and the like, an SRO file (HR_STRMx.SRO; x=0, 1, 2, . . . ) as a digital broadcast object, a still object file (HR_STILL.VRO), and an audio object file (HR_AUDIO.VRO). Note that the SRO file records ESOBS.

In FIG. 3, a time map file (HR_VTMAP.IFO, HD_STMAP.IFO) and its backup file (VR RVOB time map file HR_VTMAP.IFO/HR_VTMAP.BUP and SR ESOB time map file HR_STMAPx.IFO/HR_STMAPx.BUP) as example 1 are also assured as independent files. These files (VR RVOB time map file HR_VTMAP.IFO/HR_VTMAP.BUP and SR ESOB time map file HR_STMAPx.IFO/HR_STMAPx.BUP) can store information of time map table TMAPT (that is, TMAPT can undergo file management independently of other kinds of management information).

As shown in FIG. 3, SR management data is recorded in the HDVMG file common to VR, and undergoes control common to VR. As shown in FIG. 2, SR and VR management data are linked for respective CELLs, and their playback locations can be designated by playback times.

Note that the DVD_HDVR directory can store HR_THNL.DAT (not shown) as a thumbnail (reduced-scale picture) file which can be used in a chapter menu and the like. Furthermore, the DVD_HDVR directory can store an additional text file: HR_TEXT.DAT independent from item text (IT_TXT) (neither of them are shown).

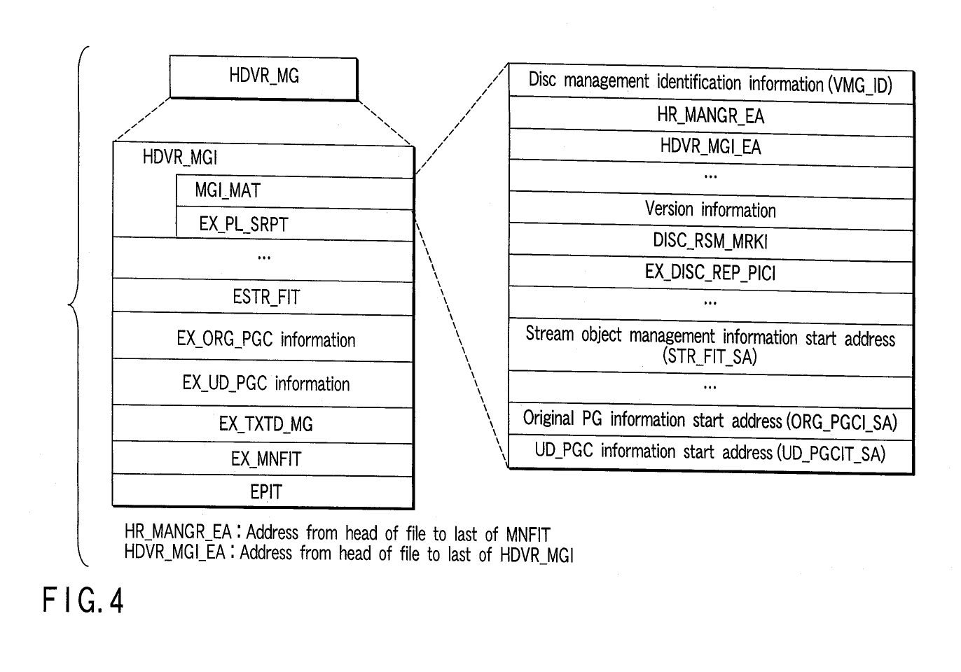

FIG. 4 is a view for explaining an example of the configuration of a field (HDVR_MGI) of one management information (HDVR_MG) recorded on AV data management information recording area 130. Note that stream recording in this embodiment will be abbreviated as SR, and video recording will be abbreviated as VR. Then, management information (ESTR_FIT; Extended Stream File Information Table) of SR data is saved in the HDVR_MG (in HR_MANGER.IFO in FIG. 3), and is managed in the same way as VR data.

The HDVR_MG includes video manager information (HDVR_MGI), a stream file information table (ESTR_FIT), (original) program chain information (EX_ORG_PGC information), playlist information (EX_UD_PGC information), a text data manager (EX_TXTD_MG), a manufacturer information table (EX_MNFIT), and an entry point information table (EPIT) which is located at the end of the file.

In other words, a DVD recorder normally has time map information (TMAPI) as RVOB management information. This information is used to divide object data (RVOB/ESOB) for each data unit (RVOBU/ESOBU) and to implement playback, special playback, and the like for that unit, and one information is required per a maximum of 0.5 s. For this reason, if the disc size increases in the future or a compression method with high compression efficiency is adopted, the number of pieces of time map information TMAPI increases, and complicated management is required when an edit process or the like is made. If this TMAPI is stored in the management information file (HR_MANGER.IFO in FIG. 3), management data in other non-related fields must be moved or rewritten every time TMAPI is changed, resulting in poor efficiency.

Hence, in the embodiment of the present invention, in order to deal with such situation, ESTR_FI and TMAPI are recorded in independent fields (HR_SFIx.IFO, HR_VTMAP.IFO, HD_TMAPx.IFO, and the like in FIG. 3).

Referring to FIG. 4, the HDVR_MGI includes disc management identification information (VMG_ID), version information (VERN), a stream object management information start address (STR_FIT_SA), a program chain information start address (ORG_PGCI_SA), playlist information start address (UD_PGCIT_SA), disc resume information (DISC_RSM_MRKI), representative picture information (EX_DISC_REP_PICI), and the like.

The disc resume information (DISC_RSM_MRKI) is resume information for the entire disc, and is a field for saving interrupt information when playback is interrupted upon playing back all titles by an original program chain (ORG_PGC). Upon next playback, playback is restarted based on this interrupt information.

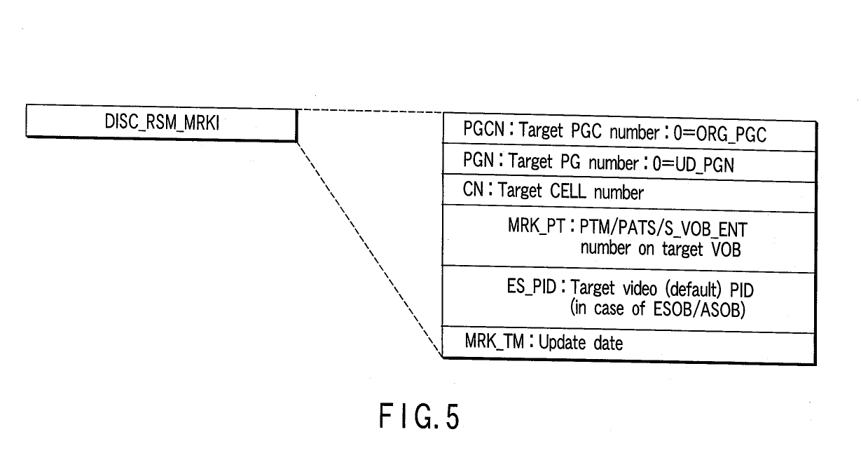

For this purpose, the disc resume information (DISC_RSM_MRKI) sets, as playback start position information, a PGC number (PGCN), PG number (PGN), CELL number (CN), playback time information (MRK_PT), and a packet identifier (ES_PID) or GP number of a video to be played back, as shown in FIG. 5. The disc resume information (DISC_RSM_MRKI) further includes resume mark update date information (MRK_TM).

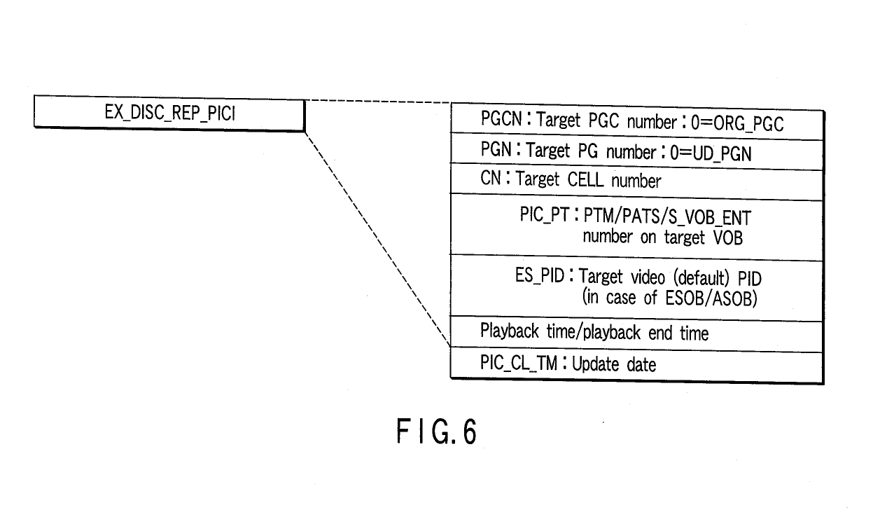

The representative picture information (EX_DISC_REP_PICI) is a representative picture of the disc, and is used to display a menu and the like. For this purpose, the representative picture information (EX_DISC_REP_PICI) sets, as image position information, a PGC number (PGCN), PG number (PGN), CELL number (CN), playback time information (PIC_PT), and a packet identifier (ES_PID) or GP number of a video to be played back, as shown in FIG. 6. The representative picture information (EX_DISC_REP_PICI) further includes its playback point information (playback time/playback end time), and update date information (PIC_CL_TM) of a representative picture generation time. Note that the playback point information can be used to set a duration of playback or a playback end time when a moving picture menu is to be generated.

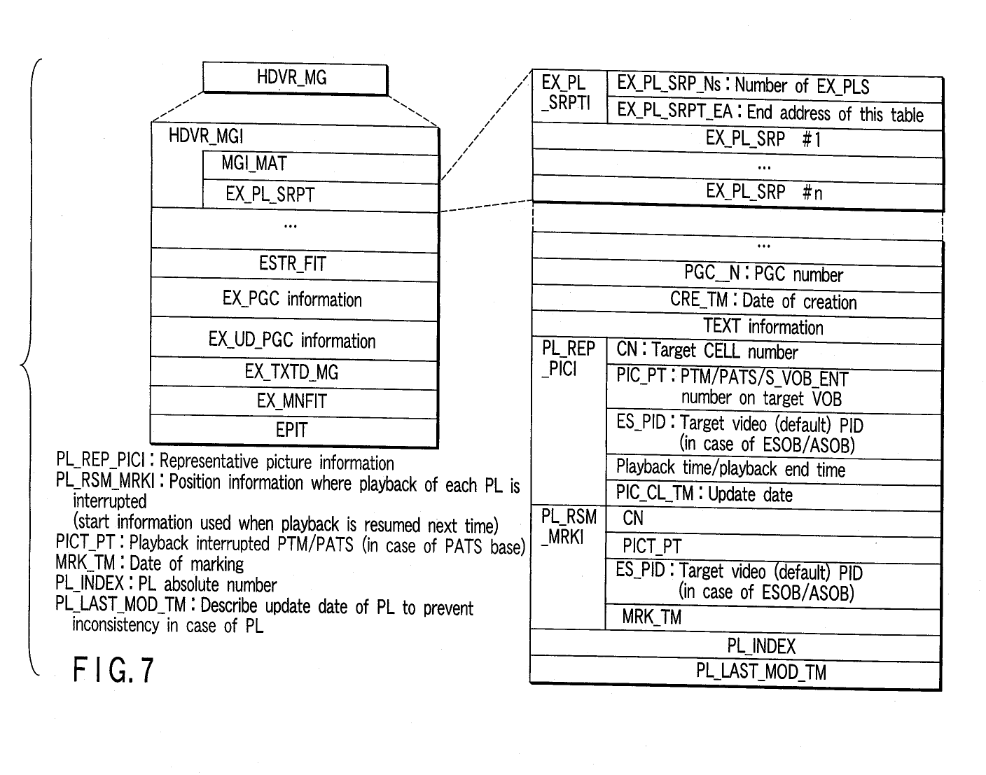

FIG. 7 is a view for explaining an example of the configuration of a playlist search pointer table (EX_PL_SRPT) as another field of one management information (HDVR_MG) in the data structure according to the embodiment of the present invention. As shown in FIG. 7, this EX_PL_SRPT (playlist information) includes resume information (PL_RSM_MRKI) and representative picture information (PL_REP_PICI) for each playlist. The PL resume information (PL_RSM_MRKI) has the same format as the disc resume information (DISC_RSM_MRKI) shown in FIG. 5, but it is set by a Cell number since it is for each PL. The representative picture information (PL_REP_PICI) has the same format as the disc representative picture information (EX_DISC_REP_PICI) in FIG. 6, but it is set by a Cell number since it is for each PL.

Different digital broadcast schemes are adopted in respective countries: for example, DVB (Digital Video Broadcasting) in Europe; ATSC (Advanced Television Systems Committee) in U.S.A.; and ARIB (Association of Radio Industries and Businesses) in Japan. [1] In DVB, the video format is MPEG2, the resolutions are 1152*1440i, 1080*1920(i, p), 1035*1920, 720*1280, (576, 480)*(720, 544, 480, 352), and (288, 240)*352, the frame frequencies are 30 Hz and 25 Hz, the audio format includes MPEG-1 audio and MPEG-2 Audio, and the sampling frequencies are 32 kHz, 44.1 kHz, and 48 kHz. [2] In ATSC, the video format is MPEG2, the resolutions are 1080*1920(i, p), 720*1280p, 480*704(i, p), and 480*640(i, p), the frame frequencies are 23.976 Hz, 24 Hz, 29.97 Hz, 30 Hz, 59.94 Hz, and 60 Hz, the audio format includes MPEG1 Audio Layer 1 & 2 (DirecTV) and AC3 Layer 1 & 2 (Primstar), and the sampling frequencies are 48 kHz, 44.1 kHz, and 32 kHz. [3] In ARIB, the video format is MPEG2, the resolutions are 1080i, 720p, 480i, and 480p, the frame rates are 29.97 Hz and 59.94 Hz, the audio format includes AAC (MPEG-2 Advanced Audio Coding), and the sampling frequencies are 48 kHz, 44.1 kHz, 32 kHz, 24 kHz, 22.05 kHz, and 16 kHz.

In this manner, since different decoders must be equipped in recorders depending on regions where the recorders are used, information (region code) indicating a recorder used to record a disc and its supported functions is saved in VMGI, thus identifying the recorder used to write data on a disc and its supported functions.

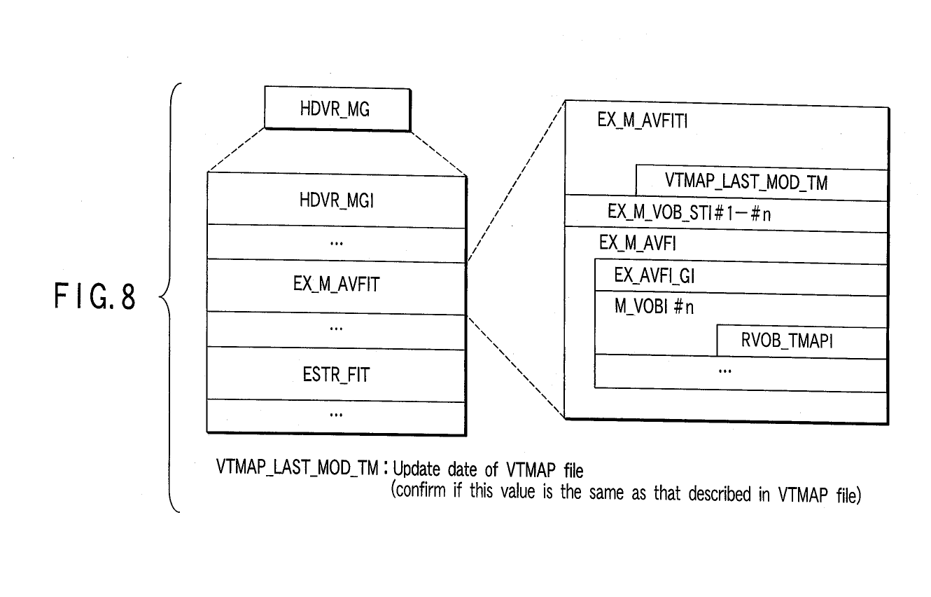

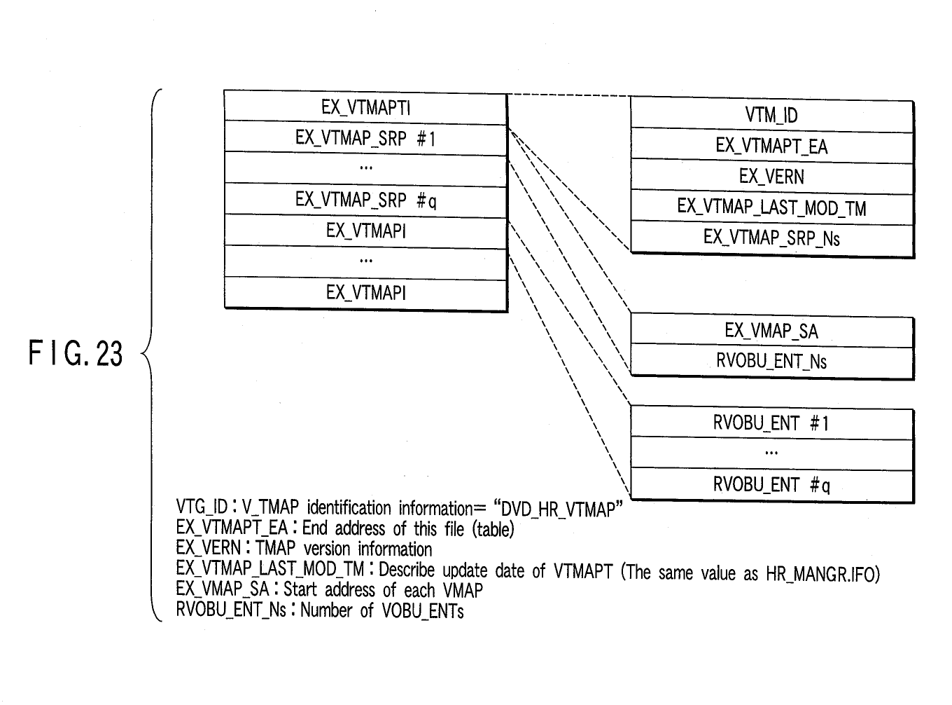

FIG. 8 is a view for explaining an example of the configuration of another field (M_AVFIT) of one management information (HDVR_MG) in the data structure according to the embodiment of the present invention. In this data structure, VR data management information (EX_M_AVFI) and SR stream management information (ESTR_FIT) are saved in HDVR_MG, thus managing stream data in the same way as VR data. That is, the VR data management information is saved in EX_M_AVFIT (Extended Movie AV File Information Table). Update date information (EX_VTMAP_LAST_MOD_TM) of VTMAPT is described in EX_M_AVFITI in the EX_M_AVFIT. This value is compared with update date information (EX_VTMAP_LAST_MOD_TM in FIG. 23) described in a TMAPT file. If these values match, processing can be made since data are consistent.

FIG. 9 is a view for explaining an example of the configuration of RVOB_TMAPI in FIG. 8. RVOB_TMAPI (in case of VR movie, M_RVOB_TMAPI) includes the number of VR movie RVOBU entries RVOBU_ENT_Ns, time offset TM_OFS, address offset ADR_OFS, RVOBU playback time range RVOBU_PB_TM_RNG (1=0.4 s to 1.2 s, 2=1 s to 2 s, 3=2 s to 3 s), and TMAP number EX_VT_MAP_N.

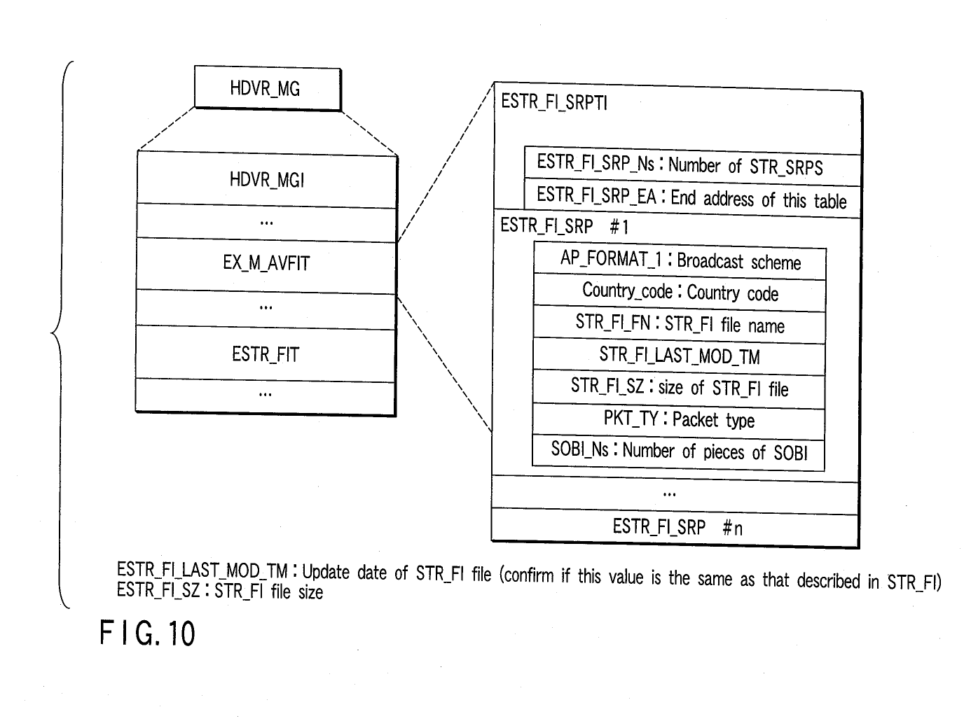

Stream management information to be described below with reference to FIG. 10 is saved in an ESTR_FIT (Extended Stream File Information Table), which includes ESTR_FITI (ESTR_FIT Information), and one or more ESTR_FI_SRPs. ESTR_FI pointed by each ESTR_FI_SRP is registered and managed as an independent file (HR_SFIx.IFO). Each STR_FI includes an ESOB_TMAPI having a function corresponding to M_RVOB_TMAPI in its data layer.

FIG. 10 is a view for explaining an example of the configuration of ESTR_FI_SRPTI and each ESTR_FI_SRP. That is, the ESTR_FI_SRPTI includes the total number of ESTR_FI_SRPs (ESTR_FI_SRP_Ns), and an end address (ESTR_FI_SRPT_EA) of this table (ESTR_FI_SRPT). Each ESTR_FI_SRP includes an AP_FORMAT (application format: broadcast scheme), COUNTRY_CODE (country code), file name of ESTR_FI (STR_FI_FN), update date information (STR_FI_LAST_MOD_TM), file size (STR_FI_SZ), PKT_TY (packet type), and the number of pieces of ESOBI (SOBI_Ns).

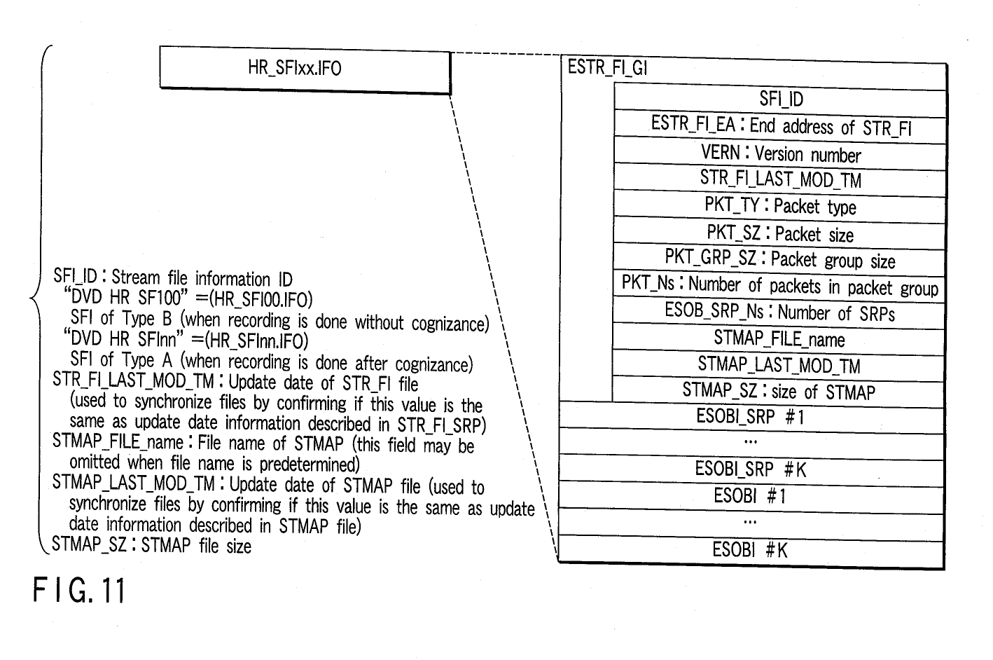

FIG. 11 is a view for explaining an example of the configuration of file HR_SFIxx.IFO included in the DVD_HDVR directory. The structure of the ESTR_FI file includes ESTR_FI_GI (ESTR_FI General Information), one or more ESOBI_SRP (Stream Object Information Search Pointers), and a plurality of pieces of ESOBI (ESOB Information) indicated by the same number values (#1 to #K) of these ESOBI_SRP#1 to ESOBI_SRP#K.

The ESTR_FI_GI in FIG. 11 includes SFI_ID (ID of an ESTR_FI file), update date information (STR_FI_LAST_MOD_TM) of the ESTR_FI, PKT_TY (packet type, normally: MPEG_TS), PKT_SZ (packet size, normally: 188), PKET_GRP_SZ (packet group size, normally: 16 sectors: 32 kbytes), PKT_Ns (the number of packets in the packet group, normally: 170), the number of ESOBI search pointers (ESOBI_SRP_Ns), STMAP file name (STMAP_FILE_NAME), and STMAP update date information (STMAP_LAST_MOD_TM).

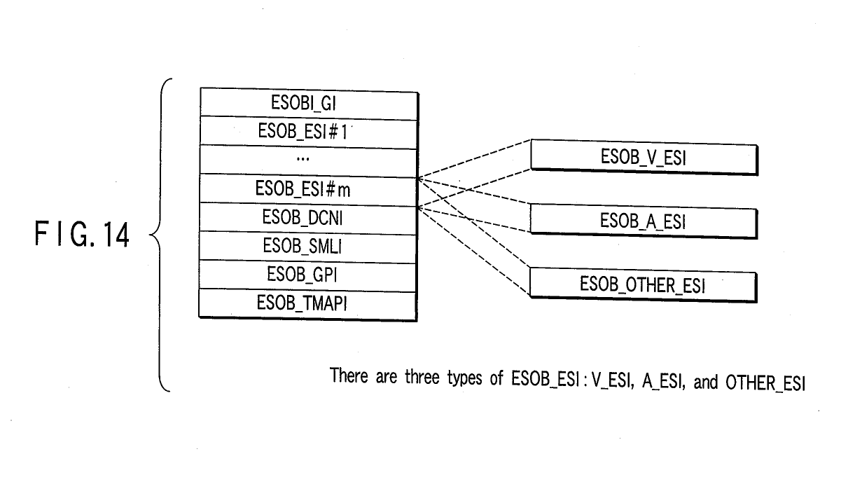

ESOBI# pointed by ESOBI_SRP# of the corresponding # number includes ESOBI_GI (ESOBI General Information), one or more pieces of ESOB_ESI (ESOBI Elementary Stream Information)#, ESOB_DCNI (ESOB Discontinuity Information), ESOB_SMLI (ESOB Seamless Information), ESOB_AGAPI (ESOB Audio GAP Information), ESOB_TMAPI (ESOB Time Map Information), and ESOB_ES_GPI (ESOB Elementary Stream Group Information). Note that the ESOB_ESI further includes ESOB_V_ESI (ESOB Video ESI) and ESOB_A_ESI (ESOB Audio ESI) (see FIG. 14).

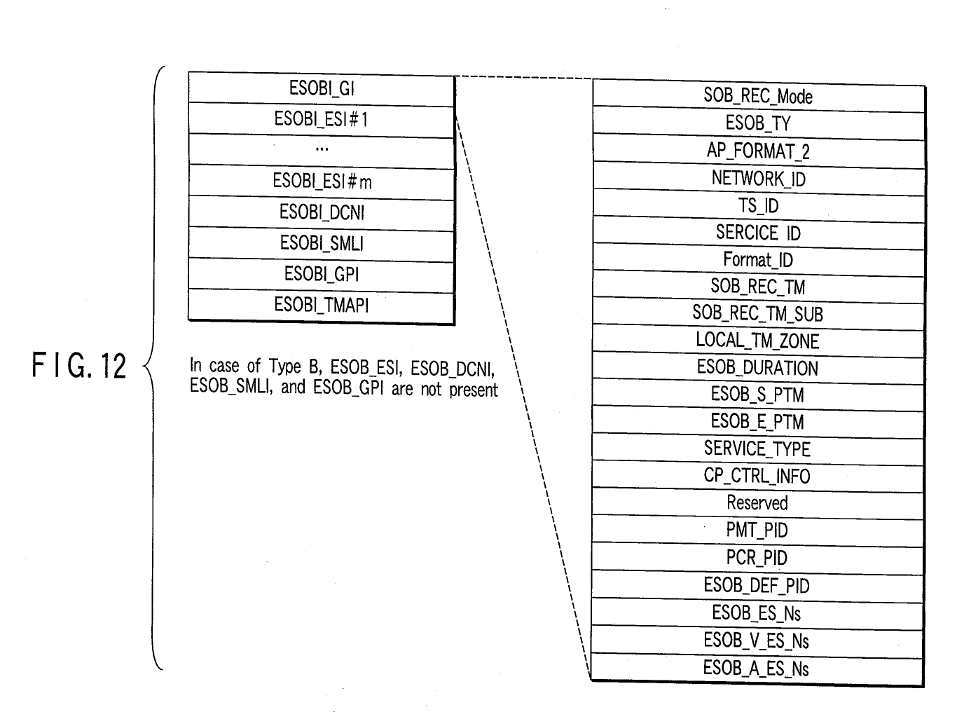

FIG. 12 is a view for explaining an example of the configuration of the ESOBI_GI included in the ESOBI shown in FIG. 11. As shown in FIG. 12, the ESOBI_GI includes SOB_REC_MODE (identification of an ESOB type: TYPE A=ESOBI of a cognized ESOB, TYPE B=non-cognized ESOBI), ESOB_TY (ESOB type), and AP_FORMAT_{—}2 (application format: 1=ISDB-S (BS/CS broadcast), 2=ISDB-T (terrestrial digital broadcast)).

The ESOBI_GI further includes SERVICE_ID (service ID), SERVICE_TYPE (service type), PMT_PID (PMT packet ID), NETWORK_ID (network ID), TS_ID (transport stream ID), PCR_PID (PCR packet ID), and ESOB_DEF_PID (ESOB default PID).

Moreover, the ESOBI_GI includes Format_ID (format ID), CP_CTRL_INFO (copy control information), ESOB_REC_TM (ESOB recording time), ESOB_REC_TM_SUB (ESOB recording sub time), ESOB_DURATION (TYPE A: a playback duration of an ESOB playback time, TYPE B: an arrival duration of an ESOB arrival time), ESOB_S_PTM (ESOB start time: in case of TYPE A)/PATS (ESOB arrival start time: in case of TYPE B), and ESOB_E_PTM (ESOB end time: in case of TYPE A)/PATS (ESOB arrival end time: in case of TYPE B).

In addition, the ESOBI_GI includes LOCAL_TM_ZONE (local time zone), ESOB_ES_Ns (the number of ESs of an ESOB), ESOB_V_ES_Ns (the number of video ESs of an ESOB), and ESOB_A_ES_Ns (the number of audio ESs of an ESOB). However, in case of TYPE B, fields PMT_PID to ESOB_A_ES_Ns are not available. There are two ESOB TYPEs: TYPE A, when ESOBI is generated in a PTM base by cognizing a cognizable title; TYPE B, when ESOBI is generated in a PATS base when a title cannot be cognized (or without cognizance). In case of TYPE B, no ESOB_ESI, ESOB_DCNI, ESOB_SMLI, and ESOB_GPI are available.

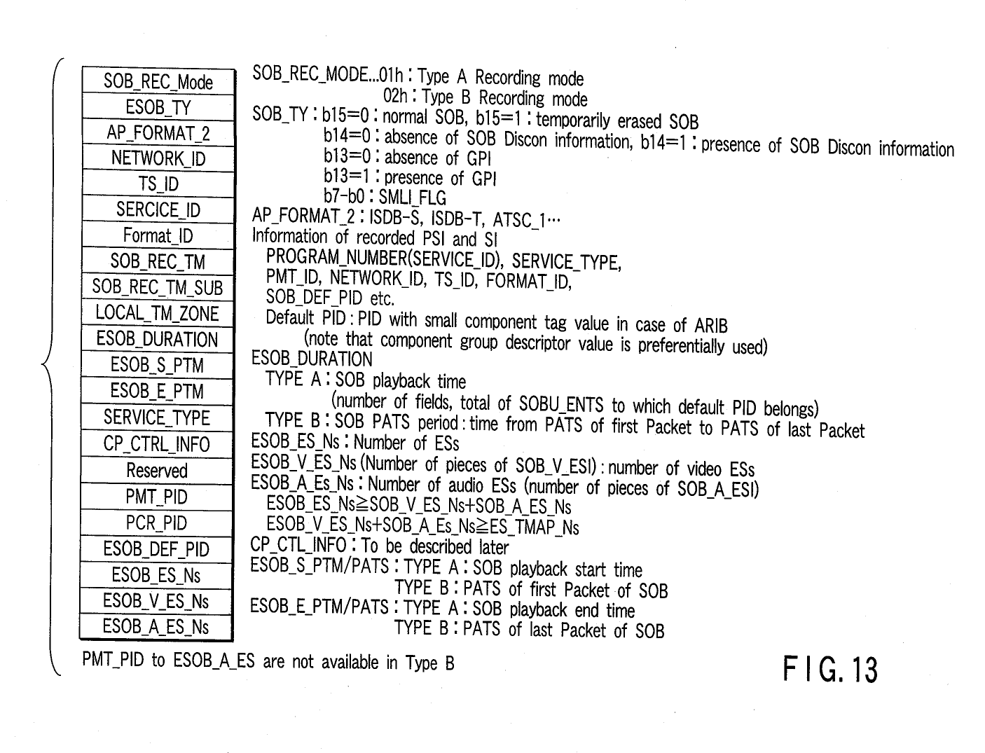

FIG. 13 is a view for explaining various kinds of information included in the ESOBI_GI in FIG. 12. ESOB_TY indicates a normal ESOB when its bit b15 is 0; a temporarily erased ESOB when its bit b15 is 1; the absence of GPI when bit b14 is 0; and the presence of GPI when bit b14 is 1. Furthermore, SERVICE_ID, PMT_ID, NETWORK_ID, TS_ID, and FORMAT_ID are formed on the basis of PSI and SI values; ESOB_ES_Ns (the number of ESs selected for video recording), ESOB_V_ES_Ns (the number of ESs used to generate a TMAP of recorded video ESs), and ESOB_A_ES_Ns (the number of ESs used to generate a TMAP of recorded audio ESs) are formed based on data to be recorded.

Note that ESOB_ES_Ns, ESOB_V_ES_Ns, ESOB_A_ES_Ns, and ES_TMAP_Ns have a relation indicated by the following inequality:

ESOB_ES_Ns≧ESOB_V_ES_Ns+ESOB_A_ES_Ns

ESOB_V_ES_Ns+ESOB_A_ES_Ns>ES_TMAP_Ns

Copy control for copyright protection or the like is done based on CP_CTRL_INFO.

Note that in ARIB the default PID (ESOB_DEF_PID) indicates a PID with a smaller component tag value (the value of a component group descriptor is preferentially used). ESOB_DURATION indicates an ESOB playback time and corresponds to a total of ESOBU_ENTs in case of TYPE A. Also, ESOB_DURATION is duration information from the ESOB arrival start time to ESOB arrival end time in case of TYPE B.

FIG. 14 is a view for explaining an example of the configuration of the ESOB_ESI included in the ESOBI. In this example, the ESOB_ESI is classified into three types (ESOB_V_ESI, ESOB_A_ESI, and ESOB_OTHER_ESI).

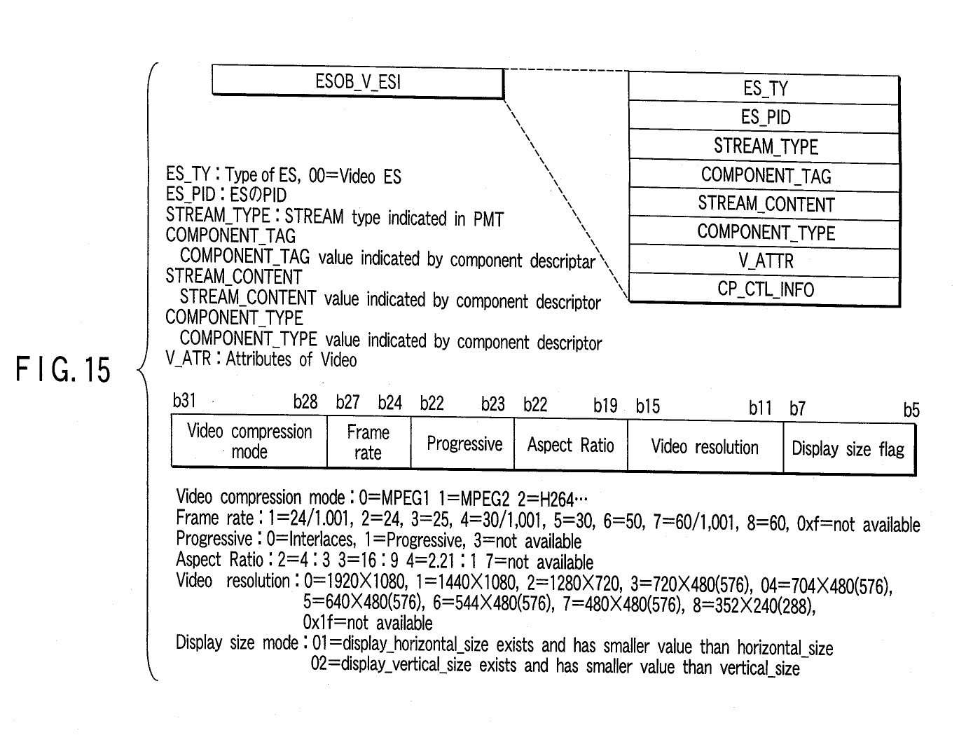

FIG. 15 is a view for explaining an example of the configuration of ESOB_V_ESI included in each ESOB_ESI (in this case, ESOB_ESI#m) and an example of the configuration of video attribute V_ATTR included in this ESOB_V_ESI. The ESOB_V_ESI includes ES_TY indicating the type of an ES, ES_PID indicating the PID of an ES, STREAM_TYPE (STREAM type indicated in a PMT), COMPONENT_TAG (the value of COMPONENT_TAG indicated by a component descriptor), COMPONENT_TYPE (the value of COMPONENT_TYPE indicated by the component descriptor), V_ATTR indicating video attributes, and CP_CTL_INFO (copy control information/copyright management information). V_ATTR (16 bits) includes the video compression method, frame rate, distinction of progressive/interlaced, aspect ratio, video resolution, display size flag, and the like.

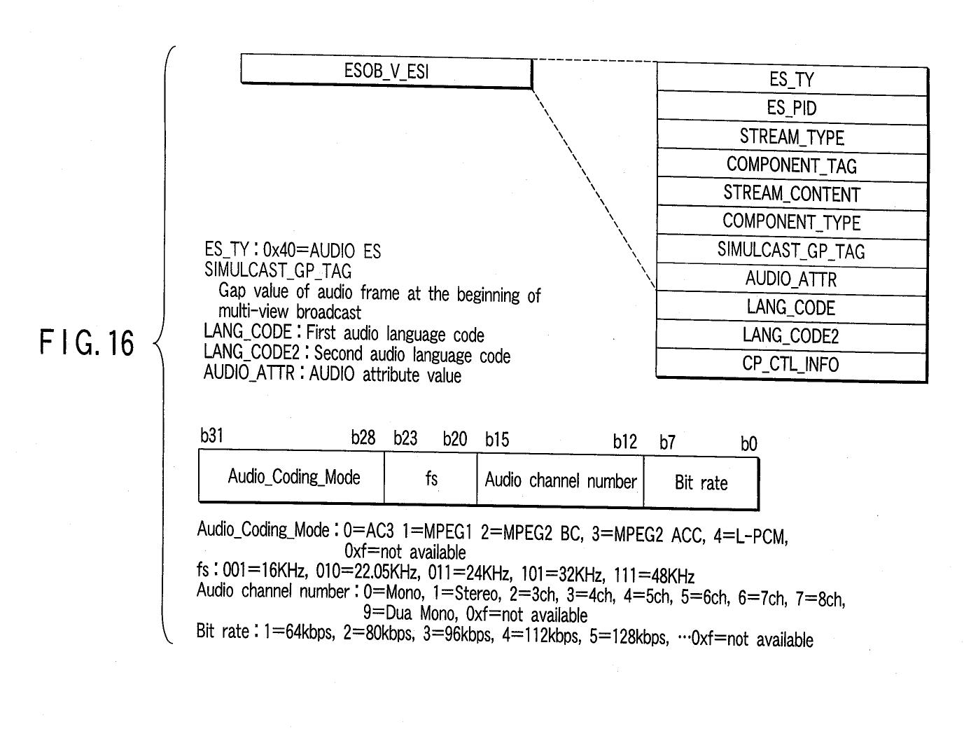

FIG. 16 is a view for explaining an example of the configuration of ESOB_A_ESI included in each ESOB_ESI (in this case, ESOB_ESI#m) and an example of the configuration of audio attribute AUDIO_ATTR included in this ESOB_A_ESI. The ESOB_A_ESI includes ES_TY indicating the type of an ES, ES_PID indicating the PID of an ES, STREAM_TYPE (STREAM type indicated in a PMT), COMPONENT_TAG (the value of COMPONENT_TAG indicated by a component descriptor), STREAM_CONTENT (the value of STREAM_CONTENT indicated by the component descriptor), COMPONENT_TYPE (the value of COMPONENT_TYPE indicated by the component descriptor), SIMULCAST_GP_TAG (the gap value of audio frames at the beginning of multi-view broadcast), AUDIO_ATTR (audio attribute values), LANG_CODE (a language code of first audio), LAND_CODE2 (a language code of second audio), and CP_CTL_INFO (copy control information/copyright management information). AUDIO_ATTR includes the compression mode, sampling frequency, the number of channels, bit rate, and the like. These values are set by audio component descriptor values.

FIG. 17 is a view for explaining an example of the configuration of ESOB_OTHER_ESI included in each ESOB_ESI (in this case, ESOB_ESI#m). The ESOB_OTHER_ESI includes DAT_COMP_ID (data contents encoding identifier) and AD_DAT_COMP_IFO (Additional data Component Information) in addition to ES_TY, ES_PID, STREAM_TYPE, COMPONENT_TAG, and CP_CTL_INFO.

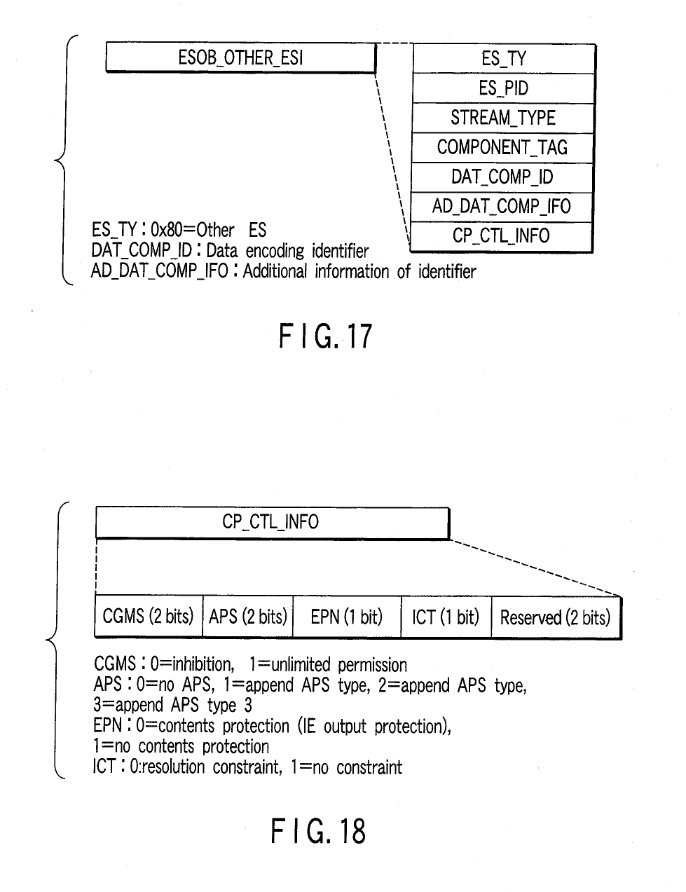

FIG. 18 is a view for explaining another example of the configuration of copy control information (copyright protection information) CP_CTL_INFO included in the ESOB_V_ESI, ESOB_A_ESI, ESOB_OTHER_ESI, and the like. The CP_CTL_INFO is stored in CPI of ESOBI_GI, ESOB_V_ESI, ESOB_A_ESI, and a Packet Group Header. The CPI of ESOBI_GI makes the overall copy control, that of ESI makes copy control of each ES, and copy control of each Packet Group is made based on CPI of the Packet Group Header. The CPI values of the ESI are used in preference to those of ESOBI_GI, and the CPI of the Packet Header Group is assigned top priority. These CPI values are set based on a digital copy control descriptor, content use descriptor, and the like.

The contents of the CP_CTL_INFO are: CCI or CGMS (0=copy never; 1=copy free); APS (0=no APS, 1=append APS type 1, 2=append APS type 2, 3=append APS type 3); EPN (0=contents protection (Internet output protection), 1=no contents protection); and ICT (0=resolution constraint, 1=no constraint). Of these contents, Retention allows temporary storage only for a time indicated by Retention_State when Retention=0 and a copy inhibition mode is set, and the stored contents must be erased after an elapse of that time.

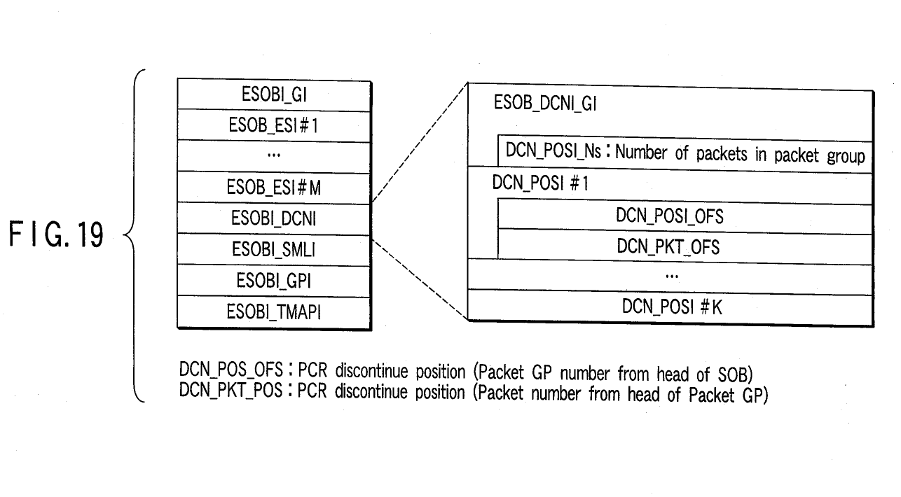

FIG. 19 is a view for explaining an example of the configuration of the ESOB_DCNI included in the ESOBI. The ESOB_DCNI includes DCNI_GI and one or more pieces of DCN_POSI. The DCNI_GI includes the number of pieces of POSI, and each DCN_POSI includes discontinuity position information. Normally, SCR is synchronization information required to match time information on the broadcast side with that on the decoder side. In this case, the value of a discontinuity indicator of the adaptation field in the packet header changes to set a PCR. The position information at that time is expressed by the number of packet groups from the head of an ESOB, and the number of packets in the packet groups.

FIG. 20 is a view for explaining an example of the configuration of ESOB_TMAPI included in the ESOBI of TYPE A. The ESOB_TMAPI includes ESOB_TMAPI_GI and one or more pieces of ES_TMAPI#. ESOB_TMAPI_GI includes TMAP_TY (ESOB type: 0=TYPE A, 1=TYPE B; however, such type information may not often be necessary when the TYPE of an ESOB is determined by only the SFI_ID), ADR_OFS (a Packet Group number (LB address) from the head of a file to the head of an ESOB), ESOBU_PB_TM_RNG (ESOBU playback time range: 1=0.4 s to 1.2 s, 2=1 s to 2 s, 3=2 s to 3 s), ESOB_S_PKT_POS (the start position of the head of an ESOB in a Packet group: 1≦ESOB_S_PKT_POS≦170), ESOB_E_PKT_POS (the end position of the head of an ESOB in a Packet group: 1≦ESOB_E_PKT_POS≦170), ES_TMAP_Ns (the number of ES_TMAPs), and the like.

Each ES_TMAPI includes ES_PID (the PID of a target ES of this TMAP), ADR_OFS (logical address from the head of an ESOB file to the head of this ES), ES_S_PTM (start PTM), ES_E_PTM (end PTM), ES_ESOBU_ENT_Ns (the number of ESOBU_ENTs), LAST_ESOBU_E_PKT_POS (position of the last ESOBU in a Packet Group), and STMAP_SRPN (the number of a TMAP in the TMAPT, which belongs to this ES: this number may be omitted when the TMAPTs are recorded in independent areas for VR and SR or TMAPs are recorded in turn in each TMAPT).

Note that TMAPI information can be prevented from becoming extremely large by appropriately setting ESOBU_PB_TM_RNG even when a video recording time increases. However, in such case, since the time interval between neighboring ENTRIES broadens, it is more likely that smooth double-speed playback and the like are disturbed.

FIG. 21 shows an example of the configuration of ESOB_TMAPI in case of TYPE B. ASOB_TMAPI includes ASOB_TMAPI_GI. The ASOB_TMAPI_GI includes TMAP_TY (ESOB type: 0=TYPE A, 1=TYPE B; however, such type information may not often be necessary when the TYPE of an ESOB is determined by only the SFI_ID), ADR_OFS (a Packet Group number (LB address) from the head of a file to the head of an ESOB), ASOBU_TM (ASOBU playback time range: 0=1 s, 1=2 s), ESOB_S_PKT_POS (the start position of the head of an ESOB in a Packet group: 1≦ESOB_S_PKT_POS≦170), ESOB_E_PKT_POS (the end position of the head of an ESOB in a Packet group: 1≦ESOB_E_PKT_POS≦170), and ASOBU_Ns (the number of ASOBUs).

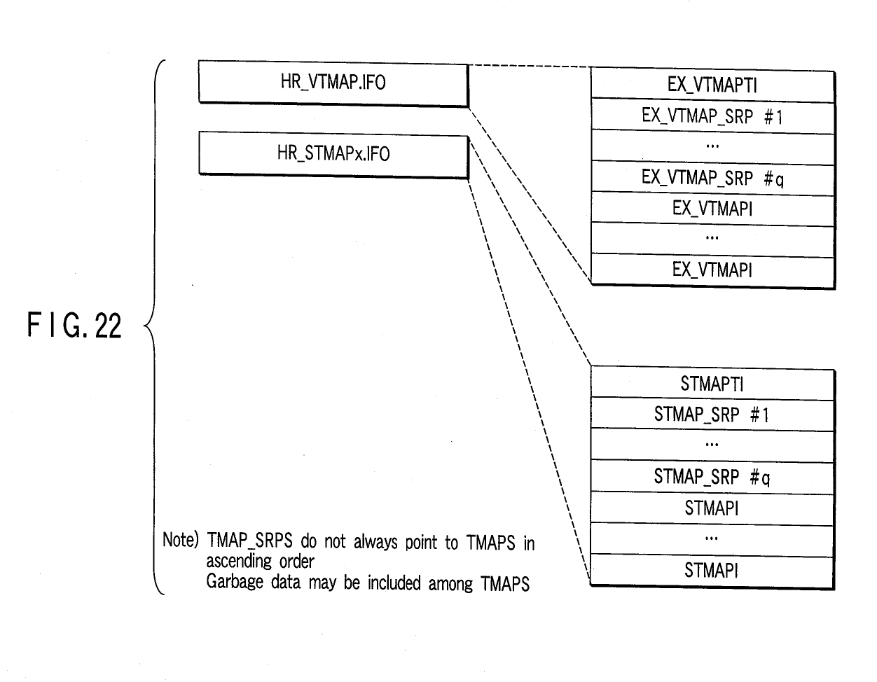

FIG. 22 is a view showing an example of the configuration of time map files HR_VTMAP.IFO and HR_STMAPx.IFO included in the DVD_HDVR directory in FIG. 3. As exemplified in FIG. 22, an EX_VTMAPT of the HR_VTMAP.IFO and an STMAPT of the HR_STMAPx.IFO adopt different data structures. In these data structures, the EX_VTMAPT includes EX_VTMAPI, EX_VTMAP_SRPT (search table information of an EX_VTMAP: EX_VTMAP_SRP#1 to EX_VTMAP_SRP#q), and EX_VTMAP#. The STMAPT includes STMAPTI, STMAP_SRPT (search table information of an STMAP: STMAP_SRP#1 to STMAP_SRP##q), and STMAP#.

FIG. 23 is a view for explaining an example of the configuration of the EX_VTMAPT in FIG. 22. Referring to FIG. 23, the EX_VTMAPT includes VTM_ID (identification information of a V_TMAP), EX_VTMAPT_EA (end address of the EX_VTMAP), EX_VERN (version information of a TMAP), EX_VTMAP_LAST_MOD_TM (update date information of a TMAPT, which assumes the same value as HR_MANGR.IFO), and EX_VTMAP_SRP_Ns (the total number of pieces of search pointer information). Furthermore, each EX_VTMAP_SRP includes EX_VTMAP_SA (start address of the EX_VTMAP), and RVOBU_ENT_Ns (the total number of RVOBU_ENTs, and the EX_VTMAP includes one or more RVOBU_ENTs.

FIG. 24 shows an example of the configuration of the contents of the RVOBU_ENT in FIG. 23. Each RVOBU_ENT includes 1STREF_SZ, VOBU_PB_TM (the number of fields), and VOBU_SZ information as in the existing DVD-VR standard.

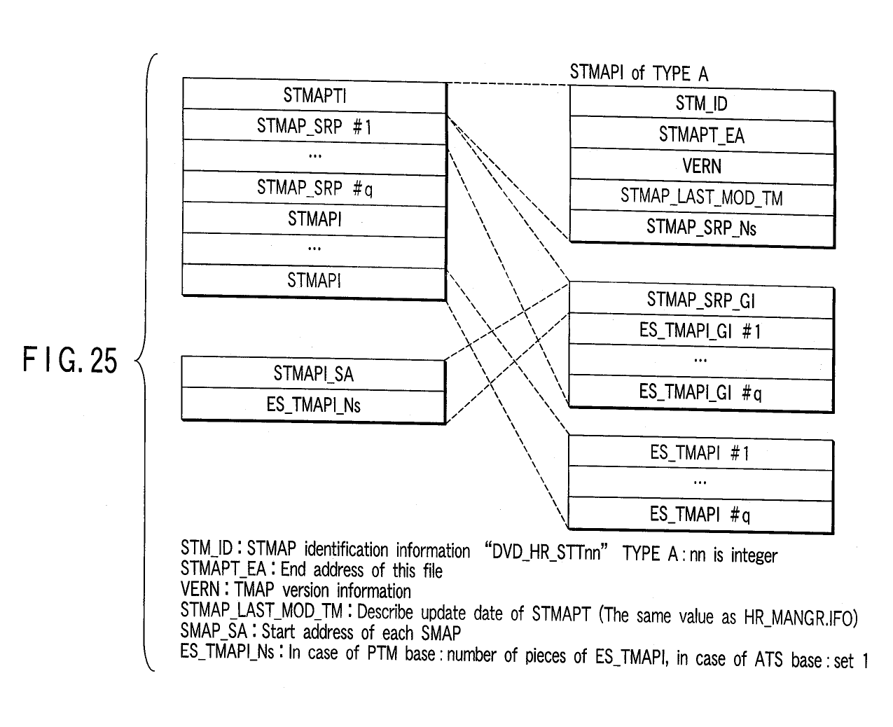

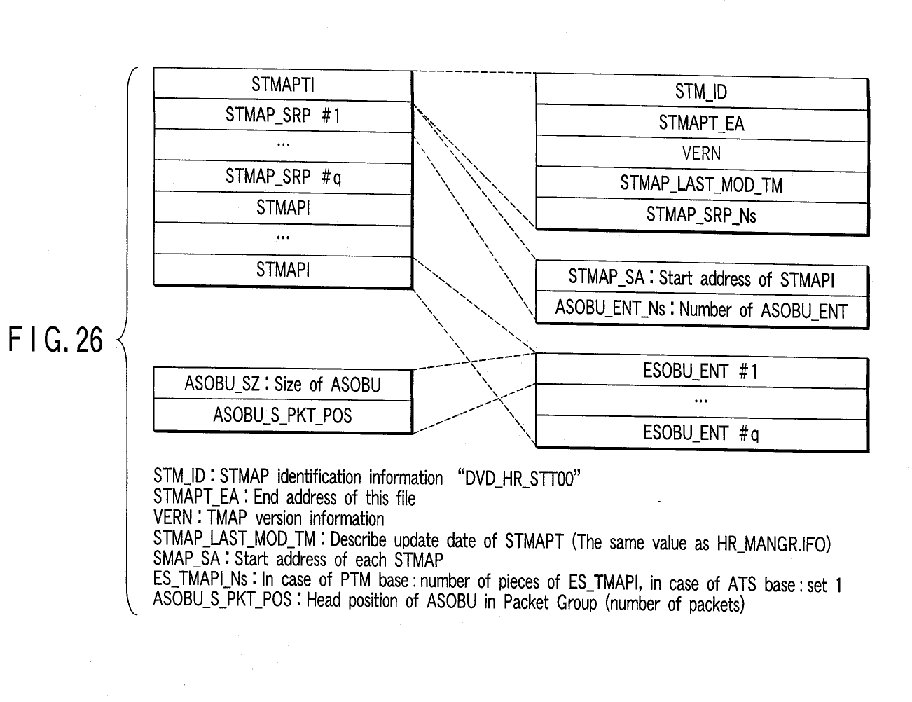

FIGS. 25 and 26 are views for explaining an example of the configuration of various kinds of information included in the STMAPT in FIG. 22. Referring to FIG. 25, STMAPTI of TYPE A includes STM_ID (STMAP identification information), STMAPT_EA (the end address of the STMAP), VERN, and STMAP_LAST_MOD_TM. Furthermore, STMAP_SRPTI includes STMAP_SRP_Ns. On the other hand, each STMAP_SRP includes STMAP_SRP_GI including STMAPI_SA (the start address of STMAPI) and ES_TMAPI_Ns (the total number of pieces of ES_TMAPI), and ES_TMAPI_GI (#1 to #q). Each STMAPI includes one or more pieces of ES_TMAPI (#1 to #q).

Referring to FIG. 26, STMAPTI of TYPE B includes STM_ID, STMAPT_EA, VERN, STMAP_LAST_MOD_TM, and STMAP_SRP_Ns. On the other hand, each STMAP_SRP includes STMAPI_SA and ASOBU_ENT_Ns (the number of SOBU_ENTs of TYPE B). Each STMAPI includes one or more ESOBU_ENTs (#1 to #q), and each ESOBU_ENT includes ASOBU_SZ (SOBU size of TYPE B) and ASOBU_S_PKT_POS (the start packet position of an SOBU of TYPE B).

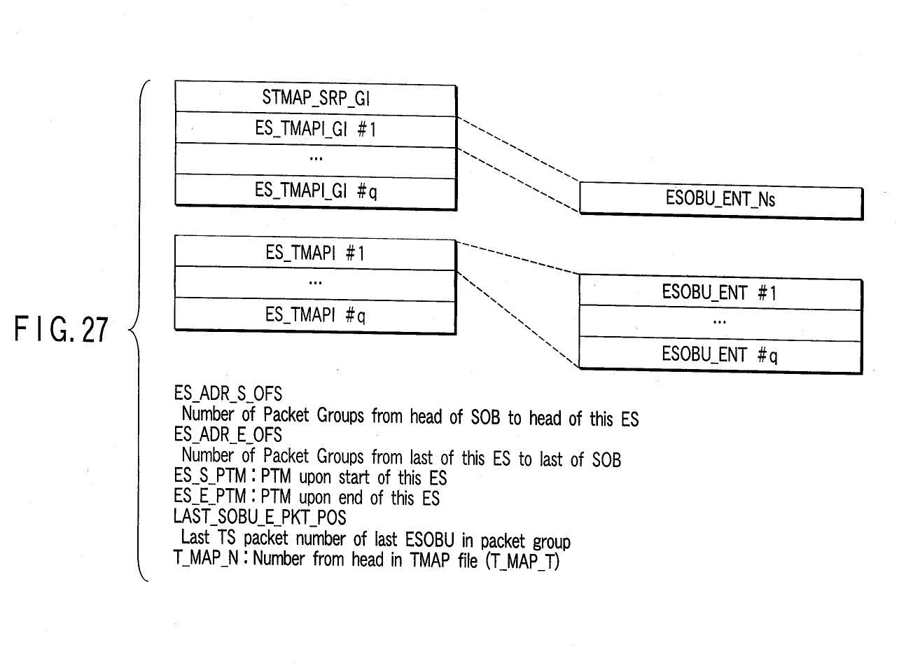

FIG. 27 is a view for explaining an example of information stored in the ES_TMAPI_GI and ES_TMAP# respectively included in the STMAP_SRP# and STMAP in FIG. 25. Each ES_TMAPI_GI includes ESOBU_ENT_Ns (the total number of ESOBU_ENTs), and each ES_TMAPI includes one or more ESOBU_ENTs. Note that STMAP_SRP data do not always point to STMAPs in ascending order. However, since each SRP points to each individual STMAP, whether or not STMAPs are arranged in ascending order does not pose any problem, and garbage data may be included among a sequence of STMAPs (e.g., insignificant data may be stored between STMAP#1 and STMAP#3).

FIG. 28 is a view for explaining an example of the configuration of the contents of the ESOBU_ENT# of TYPE A. As shown in FIG. 28, there are three cases for the ESOBU_ENT, i.e., a case wherein video data is available, a case wherein no video data is available but audio data is available, and a case of only other kinds of information. These types are respectively expressed by <1>, <2>, and <3>. That is, there are three types of ESOBU entry information (ESOBU_ENT) in accordance with the aforementioned types.

<1> When video data is available, ESOBU entry information includes end address information (unit: LB) 1st_Ref_PIC_SZ of the first reference picture (I-picture or the like) in an entry from the head of the ESOBU, ESOBU playback time (the number of fields) ESOBU_PB_TM, ESOBU_SZ (the size expressed by the number of packet groups, i.e., the number of packet groups which belong to that ESOBU), and ESOBU_S_PKT_POS (the number of packets from the head of a packet group that stores the head of an ESOBU).

In this manner, in case of a time search, the ESOBU at a target timing is obtained by accumulating ESOBU_PB_TM data, and the playback start PTM can be calculated using the number of fields from the head of that ESOBU.

<2> When video data is not available and audio data is available, ESOBU entry information includes the end address information (the same as that described above) of the first audio frame in an entry from the head of an ESOBU, ESOBU playback time (the number of fields), and ESOBU size (the same as that described above).

<3> When only other kinds of information are available, since entry information cannot be formed, all data are padded with “FF”s.

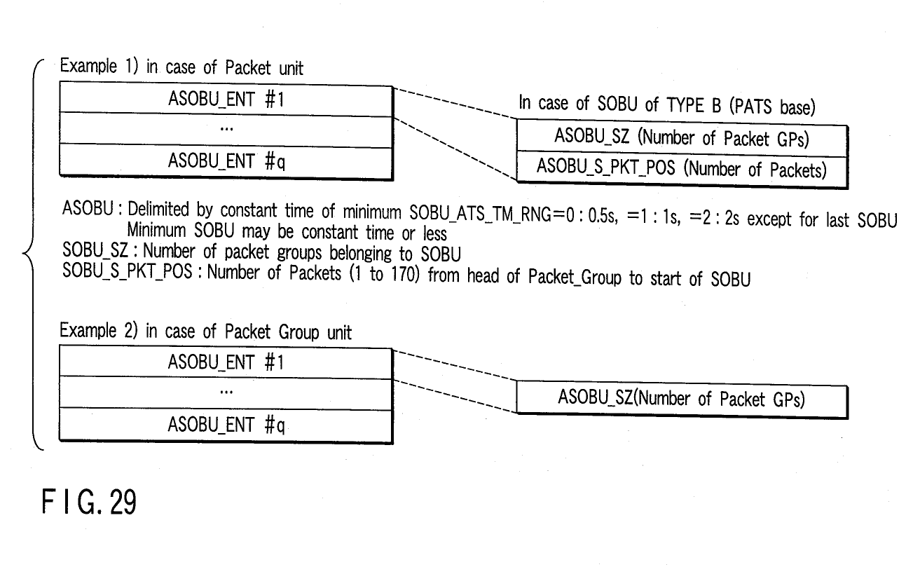

FIG. 29 is a view for explaining an example of the configuration of the contents of the ASOBU_ENT# of TYPE B. The ASOBU_ENT includes ASOBU_SZ (the size expressed by the number of packet groups, i.e., the number of packet groups which belong to that ASOBU) and ASOBU_S_PKT_POS (the number of packets from the head of a packet group that stores the head of an ASOBU).

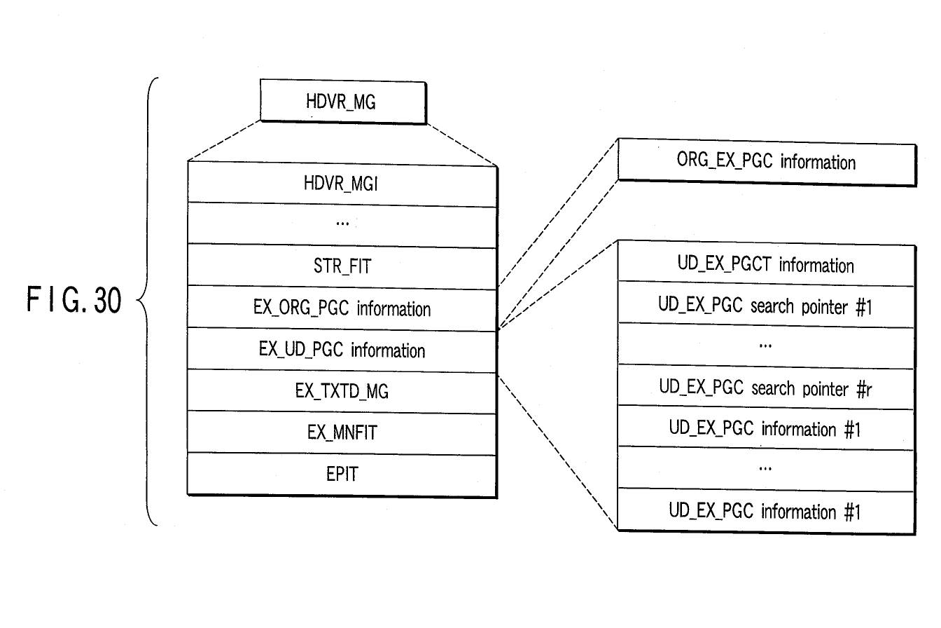

FIG. 30 is a view for explaining an example of the configuration of PGC information (ORG_EX_PGC information and EX_playlist information/UD_EX_PGCT information) included in the HDVR_MG in FIG. 4. Original PGC information ORG_EX_PGCI is stored in EX program chain information. EX playlist information (or user-defined information table information) includes user-defined PGC table information UD_EX_PGCTI, one or more UD_EX_PGC_SRP#1 to UD_EX_PGC_SRP#r, and one or more pieces of user-defined PGC information UD_EX_PGCI#1 to UD_EX_PGCI#s.

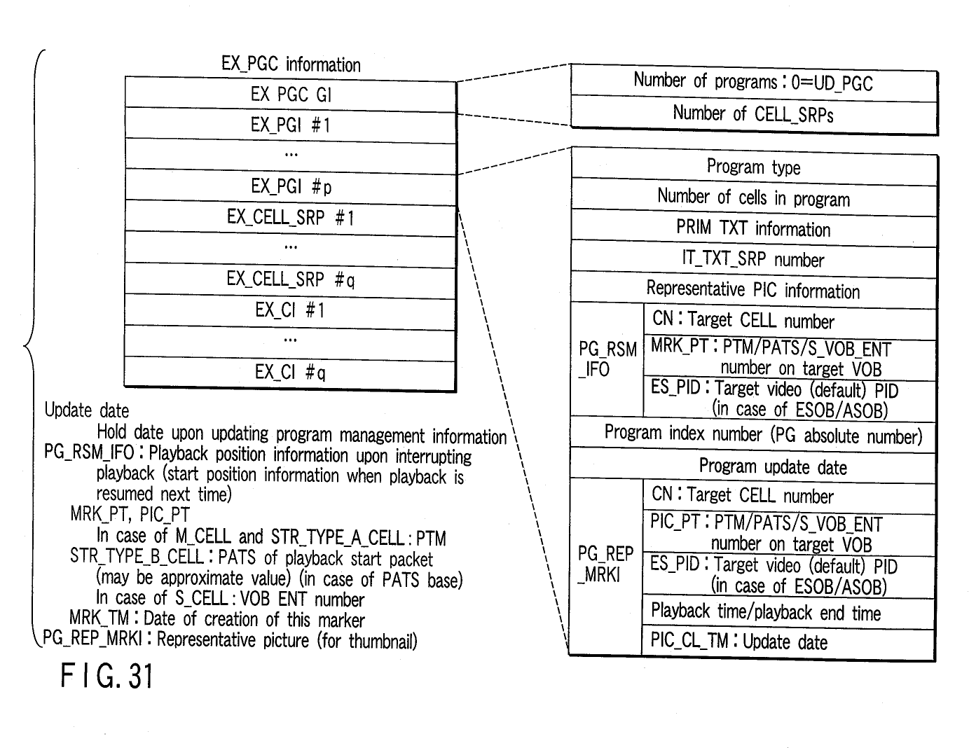

PGC information as playback information has the same format as a normal VR format, and EX_ORG_PGC information is automatically generated by an apparatus (recorder) upon video recording and is set in the order of video recording. EX_UD_PGC information is generated according to a playback order which is freely added by the user, and is called a playlist. These two formats (original PGC information and playlist) have a common format in PGC level, and FIG. 31 shows that PGC format.

FIG. 31 is a view for explaining an example of the configuration of the EX_PGC information shown in FIG. 30. The EX_PGC information (original PGCI) includes its general information EX_PGC_GI, one or more pieces of program information EX_PGI#, one or more cell search pointers EX_CELL_SRP#, and one or more pieces of cell information EX_CI#.

Note that PG information (EX_PGI#) saves update date information of this PG. This information can identify when this PG was edited. A program name as text information uses PRM_TXT information, and an IT_TXT field saves other kinds of information (director name, leading actor name, . . . ) to save other kinds of text information. This PGI is set with an SRP number of the IT_TXT field which saves these kinds of information to establish a link. Furthermore, a PG number is set in IT_TXT data. Note that the PG number is an absolute number from the beginning of recording on this disc, and is an index number which remains unchanged even after other PGs are deleted.

In order to use MNFI which is assured to implement functions unique to each manufacturer, the SRP number of such MNFI is set in PGI. Also, the PG number is set in the MNFI information to link with data in MNFI information.

Furthermore, PG update date information is set in both the MNFI and IT_TXT. By checking if these two times match upon displaying a menu, whether or not the contents have been edited by another manufacturer can be verified. Furthermore, in CELL information (EX_CI#), types, i.e., ESOB TYPE A and TYPE B are added to a CELL type to designate an ESOB number, start time, end time, and GP number to be played back. Note that the start and end times can be expressed by either of two methods, i.e., PTS units (playback time) and ATS units (transfer time).

When a time is designated by a playback time (real time upon playback), the same access method as in the conventional VR is allowed, and the user can designate a desired access position using a playback time. Hence, a user's desire can be perfectly reflected. However, this method can be designated only when the stream contents can be sufficiently cognizable. If the contents cannot be sufficiently cognizable, a time must be designated using a transfer time. (That is, if a time is designated using a playback time, playback cannot always be started from the head of I-picture data.) If a frame at the playback start position is not I, decoding starts from immediately preceding I, and display starts when the target frame is decoded, thus presenting a picture to the user as if playback started from the designated frame.

As for a reference ID, a method of setting the PID (or component tag value) of a representative one of streams to be played back, and a method of setting the ID of a component group in case of multi-view TV or the like are available. Also, in still another method, a reference GPI number may be set to switch groups (during playback). Unique ID numbers are assigned to PG and CELL data, so that PG and CELL data can be designated using numbers which remain unchanged even when middle PG and CELL data are deleted.

In DVD-VR used so far, entry point information (marker information) exists in CELL information. However, in the embodiment of the present invention, marker information (PG_RSM_IFO, PG_REP_MRKI, and the like) can exist not only in the CELL information (EX_CI) but also in the PGI and PGCI and/or HDVR_MGI.

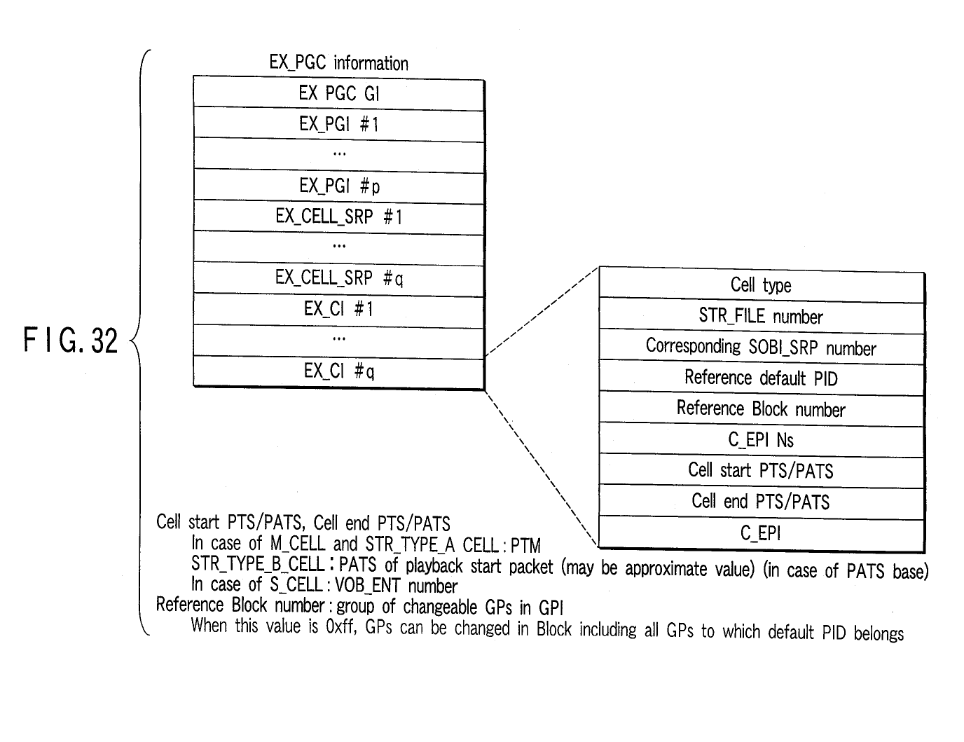

FIG. 32 is a view for explaining an example of the configuration of EX_CELL information (EX_CI). FIG. 32 is a view for explaining an example of the configuration of the contents of elements of program chain information (EX_ORG_PGC information or EX_UD_PGC information) shown in FIG. 4 and the like. This program chain information (EX_PGC information; EX_PGCI) includes program chain general information (EX_PGC_GI), one or more pieces of program information (EX_PGI#1 to EX_PGI#p), one or more cell search pointers (EX_CELL_SRP#1 to EX_CELL_SRP#q), and one or more pieces of cell information (EX_CI#1 to EX_CI#q).

The EX_PGCI_GI includes the number of programs and the number of cell search pointers. Each program information includes a program type, the number of cells in the program, primary text information, an item text search pointer number, representative picture information, an editor ID, program index number (program absolute number), program update date, and manufacturer's information number (MNFI number). Each cell information includes a cell type, ESFI number, corresponding ESOB number, reference ID, the number of pieces of cell entry point information, cell start PTS/PATS, cell end PTS/PATS, and cell entry point information (C_EPI). A program update date field saves date information (year, month, day, hour, minute, second) when the program management information is updated. Also, an MNFI number field describes the number of a manufacturer's information search pointer.

The EX_PGC information in FIG. 32 is playback information, and EX_ORG_PGC information is automatically generated by an apparatus (recorder) upon video recording and is set in the order of video recording as in the conventional VR format. On the other hand, EX_UD_PGC information is generated according to a playback order which is freely added by the user, and is called a playlist. These two formats have a common format in PGC level, and FIG. 32 shows the common format of the EX_PGC information.

The program information (EX_PGI) saves update date information of that program (PG). This date information can identify when this program was edited. A program name as text information uses PRM_TXT information, and an IT_TXT field saves other kinds of information (director name, leading actor name, . . . ) to save other kinds of text information. This PGI is set with an SRP number of the IT_TXT field which saves these kinds of information to establish a link. Furthermore, a PG number is set in IT_TXT data. Note that the PG number is an absolute number from the beginning of recording on this disc, and is an index number which remains unchanged even after other PGs are deleted.

In order to use MNFI which is assured to implement functions (of the recorder) unique to each manufacturer, the search pointer number (MNFI number) of manufacturer's information MNFI is set in program information EX_PGI. Also, the PG number is set in the MNFI information to link data in EX_PGCI with data in MNFI information. Furthermore, PG update date information is set in both the MNFI and IT_TXT. By checking if these two times match upon displaying a menu, whether or not the contents have been edited by another manufacturer can be verified.

In the cell information (EX_CI) in FIG. 32, an ESOB type can be added to a cell type. Furthermore, this cell information can designate a corresponding ESOB number, and can also designate the cell start time (cell start PTS/PATS) and cell end time (cell end PTS/PATS). Note that these cell start and end times can be expressed by either of two methods, i.e., PTS units (playback time: TYPE A) and PATS units (transfer time: TYPE B). When a time is designated by a playback time (real time upon playback), the same access method as in the conventional VR is allowed, and the user can designate a desired access position using a playback time. Hence, a user's desire can be perfectly reflected. However, this method can be designated only when the stream contents can be sufficiently cognizable. If the contents cannot be sufficiently cognizable, a time must be designated using an arrival time unit.

If a time is designated using a playback time, playback cannot always be started from the head of I-picture data. If a frame at the playback start position is not I-picture, decoding starts from immediately preceding I-picture, and display starts when the target frame is decoded, thus presenting a picture to the user as if playback started from the designated frame.

As for the “reference ID” included in the cell information in FIG. 32, a method of setting the PID (or component tag value) of a representative one of streams to be played back, and a method of setting the ID of a component group in case of multi-view TV or the like are available. Also, if this setting value is 0xffff, a method of multi-displaying using sub-windows, and a method of preferentially displaying a group set in advance (or a default main group), and switching it later (during playback) may be used.

As a new concept, the “manufacturer ID (editor ID) of the last apparatus used to execute an edit process” is stored in EX_PGI, thus adding this information which indicates the manufacturer of an apparatus used to execute an edit process. With this information, the use state of information of MNFI used in respective manufacturers can be recognized. When the contents of an MNFI area are rewritten using an apparatus of another manufacturer, each apparatus may recognize that information in that MNFI has poor reliability. For this reason, after the edit process by the apparatus of the other manufacturer, new MNFI must be generated. Unique ID numbers are appended to PGs, and each PG can be designated by a number which remains unchanged even when a middle PG is deleted.

Unique ID numbers are assigned to PGs and CELLs, and PGs and CELLs can be designated by numbers which remain unchanged even when middle PG and CELL are deleted. Furthermore, an information area of a poor reception state may be added to cell entry point information C_EPI, EPs may be set at the start and end positions of poor reception, and its status may be additionally set in the information area of a poor reception state.

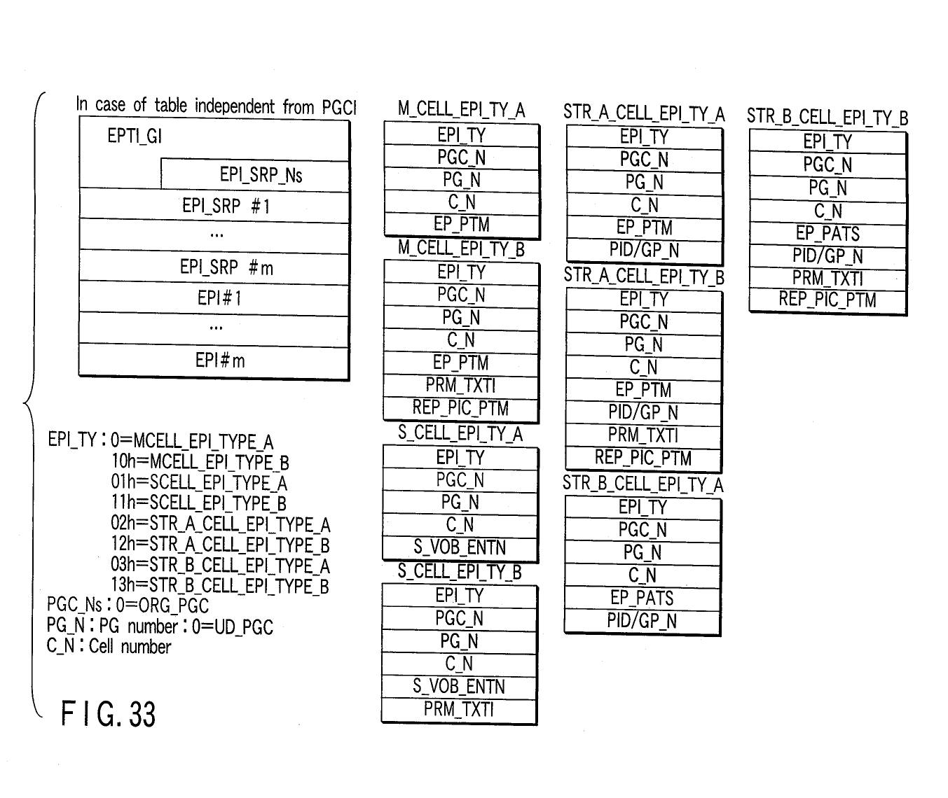

FIG. 33 shows the structure of an EPIT (entry point information table) when the EPIT exists in the HDVR_MGI. EPTI_GI is set with the number of EPI_SRPs, and each EPI_SRP is set with the start address of each EPI. There are a total of eight different types of EPI, i.e., two types each for respective CELL types.

M_CELL_EPI_TY_A includes a PGC number, PG number, CELL number, and PTM with an EP, and M_CELL_EPI_TY_B further includes PRM_TXTI (text information) and REP_PIC_PTM (thumbnail pointer).

S_CELL_EPI_TY_A includes a PGC number, PG number, CELL number, and S_VOB_ENT number with an EP, and S_CELL_EPI_TY_B further includes PRM_TXTI (text information).

STR_A_CELL_EPI_TY_A (ESOB of TYPE A) includes a PGC number, PG number, CELL number, PTM with an EP, and PID (or group number) of an ES with that EP, and STR_A_CELL_EPI_TY_B further includes PRM_TXTI (text information) and REP_PIC_PTM (thumbnail pointer).

STR_B_CELL_EPI_TY_A (ESOB of TYPE B) includes a PGC number, PG number, CELL number, PATS with an EP, and PID of an ES with that EP, and STR_B_CELL_EPI_TY_B further includes PRM_TXTI (text information) and REP_PIC_PTM (thumbnail pointer).

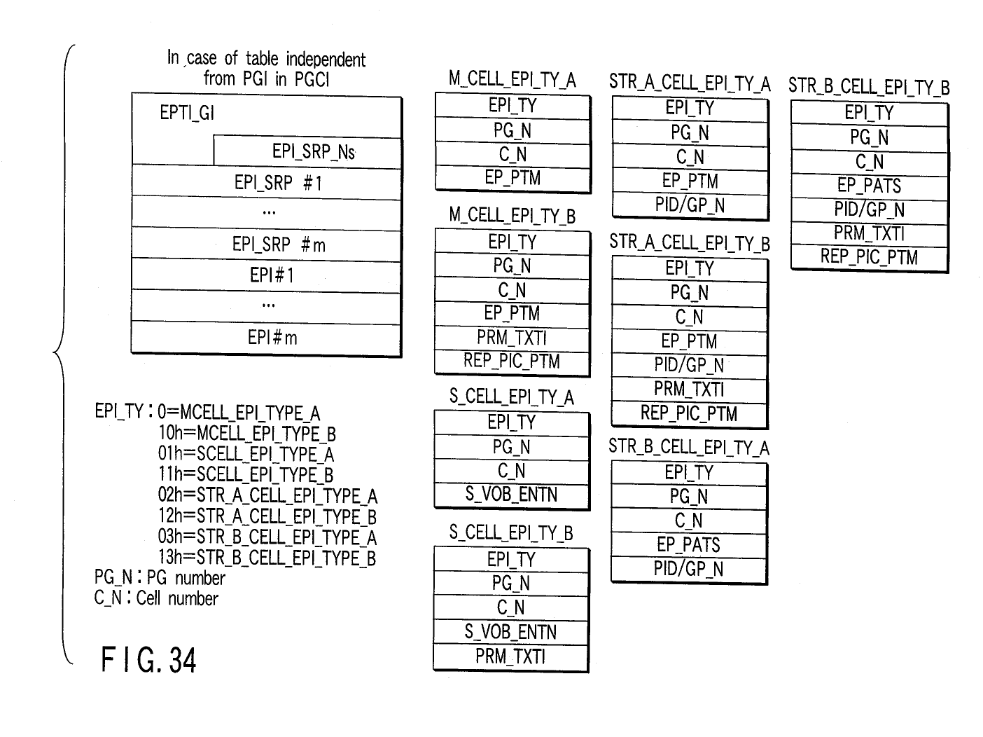

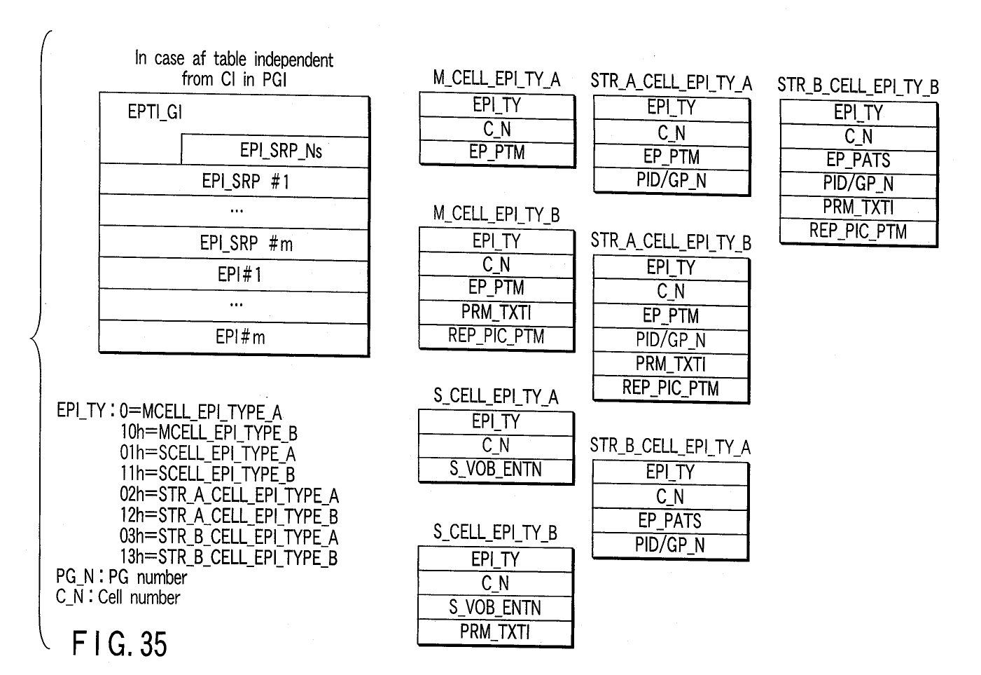

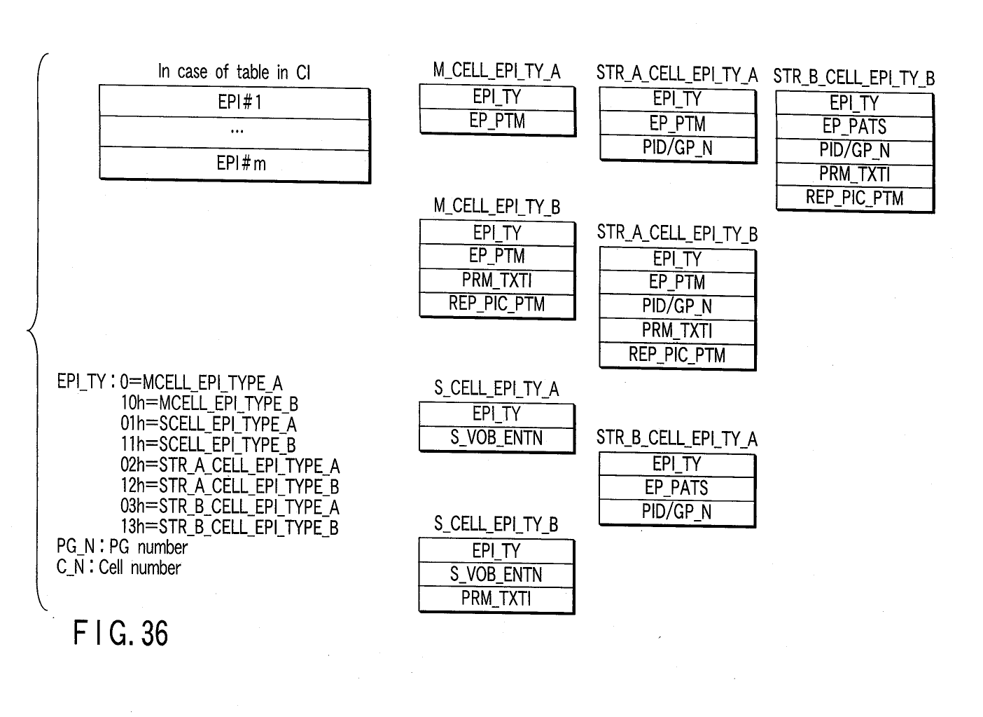

FIG. 34 shows an example of the structure when the EPIT exists in PGCI. In this structure, the PGC number is omitted from the structure shown in FIG. 33. FIG. 35 shows a case wherein the EPIT exists in PGI. In this structure, the PG number is omitted from the structure shown in FIG. 34. FIG. 36 shows a case wherein the EPIT exists in CELLI. In this structure, the CELL number is omitted from the structure shown in FIG. 35.

FIG. 37 is a view for explaining an example of the configuration of the stream object data unit (ESOBU) shown in FIG. 1 or 2. One ESOBU 143 includes one or more packet groups 147, each of which includes, e.g., 16 packs (1 pack=1 sector: 2048 bytes).

Each packet group 147 includes packet group header (404 bytes) 161, one or more (170 in this case) packet arrival time PAT (4 bytes) data 162, and one or more (170 in this case) MPEG-TS packets (188 bytes) 163 as many as the PAT data. Each MPEG-TS packet 163 has PAT 162 to be paired at its head position, and this PAT allows to detect the arrival time of each MPEG-TS (at the apparatus).

Packet group header 161 includes a header ID (00FFA5A5), packet group general information (PKT_GRP_GI), display control information (DCI) and copy generation management information (or copy control information CCI), extended bytes of a packet arrival time of the first packet (FIRST_PATS_EXT), and manufacturer's information (MNI) (or manufacturer's information MNFI).

One hundred eighty-eight-byte MPEG-TS packet 163 is paired with 4-byte PATS 162. One hundred twenty-eight-byte pack group header 161 and 170 pairs of PATS/MPEG-TS form a 32-kbyte packet group 147 (for 16 packs).

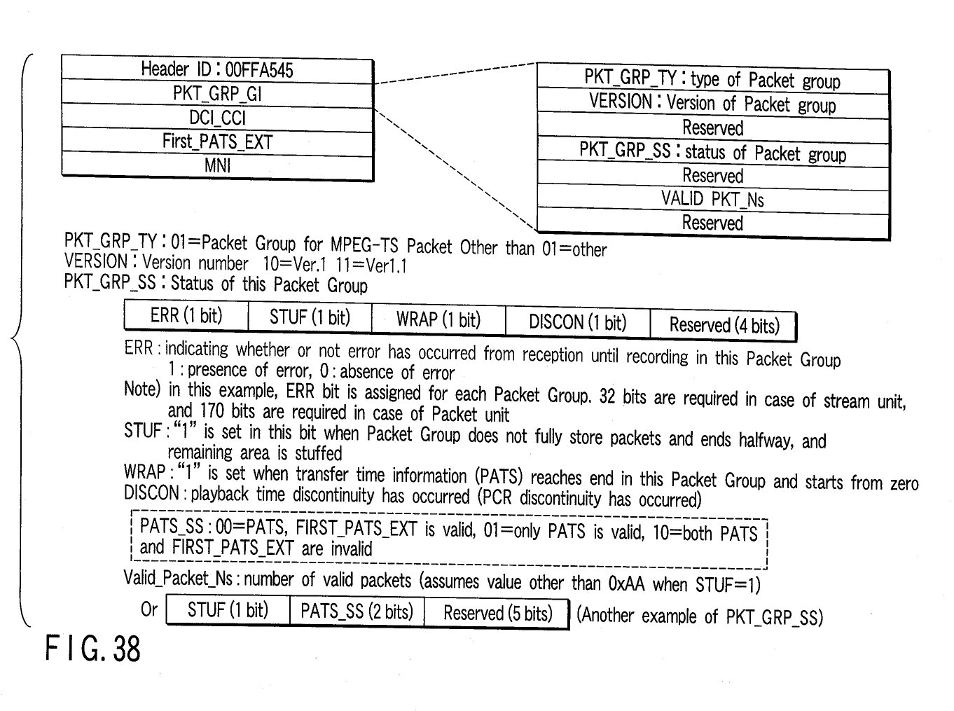

FIG. 38 is a view for explaining an example of the configuration of the PKT_GRP_GI included in the packet group header. The PKT_GRP_GI includes PKT_GRP_TY indicating the type of a packet group, VERSION indicating the version of a packet group, PKT_GRP_SS indicating the status of a packet group, and VALID_PKT_Ns indicating the number of valid packets. If a packet group is MPEG-TS, PKT_GRP_TY becomes “01”. If packet group 147 in FIG. 37 and the like is formed of packets other than MPEG-TS, PKT_GRP_TY assumes a value other than “01”.

PKT_GRP_SS can have four different status values (ERR, STUF, WRAP, DISCON) (+reserve). ERR is status indicating if an error has occurred during a period from reception to recording of a packet group. STUF is status indicating if a packet group includes a stuffed field at its end. WRAP is status indicating if transfer time information (PATS) reaches the end in this packet group and starts from zero. DISCON is status indicating if discontinuity between playback times (PCR discontinuity) has occurred.

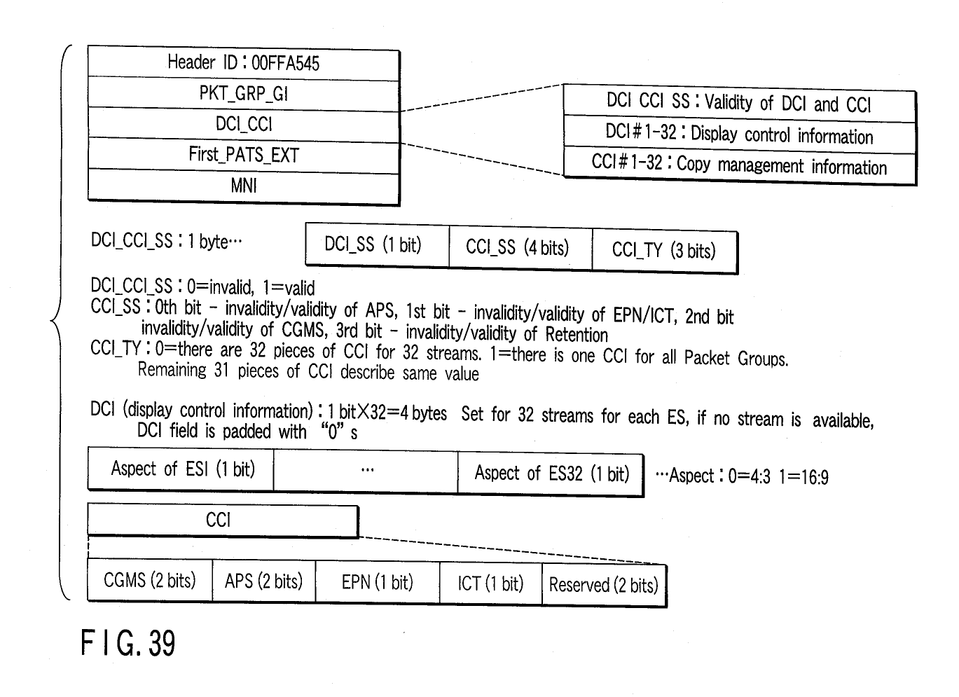

FIG. 39 is a view for explaining an example of the configuration of the DCI_CCI included in the packet group header shown in FIG. 37. Validity information (DCI_CCI_SS) has 1 byte: 1-bit DCI_SS data of that byte indicates invalid if it is “0”; and valid if it is “1”. The 0th bit of 4-bit CCI_SS data indicates the invalidity/validity of APS; the 1st bit indicates the invalidity/validity of EPN and ICT; and the 2nd bit indicates the invalidity/validity of CGMS.

Four bytes are assigned to the display control information (DCI), and DCI for 32 streams is set for each ES. If no stream is available, this DCI field is padded with “0”s. In the contents of this DCI, aspect flags (“0” indicates an aspect ratio=4:3, “1” indicates an aspect ratio=16:9) of ES1 to ES32 are allocated in turn from the head.

The copy control information (CCI) may include, with the same contents as those in ESI, digital copy control (00=copy never, 01=copy once, 11=copy free), analog copy control (00=no APS, 01=APS type 1, 10=APS type 2, 11=APS type 3), EPN (0=contents protection, 1=no contents protection), and ICT (Image_Constraint_Token: 0=analog video output resolution constraint, 1=no constraint). Note that APS is an abbreviation for “Analog Protection System”, and this embodiment assumes Macrovision®.

When a change in CCI/DCI may take place in a single packet group of a single ES, that packet group is temporarily delimited, and the remaining data of the packet group are padded with dummy data (PAT=0x01, TS packet=ALL0x00) to set the next packet group. In other words, an align process is executed to prevent CCI/DCI from changing in a packet group.

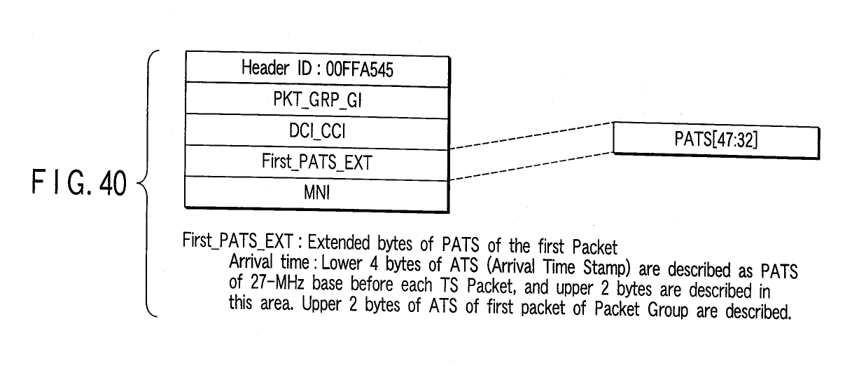

FIG. 40 is a view for explaining an example of the configuration of the FIRST_PATS_EXT included in pack group header 161 in FIG. 37. In each packet group, the lower 4 bytes of extended bytes FIRST_PATS_EXT of the packet arrival time of the first packet are described before each TS packet in that packet group as PATS of 27-MHz base. The upper 2 bytes of the FIRST_PATS_EXT are described in an area of the FIRST_PATS_EXT. As the upper 2 bytes of this FIRST_PATS_EXT, the upper 2 bytes of ATS of the first packet of a packet group are described.

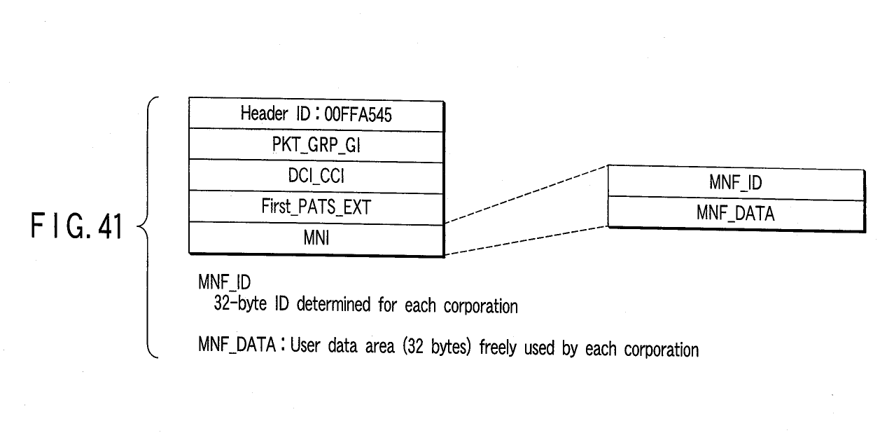

FIG. 41 is a view for explaining an example of the configuration of manufacturer's management information (MNI). This MNI includes a 32-byte ID (MNF_ID) determined for each manufacturer (corporation), and a user data area (MNF_DATA) which is freely specified by each manufacturer (corporation).

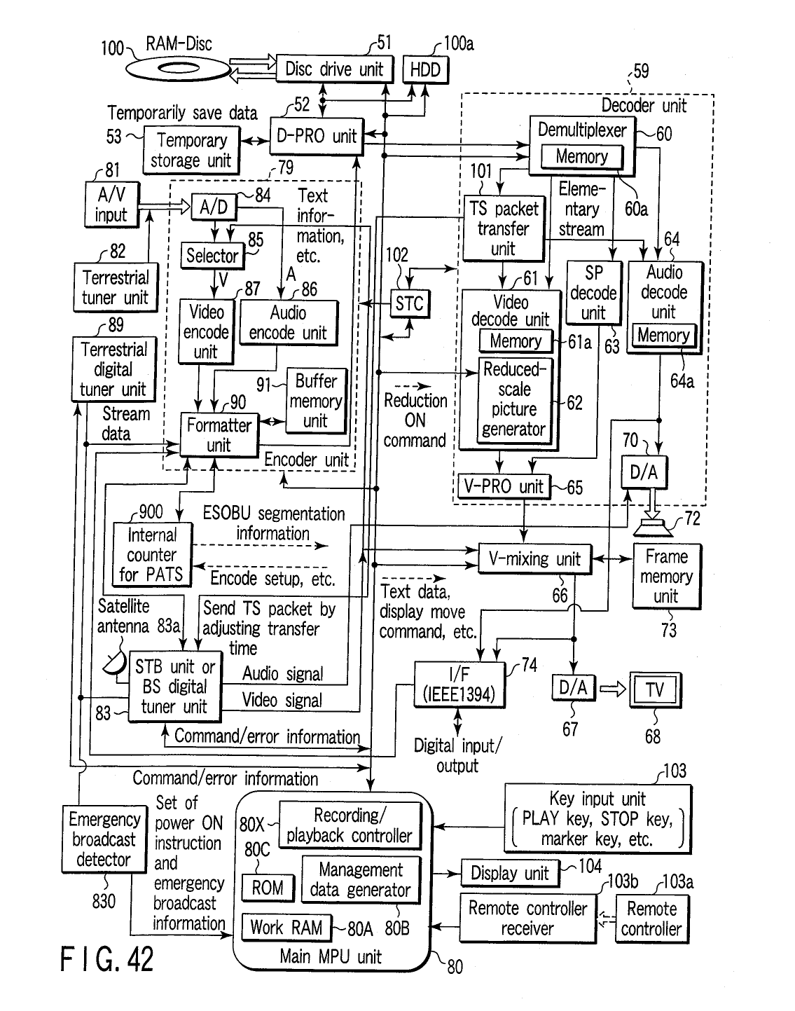

FIG. 42 is a block diagram for explaining an example of the apparatus which records and plays back AV information (digital TV broadcast program or the like) on an information storage medium (optical disc, hard disc, or the like) using the data structure according to the embodiment of the present invention. As shown in FIG. 42, this apparatus (digital video recorder/streamer) comprises MPU unit 80, key input unit 103, remote controller receiver 103b for receiving user operation information from remote controller 103a, display unit 104, decoder unit 59, encoder unit 79, system time counter (STC) unit 102, data processor (D-PRO) unit 52, temporary storage unit 53, disc drive unit 51 for recording/playing back information on/from recordable optical disc 100 (e.g., a DVD-RAM or the like), hard disc drive (HDD) 100a, video mixing (V-mixing) unit 66, frame memory unit 73, analog TV D/A converter 67, analog TV tuner unit 82, terrestrial digital tuner unit 89, and STB (Set Top Box) unit 83 connected to satellite antenna 83a. Furthermore, this apparatus comprises digital I/F 74 (e.g., IEEE1394) to support digital inputs/outputs as a streamer. Note that STC unit 102 counts clocks on a 27-MHz basis in correspondence with PAT_Base.

STB unit 83 decodes received digital broadcast data to generate an AV signal (digital). STB unit 83 sends the AV signal to TV 68 via encoder unit 79, decoder unit 59, and D/A converter 67 in the streamer, thus displaying the contents of the received digital broadcast. Alternatively, STB unit 83 directly sends the decoded AV signal (digital) to V-mixing unit 66, and can send an analog AV signal from it to TV 68 via D/A converter 67.

The apparatus shown in FIG. 42 forms a recorder comprising both the video and stream recording functions. Hence, the apparatus comprises components (IEEE1394 I/F and the like) which are not required in video recording, and those (AV input A/D converter 84, audio encode unit 86, video encode unit 87, and the like) which are not required in stream recording.

Encoder unit 79 includes A/D converter 84, video encode unit 87, input selector 85 to video encode unit 87, audio encode unit 86, a sub-picture encode unit (as needed although not shown), formatter unit 90, and buffer memory unit 91.

Decode unit 59 comprises demultiplexer 60 which incorporates memory 60a, video decode unit 61 which incorporates memory 61a and reduced-scale picture (thumbnail or the like) generator 62, sub-picture (SP) decode unit 63, audio decode unit 64 which incorporates memory 64a, TS packet transfer unit 101, video processor (V-PRO) unit 65, and audio D/A converter 70. An analog output (monaural, stereo, or AAC 5.1CH surround) from this D/A converter 70 is input to an AV amplifier or the like (not shown) to drive a required number of loudspeakers 72.

In order to display contents, whose video recording is in progress, on TV 68, stream data to be recorded is sent to decoder unit 59 simultaneously with D-PRO unit 52, and can be played back. In this case, MPU unit 80 makes setups upon playback in decoder unit 59, which then automatically executes a playback process.

D-PRO unit 52 forms ECC groups by combining, e.g., every 16 packs (or 32 packs or 64 kbytes), appends ECC data to each group, and sends them to disc drive unit 51. When disc drive unit 51 is not ready to record on disc 100, D-PRO unit 52 transfers the ECC groups to temporary storage unit 53 and waits until disc drive unit 51 is ready to record. When disc drive unit 51 is ready, D-PRO unit 52 starts recording. As temporary storage unit 53, a large-capacity memory is assumed since it must hold recording data for several minutes or longer by high-speed access. Temporary storage unit 53 may be assured by using a given area of HDD 100a. Note that MPU unit 80 can make read/write access to D-PRO unit 52 via a dedicated microcomputer bus, so as to read/write the file management area and the like.

The apparatus shown in FIG. 42 assumes optical disc 100 such as DVD-RAM/-RW/-R/Blue media (recordable media using blue laser) and the like as primary recording media, and hard disc drive (HDD) 100a (and/or a large-capacity memory card (not shown) or the like) as its auxiliary storage device.

These plurality of types of media can be used as follows. That is, stream recording is done on HDD 100a using the data structure (format) shown in FIGS. 1 to 41. Of stream recording contents which are recorded on HDD 100a, programs that the user wants to preserve directly undergo stream recording (direct copy or digital dubbing) on disc 100 (if copying is not inhibited by copy control information CCI). In this manner, only desired programs having quality equivalent to original digital broadcast data can be recorded together on disc 100. Furthermore, since the stream recording contents copied onto disc 100 exploit the data structure of the present invention, they allow easy special playback processes such as time search and the like, although they are recorded by stream recording.

A practical example of a digital recorder having the aforementioned features (a streamer/video recorder using a combination of DVD-RAM/-RW/-R/Blue media and HDD) is the apparatus shown in FIG. 42. The digital recorder shown in FIG. 42 is configured to roughly include a tuner unit (82, 83, 89), disc unit (100, 100a), encoder unit 79, decoder unit 59, and a controller (80).

Satellite digital TV broadcast data is delivered from a broadcast station via a communication satellite. The delivered digital data is received and played back by STB unit 83. This STB unit 83 expands and plays back scrambled data on the basis of a key code distributed from the broadcast station. At this time, scramble from the broadcast station is descrambled. Data is scrambled to prevent users who are not subscribers of the broadcast station from illicitly receiving broadcast programs.

In STB unit 83, the broadcast digital data is received by a tuner system (not shown). When the received data is directly played back, it is descrambled by a digital expansion unit and is decoded by an MPEG decoder unit. Then, the decoded received data is converted into a TV signal by a video encoder unit, and that TV signal is externally output via D/A converter 67. In this manner, the digital broadcast program received by STB unit 83 can be displayed on analog TV 68.

Terrestrial digital broadcast data is received and processed in substantially the same manner as satellite broadcast data except that it does not go through any communication satellite (and is not scrambled if it is a free broadcast program). That is, terrestrial digital broadcast data is received by terrestrial digital tuner unit 89, and the decoded TV signal is externally output via D/A converter 67 when it is directly played back. In this way, a digital broadcast program received by terrestrial digital tuner unit 89 can be displayed on analog TV 68. Terrestrial analog broadcast data is received by terrestrial tuner unit 82, and the received analog TV signal is externally output when it is directly played back. In this way, an analog broadcast program received by terrestrial tuner unit 82 can be displayed on analog TV 68.

An analog video signal input from external AV input 81 can be directly output to TV 68. Also, after the analog video signal is temporarily A/D-converted into a digital signal by A/D converter 84, and that digital signal is then re-converted into an analog video signal by D/A converter 67, that analog video signal may be output to the external TV 68 side. In this way, even when an analog VCR playback signal that includes many jitter components is input from external AV input 81, an analog video signal free from any jitter components (that has undergone digital time-base correction) can be output to the TV 68 side.

A digital video signal input from digital I/F (IEEE1394 interface) 74 is output to the external TV 68 side via D/A converter 67. In this way, a digital video signal input to digital I/F 74 can be displayed on TV 68.

A bitstream (MPEG-TS) input from satellite digital broadcast, terrestrial digital broadcast, or digital I/F 74 can undergo stream recording in stream object group recording area 133 (FIG. 1(d)) of disc 100 (and/or HDD 100a) as stream objects. An analog video signal from terrestrial analog broadcast or AV input 81 can undergo video recording on VR object group recording area 132 (FIG. 1(d)) of disc 100 (and/or HDD 100a) as VR objects.

Note that the apparatus may be configured to temporarily A/D-convert an analog video signal from terrestrial analog broadcast or AV input 81 into a digital signal, and to make stream recording of the digital signal in place of video recording. Conversely, the apparatus may be configured to make video recording of a bitstream (MPEG-TS) input from satellite digital broadcast, terrestrial digital broadcast, or digital I/F 74 (after it undergoes required format conversion) in place of stream recording.

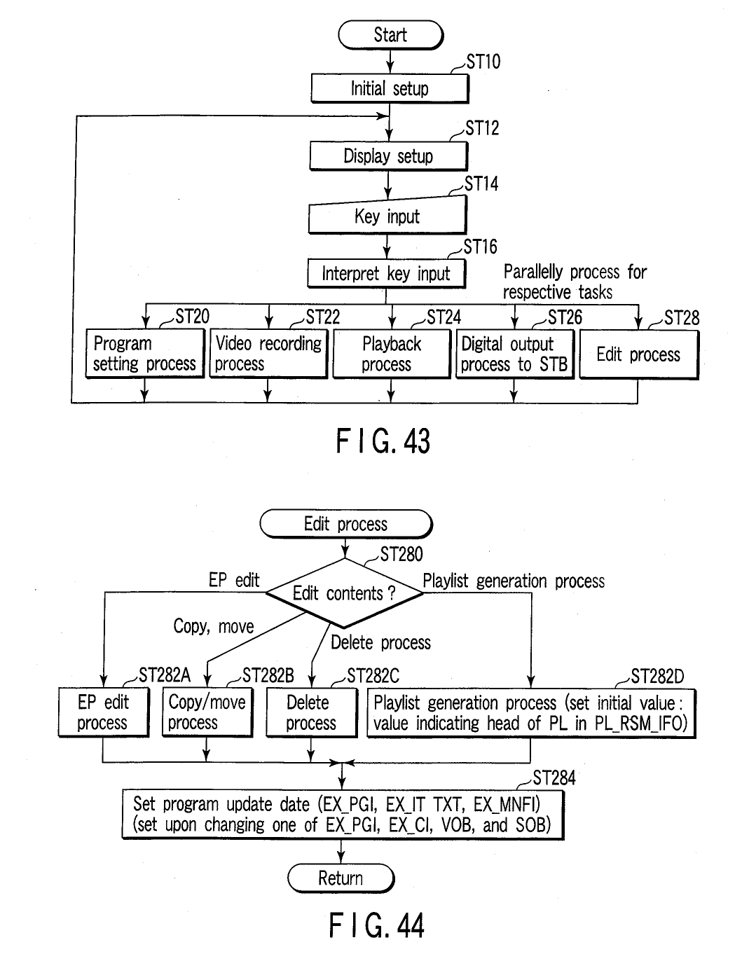

Recording/playback control of stream recording or video recording is done by main MPU unit 80 (recording/playback controller 80X) on the basis of firmware (control programs and the like corresponding to operations shown in FIGS. 43 to 68 to be described later) written in ROM 80C. MPU unit 80 has management data generation unit 80B for stream recording and video recording, generates various kinds of management information using work RAM 80A as a work area, and records the generated management information on AV data management information recording area 130 in FIG. 1(d) as needed. MPU unit 80 plays back management information recorded on AV data management information recording area 130, and executes various kinds of control (FIGS. 42 to 68) on the basis of the played back management information.

The features of medium 100 (100a) used in the apparatus of FIG. 42 will be briefly summarized below. That is, this medium has management area 130 and data areas 131 to 133. Data is separately recorded on the data areas as a plurality of object data (ESOB), and each object data includes a group of data units (ESOBU). One data unit (ESOBU) includes packet groups each of which is formed by converting a MPEG-TS compatible digital broadcast signal into TS packets and packing a plurality of packets. On the other hand, management area 130 has PGC information (PGCI) as information used to manage the playback sequence. This PGC information includes cell information (CI). Furthermore, management area 130 has information used to manage object data (ESOB).

The apparatus shown in FIG. 42 can make stream recording on medium 100 (100a) with the above data structure in addition to video recording. In this case, in order to extract program map table PMT and service information SI from a TS packet stream, MPU unit 80 has a service information extraction unit (not shown; firmware that forms management data generation unit 80B). Also, MPU unit 80 has an attribute information generation unit (not shown; firmware that forms management data generation unit 80B) that generates attribute information (PCR_pack number, PCR_LB count number, and the like) on the basis of information extracted by the service information extraction unit.

In the apparatus shown in FIG. 42, the flow of signals upon recording are, for example, as follows. That is, TS packet data received by the STB unit (or terrestrial digital tuner) are packed into packet groups by the formatter unit and the packet groups are saved on a work area (buffer memory unit 91). When the saved packet groups reach a predetermined size (CDA size or its integer multiple), they are recorded on the disc. As the operations to be executed at that time, upon reception of TS packets, a group is formed every 170 packets, and a packet group header is generated.

On the other hand, an analog signal input from the terrestrial tuner or line input is converted into a digital signal by the A/D converter. That digital signal is input to respective encoder units. That is, a video signal is input to the video encode unit, an audio signal is input to the audio encode unit, and text data of, e.g., teletext broadcasting is input to an SP encode unit (not shown). The video signal is compressed by MPEG, the audio signal is compressed by AC3 or MPEG audio, and the text data is compressed by runlength coding.

Each encoder unit packs compressed data (or segments into blocks) to form 2048-byte packets (or blocks) and inputs them to the formatter unit. The formatter unit multiplexes the packets (or blocks), and sends them to the D-PRO unit. The D-PRO unit forms ECC blocks for every 16 or 32 packets (16 or 32 blocks), appends error correction data to them, and records the packets (or blocks) on the disc via the disc drive unit.

When the disc drive unit is busy due to seek, track jump, and the like, data are stored in an HDD buffer unit, and wait until the disc drive unit is ready. Furthermore, the formatter unit generates segmentation information during video recording, and periodically sends it to the MPU unit (GOP head interrupt or the like). The segmentation information includes the number of packs (or the number of LBs) of RVOBU (ESOBU), the end address of I-picture data from the head of RVOBU (ESOBU), the playback time of RVOBU (ESOBU), and the like.

In the flow of signals upon recording, TS packet data received by the STB unit (or terrestrial digital tuner) are converted into packet groups by the formatter unit, and are saved in the work RAM. When data saved in the work RAM reach a predetermined size (CDA size or its integer multiple), they are recorded on the disc.

In the flow of signals upon playback, data are read out from the disc by the disc drive unit, undergo error correction by the D-PRO unit, and are then input to the decode unit. The MPU unit determines the type of input data (i.e., VR or SR data) (based on cell type), and sets that type in the decoder unit before playback. In case of SR data, the MPU unit determines the PMT_ID to be played back based on cell information CI to be played back, determines the PIDs of items (video, audio, and the like) to be played back based on that PMT, and sets them in the decoder unit. In the decoder unit, the demultiplexer sends TS packets to the respective decode units based on the PIDs. Furthermore, the TS packets are sent to the TS packet transfer unit, and are transmitted to the STB unit (1394 I/F) in the form of TS packets. The respective decode units execute decoding, and decoded data are converted into an analog signal by the D/A converter, thus displaying data on the TV. In case of VR data, the demultiplexer sends data to the respective decode unit according to the fixed IDs. The respective decode units execute decoding, and decoded data are converted into an analog signal by the D/A converter, thus displaying data on the TV.

Upon playback, pack data read out from the disc are interpreted by the demultiplexer. Packs that store TS packets are sent to the TS packet transfer unit, and are then sent to the decoders, thus playing back data. When pack data are transferred to the STB unit (or are transmitted to an external apparatus such as a digital TV or the like), the TS packet transfer unit transfers only TS packets at the same time intervals as they arrived. The STB unit makes decoding to generate an AV signal, which is displayed on the TV via the video encoder unit in the streamer.

An MPEG-TS scheme as a basic format common to broadcast schemes which broadcast (distribute) compressed moving picture data such as digital TV broadcast, broadcast that uses a wired network such as the Internet or the like, and so on is divided into a packet management data field and payload. The payload includes data to be played back in a scrambled state. According to ARIB, a PAT (Program Association Table), PMT (Program Map Table), and SI (Service Information) are not scrambled. Also, various kinds of management information can be generated using the PMT and SI (SDT: Service Description Table, EIT: Event Information Table, BAT: Bouquet Association Table).

The contents to be played back include MPEG video data, Dolby AC3(R) audio data, MPEG audio data, data broadcast data, and the like. Also, the contents include information required upon playback (e.g., PAT, PMT, SI, and the like) although they are not directly related to the contents to be played back. The PAT includes the PID (Packet Identification) of the PMT for each program, and the PMT records the PIDs of video data and audio data.

A normal playback sequence of the STB (Set Top Box) is as follows. That is, when the user determines a program based on EPG information, the PAT is loaded at the start time of the target program. The PID of a PMT, which belongs to the desired program, is determined on the basis of that data, and the target PMT is read out in accordance with that PID. Then, the PIDs of video and audio packets to be played back, which are included in the PMT, are determined. Video and audio attributes are read out based on the PMT and SI and are set in respective decoders. The video and audio data are extracted and played back in accordance with their PIDs. Note that the PAT, PMT, SI, and the like are transmitted at intervals of several 100 ms since they are also used during playback.

In the flow of signals upon recording, TS packet data received by the STB unit (or terrestrial digital tuner) are converted into packet groups by the formatter unit, and are saved in the work RAM. When data saved in the work RAM reach a predetermined size, they are recorded on the disc. As the operations at that time, upon reception of TS packets, a group is formed every 170 packets, and a packet group header is generated.

An analog signal input from the terrestrial tuner or line input is converted into a digital signal by the A/D converter. That digital signal is input to respective encoder units. That is, a video signal is input to the video encode unit, an audio signal is input to the audio encode unit, and text data of, e.g., teletext broadcasting is input to an SP encode unit. The video signal is compressed by MPEG, the audio signal is compressed by AC3 or MPEG audio, and the text data is compressed by runlength coding.

Each encoder unit (for VR) packs compressed data to form 2048-byte packets and inputs them to the formatter unit. The formatter unit packs and multi-plexes the packets, and sends them to the D-PRO unit.

The D-PRO unit forms ECC blocks for every 16 or 32 packs, appends error correction data to them, and records the ECC packets on the disc via the disc drive unit. When the disc drive unit is busy due to seek, track jump, and the like, data are stored in an HDD buffer unit, and wait until the disc drive unit is ready.

Furthermore, the formatter unit generates segmentation information during video recording, and periodically sends it to the MPU unit (GOP head interrupt or the like). The segmentation information includes the number of packs of RVOBU (ESOBU), the end address of I-picture data from the head of RVOBU (ESOBU), the playback time of RVOBU (ESOBU), and the like.

In the flow of signals upon playback, data are read out from the disc by the disc drive unit, undergo error correction by the D-PRO unit, and are then input to the decode unit. The MPU unit determines the type of input data (i.e., VR or SR data) (based on CELL TYPE), and sets that type in the decoder unit before playback. In case of SR data, the MPU unit determines the PMT_ID to be played back based on CELLI to be played back, determines the PIDs of items (video, audio, and the like) to be played back based on that PMT, and sets them in the decoder unit. In the decoder unit, the demultiplexer sends TS packets to the respective decode units based on the PIDs. Furthermore, the TS packets are sent to the TS packet transfer unit, and are transmitted to the STB unit (1394 I/F) in the form of TS packets. The respective decode units execute decoding, and decoded data are converted into an analog signal by the D/A converter, thus displaying data on the TV. In case of VR data, the demultiplexer sends data to the respective decode unit according to the fixed IDs. The respective decode units execute decoding, and decoded data are converted into an analog signal by the D/A converter, thus displaying data on the TV.

In order to display contents on the TV, data is sent to the decoder unit simultaneously with the D-PRO unit, and is played back. In this case, the MPU unit makes setups upon playback in the decoder unit, which then automatically executes a playback process. The D-PRO unit forms ECC groups by combining, e.g., every 16 packs, appends ECC data to each group, and sends them to the disc drive unit. When the disc drive unit is not ready to record on the disc, the D-PRO unit transfers the ECC groups to the temporary storage unit and waits until the disc drive unit is ready to record data. When the disc drive unit is ready, the D-PRO unit starts recording. As the temporary storage unit, a large-capacity memory is assumed since it must hold recording data for several minutes or longer by high-speed access. Also, a microcomputer can make high-speed read/write access to the D-PRO unit via a dedicated microcomputer bus, so as to read/write the file management area and the like.

Upon playback, pack data read out from the disc are interpreted by the demultiplexer. Packs that store TS packets are sent to the TS packet transfer unit, and are then sent to the decoders, thus playing back data. When pack data are transferred to the STB unit (or are transmitted to an external apparatus: a digital TV or the like), the TS packet transfer unit transfers only TS packets at the same time intervals as they arrived.

The STB unit makes decoding to generate an AV signal, which is displayed on the TV via the video encoder unit in the streamer.

FIG. 43 is a flowchart (overall operation process flow) for explaining an example of the overall operation of the apparatus shown in FIG. 42. In this case, data processes include five different processes, i.e., a video recording process, playback process, data transfer process (a digital output process to the STB or the like), program setting process, and edit process, as shown in FIG. 43.

For example, when the power switch of the apparatus in FIG. 42 is turned on, MPU unit 80 makes initial setups (upon factory shipment or after user's setups) (step ST10). MPU unit 80 also makes display setups (step ST12) and waits for a user's operation. If the user has made a key input from key input unit 103 or remote controller 103a (step ST14), MPU unit 80 interprets the contents of that key input (step ST16). The following five data processes are executed as needed in accordance with this input key interpretation result.

That is, if the key input is, for example, a key operation made to set timer program recording, a program setting process starts (step ST20). If the key input is a key operation made to start video recording, a video recording process starts (step ST22). If the key input is a key operation made to start playback, a playback process starts (step ST24). If the key input is a key input made to output digital data to the STB, a digital output process starts (step ST26). If the key input is a key operation of an edit process, the edit process starts (step ST28).

The processes in steps ST20 to ST28 are parallelly executed as needed for respective tasks. For example, the process for outputting digital data to the STB (ST26) is parallelly executed during the playback process (ST24). Or a new program setting process (ST20) can be parallelly executed during the video recording process (ST22) which is not timer program recording. Or by utilizing the feature of disc recording that allows high-speed access, the playback process (ST24) and digital output process (ST26) can be parallelly executed during the video recording process (ST22). Also, the disc edit process (step ST28) can be executed during video recording on the HDD.

FIG. 44 is a flowchart (edit operation process flow) for explaining an example of the contents of the edit process (ST28) shown in FIG. 43. When the control enters the edit process, the flow branches to one of four processes (one of A to D) (step ST280) in accordance with the edit contents. Upon completion of one of an entry point edit process (step ST282A), copy/move process (step ST282B), delete process (step ST282C), and playlist generation process (step ST282D), the program update date by this edit process is set in respective pieces of management information (EX_PGI, EX_IT_TXT, EX_MNFI) (step ST284).

When one of program information PGI, cell information CI, or RVOB/ESOB data has been changed, this program update date may be set. When RVOBI and/or ESOBI have/has been changed, the edit times/time (EDIT_TIME) of the RVOBI and/or ESOBI can be set in ESOB_EDIT_TIME (not shown) or the like.

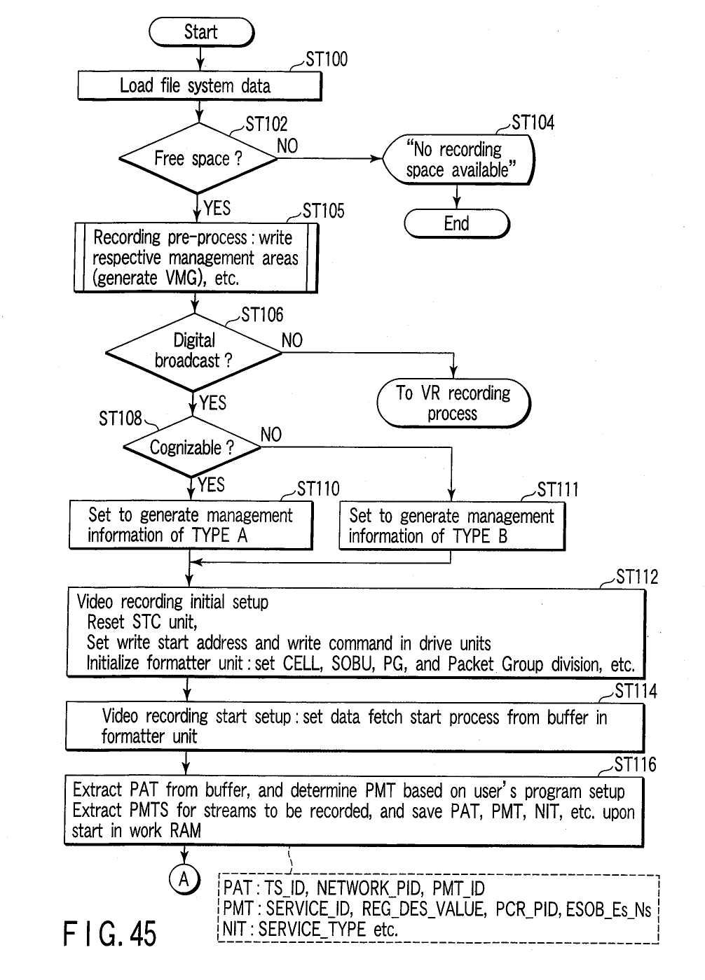

FIGS. 45 to 55 are flowcharts for explaining an example of the video recording operation of the apparatus in FIG. 42. Data processes upon stream recording are as follows.

d1) A program to be recorded is determined using EPG (Electronic Program Guide) in the program setting process, reception of that program starts, and the determined program is recorded.

d2) Upon reception of a recording command from the key input unit, the MPU unit loads management data from the disc drive unit and determines a write area. At this time, the MPU unit checks the file system (step ST100) to determine whether or not recording can be proceeded (step ST102). If recording can be proceeded, the MPU unit determines a recording position (step ST105); otherwise, the MPU unit displays a message that advises accordingly for the user (step ST104), thus aborting the recording process.

d3) If data to be recorded is digital broadcast data (step ST106) and if no error is found (step ST111), contents of the management area are set to write data in the determined area, and the write start address of video data is set in the disc drive unit, thus preparing for data recording (step ST112).

d4) It is checked if the stream of interest is cognizable (if it supports cognizance). If the stream of interest is cognizable (or it supports cognizance), the type of stream is determined as TYPE A and a video recording preparation starts; otherwise, the type of stream is determined as TYPE B and a video recording preparation is made.

d5) The time of the STC unit is reset. Note that the STC unit is a system timer, and recording/playback is done with reference to the count value of this timer.

d6) The PAT of a program to be recorded is loaded to determine the PID required to fetch the PMT of the target program. Then, the target PMT is loaded to determine the PIDs of data (video, audio) to be decoded (to be recorded). At this time, the PAT and PMT are saved in the work RAM of the MPU unit, and are written in the management information. VMG file data is written in the file system, and required information is written in VMGI.

d7) Video recording setups are made in respective units (step ST114). At this time, a segmentation setup of data and a reception setup of TS packets are made in the formatter unit. Also, the PID of data to be recorded is set to record only a target video stream. Furthermore, the buffer is set to start holding of TS packets (step ST116). Then, the formatter unit starts operation.

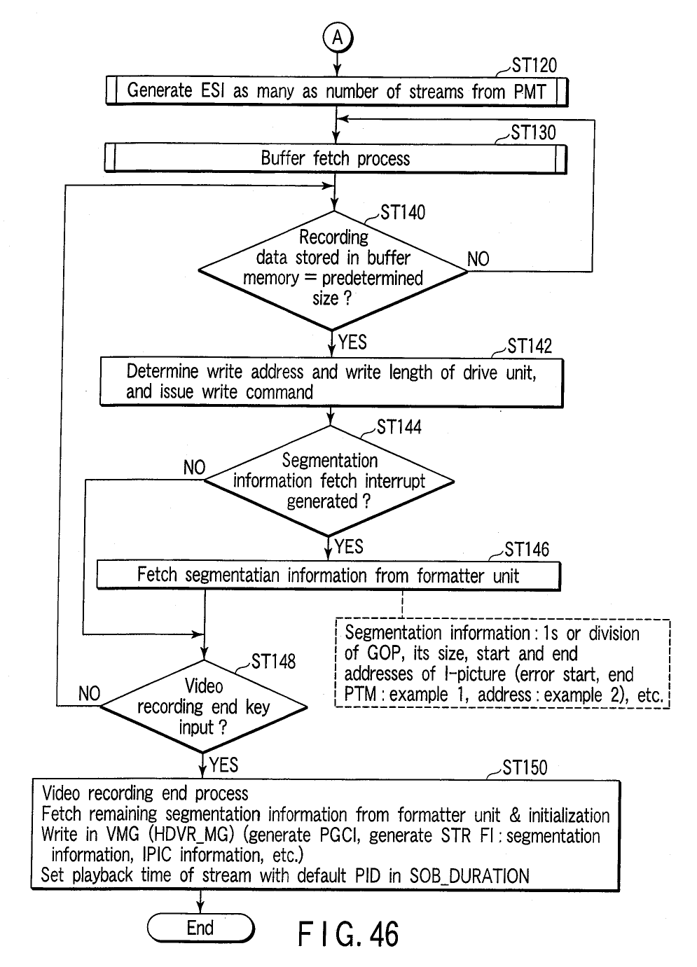

d8) ESOB_ESI is generated based on the PMT (step ST120; see FIG. 46).

d9) If data stored in the buffer reaches a predetermined size, an ECC process is done via the D-PRO unit, thus recording the data on the disc (step ST130).

d10) During video recording, segmentation information is saved in the work RAM of the MPU unit periodically (before the buffer RAM of the formatter unit becomes full of data). The segmentation information to be saved is ESOBU segmentation information, i.e., the ESOBU start address, ESOBU pack length, I-picture end address, the ESOBU arrival time (PATS), or the like may be saved.

d11) It is checked if video recording is to end (if the user has pressed a video recording end key or if no recordable space remains). If video recording is to end, remaining segmentation information is fetched from the formatter unit, and is added to the work RAM. These data are recorded in management data (VMGI), and the remaining information is recorded in the file system.

d12) If video recording is not to end, the control returns to d9) to continue the data fetch and write processes.

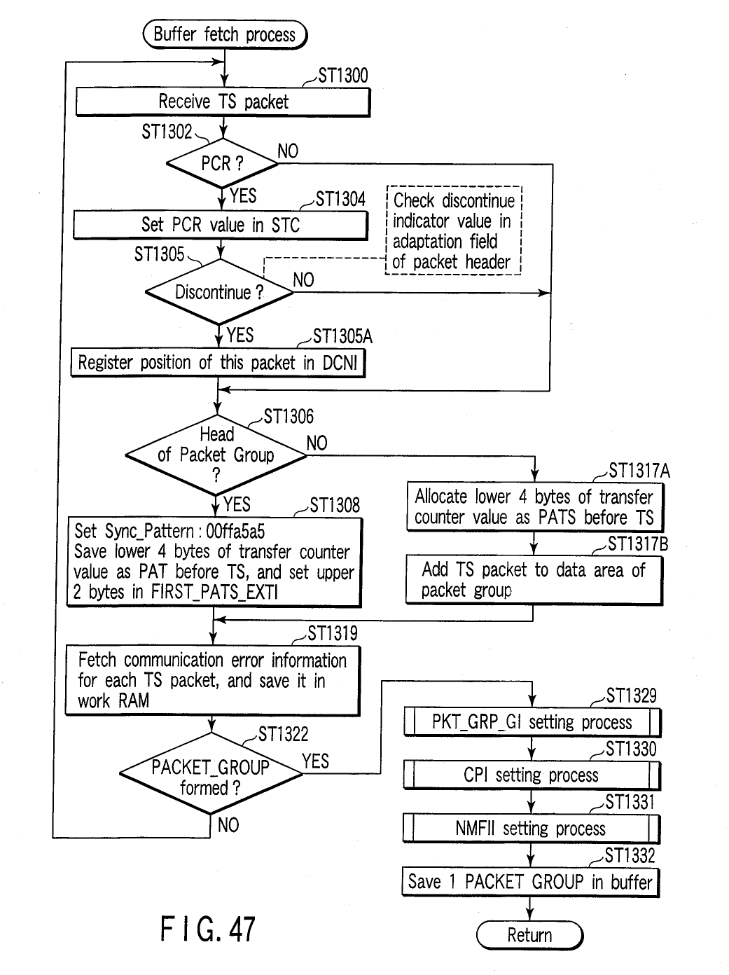

FIG. 47 is a flowchart (buffer fetch process flow) for explaining an example of the contents of the buffer fetch process (ST130). In the flow of signals upon recording, TS packet data received by the STB unit (or terrestrial digital tuner) are converted into packet groups by the formatter unit, and are saved in the work RAM. When data saved in the work RAM reach a predetermined size (CDA size or its integer multiple), they are recorded on the disc. As the operations at that time, upon reception of TS packets, a group is formed every 170 packets, and a packet group header is generated.

a1) A TS packet is received (step ST1300).

a2) If the fetched TS packet includes a PCR, the STC unit is corrected.

a3) If the TS packet includes SCR data, and the discontinuity indicator in the adaptation field in the packet header is set (discontinuity: whether or not the SCR data is discontinuous). If the SCR data is discontinuous, its position information is set in ESOB_DCNI.

a4) If the packet of interest corresponds to the head of a packet group, Sync_Pattern: 00ffa5a5a is set (step ST1308).

a5) The arrival time of the TS packet is allocated before that TS packet as PAT data (step ST1308).

a6) The fetched TS packet is set in the TS packet data area.

a7) It is checked if a packet group is formed (if 170 TS packets are grouped) (step ST1322). If NO in step S1322, the control returns to a1); otherwise, a CCI process is executed (step ST1330), and the group data is temporarily saved in the buffer RAM (step ST1332).

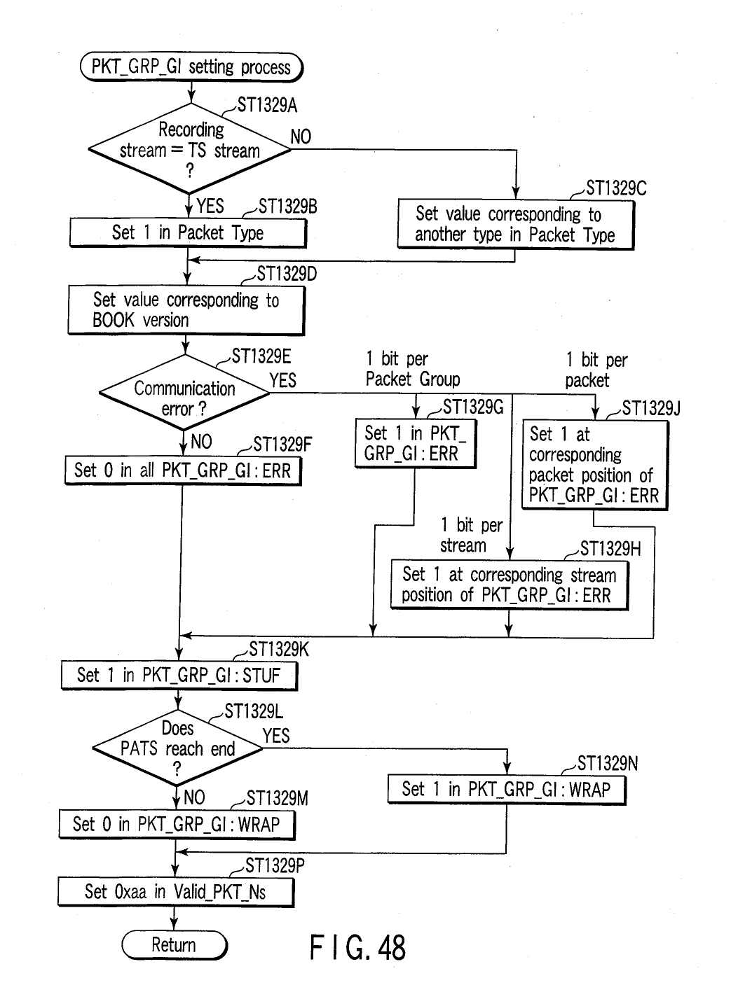

FIG. 48 is a flowchart for explaining a PKT_GRP_GI setting process during recording.

c1) The stream type which is being recorded is checked (step ST1329A). If the stream type indicates a TS stream, “1” is set in Packet TYPE (step ST1329B); otherwise, a value corresponding to each type is set (step ST1329C).

c2) Version information is set (step ST1329D).

c3) It is checked for each Packet on the basis of information from the tuner if a communication error has occurred (step ST1329E). If no error is found, the flow jumps to c5).

c4) If an error is found, the following three different error setting methods are available.

When 1 bit is set for the overall Packet Group: “1” is set in ERR (step ST1329G).

When 1 bit is set for each stream (a total of 32 bits are required): a stream that suffers an error is checked, and “1” is set in a bit in ERR corresponding to the errored stream (step ST1329H).

When 1 bit is set for each Packet (a total of 170 bits are required): a packet that suffers an error is checked, and “1” is set in a bit in ERR corresponding to the errored packet (step ST1329J).

c5) In this stage, since no dummy data is inserted, “0” is set in STUF (step ST1329K), and “170” (0xAA) is set in VALID_PKT_Ns.

c6) It is checked if the PATS reaches an end in this Packet Group (step ST1329L). If the PATS does not reach an end, “0” is set in WRAP (step ST1329M). If the PATS reaches an end, “1” is set in WRAP (step ST1329N). After that, “0xaa” is set in VALID_PKT_Ns (step ST1329P).

The CCI setting process (not shown) will be described below.

b1) It is checked if the latest PMT and EIT include copy information. If copy information is found, copy information is formed and set based on that information. After that, the control advances to b3).

b2) If the received TS packet does not include any copy information, the same information as that in the previous pack is formed as copy information.

b3) It is checked if the latest PMT and EIT include contents use descriptors. If contents use descriptors are found, the following process is made. That is, if the values of the contents use descriptors have changed in the middle of a packet group, dummy data is inserted in the previous packet group to form a new packet group after the changed position, and CCI is set based on that information.

b4) If the received TS packet does not include any copy information, CCI is formed as “copy free”.

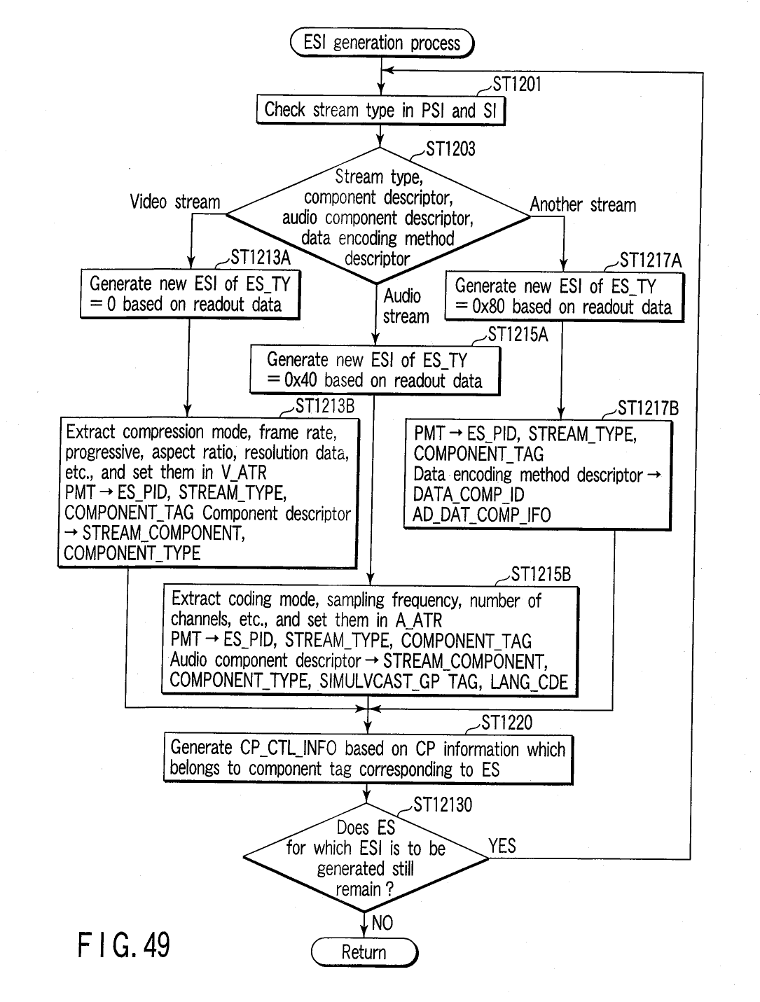

FIG. 49 is a flowchart (ESI setting process flow) for explaining an example of the contents of the stream information (ESI) generation process (ST120). ESOB_ESI can be set as follows.

f1) PSI and SI are examined to check the number of set streams (step ST1201).

f2) f4) and f5) are repeated in correspondence with the number of set streams.

f3) A stream type is checked based on PSI and SI (step ST1203) to determine if the stream of interest is a video/audio stream or another type of stream to branch the control to the next stream check processes.

f4) The stream type is categorized to MPEG1 video, MPEG2 video, MPEG1 audio, MPEG2 audio, . . . , and internal data are checked depending on the determined type to read out respective kinds of attribute information.

f5) In case of a video stream, ES_TY=0 (step ST1213A), and respective kinds of attribute information are set (especially, resolution data, aspect information, and the like are extracted) to generate V_ATR (step ST1213B). The control then advances to f8).

f6) In case of an audio stream, ES_TY=0x40 (step ST1215A), and respective kinds of attribute information are set (especially, the sampling frequency, the number of channels, and the like are extracted) to generate A_ATR (step ST1215B). The control then advances to f8).

f7) In case of another kind of stream, ES_TY=0x80 (step ST1217A), and respective kinds of attribute information are set (step ST1217B). The control then advances to f8).

f8) Copy information is extracted to generate CP_CTL_INFO (step ST1220).

f9) New ESI is set based on the attribute information, and the control returns to check the next stream (step ST1230).

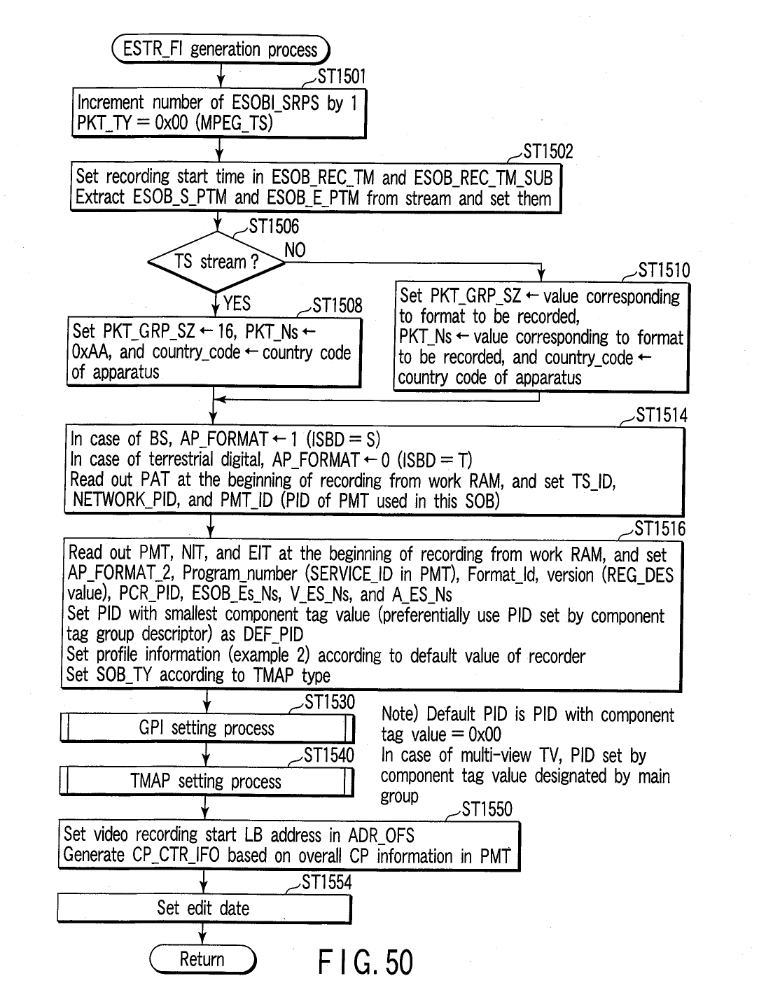

FIG. 50 is a flowchart (stream file information generation process flow with a GPI setting process and TMAP setting process) for explaining an example of a stream file information (STR_FI) generation process in the video recording end process (ST150). The STR_FI generation process will be described below with reference to FIGS. 50 to 53.

g1) The number of ESOBI_SRP# data is increased by one to add another ESOBI, an area for that ESOBI is assured, and 0: MPEG_TS is set in PKT_TY (step ST1501).

g2) The video recording time is set in ESOB_REC_TM (step ST1502). Note that the internal clock of the apparatus (FIG. 42) is set and corrected based on TDT (Time Data Table; not shown), so that an accurate time can always be obtained.

g3) Start and end PTMs are set (step ST1502).

g4) If the stream type is a TS stream (ARIB, DVB), “188” is set in AP_PKT_SZ and “16” is set in PKT_GRP_SZ (step ST1508); otherwise, values according to the broadcast scheme are set (step ST1510).

g5) MPEG_TS is set in PKT_TY.

g6) TS_ID, NETWORK_PID, and PMT_ID (the PID of the PMT used by this ESOB) are set based on the PAT (step ST1514).

g7) SERVICE_ID (Program Number in PMT) and PCR_PID are set based on the PMT (step ST1516). Furthermore, as for FORMAT_ID and VERSION, default values in the apparatus (in case of the built-in tuner) or Registration_Descriptor values sent via a digital input (in case of an external digital input) are set.

g8) Moreover, the number of recorded ESs is set. (The PMT is set with information: the number of all broadcasted ESs. However, since not all ESs are always recorded upon video recording, the number of recorded ESs is set.)

g9) The video recording start LB address is set in ADR_OFS (step ST1550), and a default PID is set. Note that the default video PID corresponds to that with a component tag value=00 or that of a stream corresponding to a component tag described in a main component group.

g10) A GPI setting process (to be described later) is executed (step ST1530), and TMAPI is generated for each stream on the basis of segmentation information (step ST1540).

g11) An edit date is set (step ST1554).

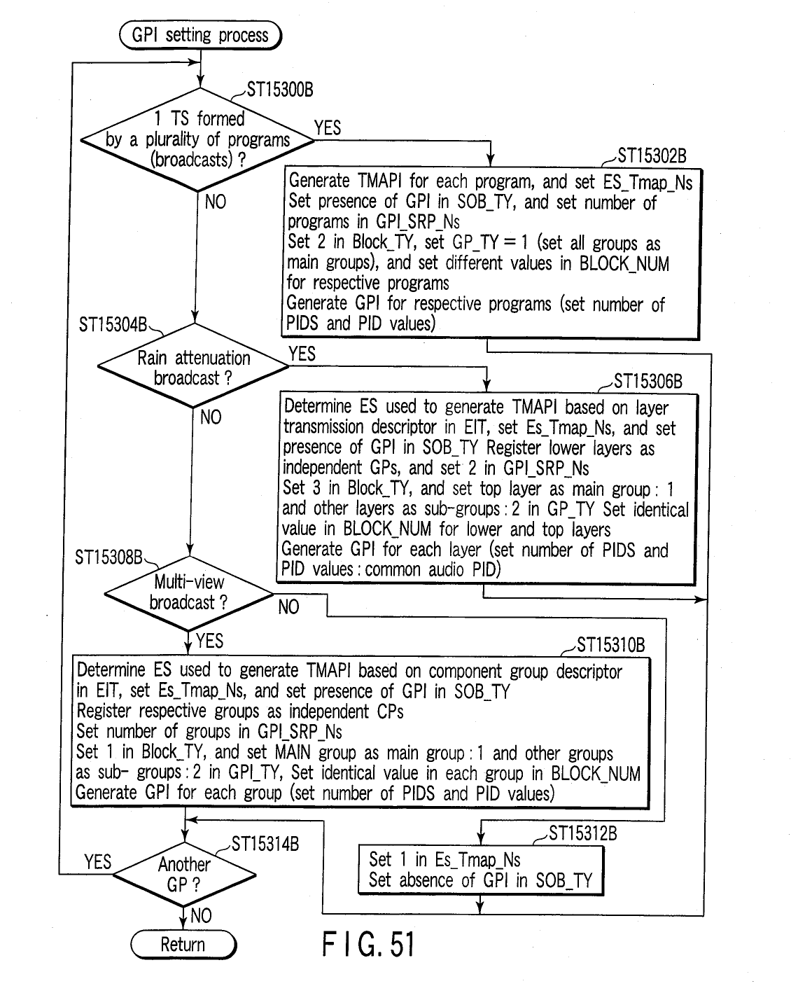

FIG. 51 is a flowchart for explaining an example (example 1) of the GPI setting process (ST1530).

h1) A stream type is checked.

h2) If a plurality of programs form one stream (YES in step ST15300B), information indicating the presence of GPI is set in ESOB_TY, GP_TY=3, all GPs are set as main groups, different numbers are set in GP_NUM in correspondence with programs, and one GPI is generated per program, thus ending this process (store the PID to be played back) (step ST15302B).

h3) In case of rain attenuation broadcast (YES in step ST15304B), information indicating the presence of GPI is set in ESOB_TY, GP_TY=2, and the top layer is set as a main group and other layers are set as sub-groups. An identical number is set in GP_NUM, and one GPI is generated per layer, thus ending this process (store the PID to be played back) (step ST15306B).

h4) In case of multi-view broadcast (YES in step ST15308B), information indicating the presence of GPI is set in ESOB_TY, GP_TY=1, and a MAIN group is set as a main group and other groups are set as sub-groups. An identical number is set in GP_NUM, and one GPI is generated per view. If no GP remains (NO in step ST15314B), this process ends (store the PID to be played back) (step ST15310B).

h5) Otherwise (NO in step ST15308B), information indicating the absence of GPI is set in ESOB_TY, and if no GP remains (NO in step ST15314B), this process ends (step ST15312B)

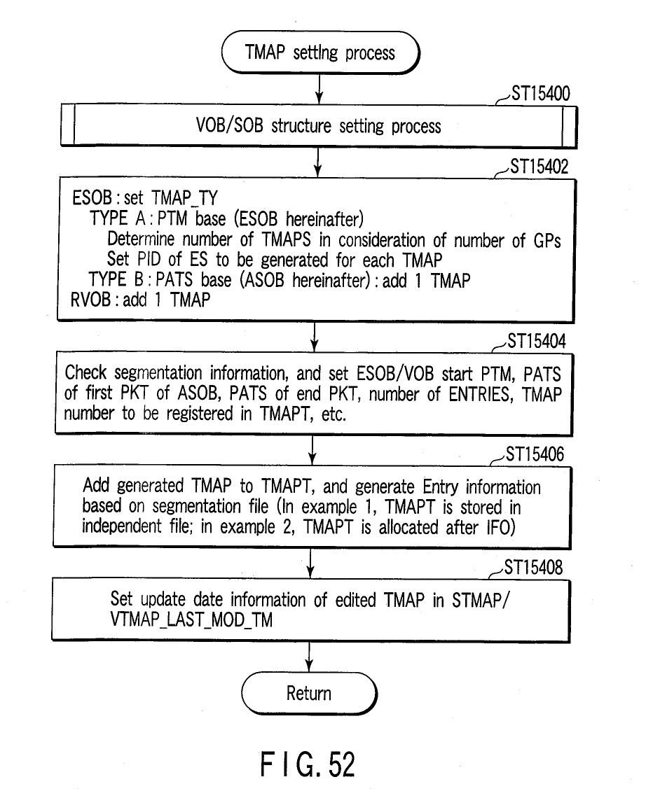

FIG. 52 is a flowchart for explaining the TMAP setting process (ST1540).

i1) The ESOB structure is determined (step ST15400).

i2) In case of TYPE A, ESs for this TMAP data are to be generated are determined in consideration of the number of GPs, the number of ESs is set as the number of TMAPs, and ES_PID is set for each TMAP (step ST15402). (However, one TMAP need not always be assigned to one GP. If no TMAP is available, the TMAP of MAIN_GP or GP with identical GP_NUM is used to implement playback, search, special playback, and the like.)

In case of TYPE B, a setting is made to add one TMAP.

i3) The ESOB start and end times (TYPE A: playback time, TYPE B: arrival time), the start and end times for each TMAP, the number of ENTRIES, and the like are set based on segmentation information (step ST15404).

i4) TMAPT data is added, and ENTRY information is generated based on segmentation information (step ST15406).

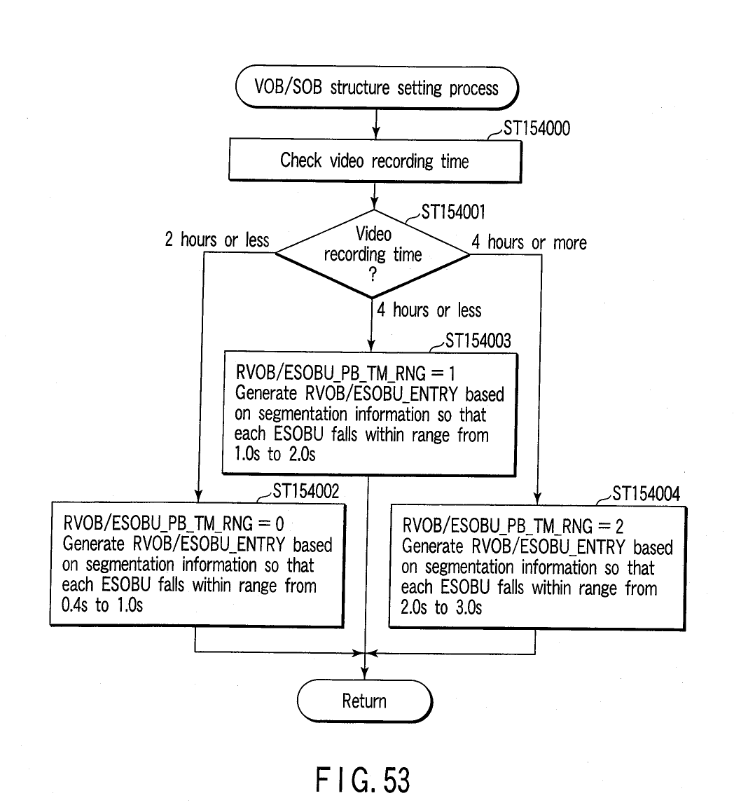

FIG. 53 is a flowchart for explaining the RVOB/ESOB structure setting process (ST15400). The RVOB/ESOB structure setting process will be described below.

j1) The recorded time is checked (step S154001). If the recorded time is equal to or shorter than two hours, the control advances to j2); if it falls within the range from two to four hours, the control advances to j3); or if it is equal to or longer than four hours, the control advances to j4).

j2) “0” is set in RVOB/ESOB_PB_TM_RNG/ASOBU_TM, and RVOBU/ESOBU_ENT/ASOBU_ENT data are generated based on segmentation information (information of 0.4 s to 1 s) so that each ESOBU has a time range of 0.4 s to 1 s (step ST154002). The control then advances to j5).

j3) “1” is set in RVOB/ESOB_PB_TM_RNG/ASOBU_TM, and RVOBU/ESOBU_ENT/ASOBU_ENT data are generated based on segmentation information (information of 1 s to 2 s) so that each ESOBU has a time range of 1 s to 2 s (step ST154003). The control then advances to j5).

j4) “2” is set in RVOB/ESOB_PB_TM_RNG/ASOBU_TM, and RVOBU/ESOBU_ENT/ASOBU_ENT data are generated based on segmentation information (information of 2.0 s to 3.0 s) so that each ESOBU has a time range of 2 s to 3 s (step ST154004). The control then advances to j5).

j5) This process ends.

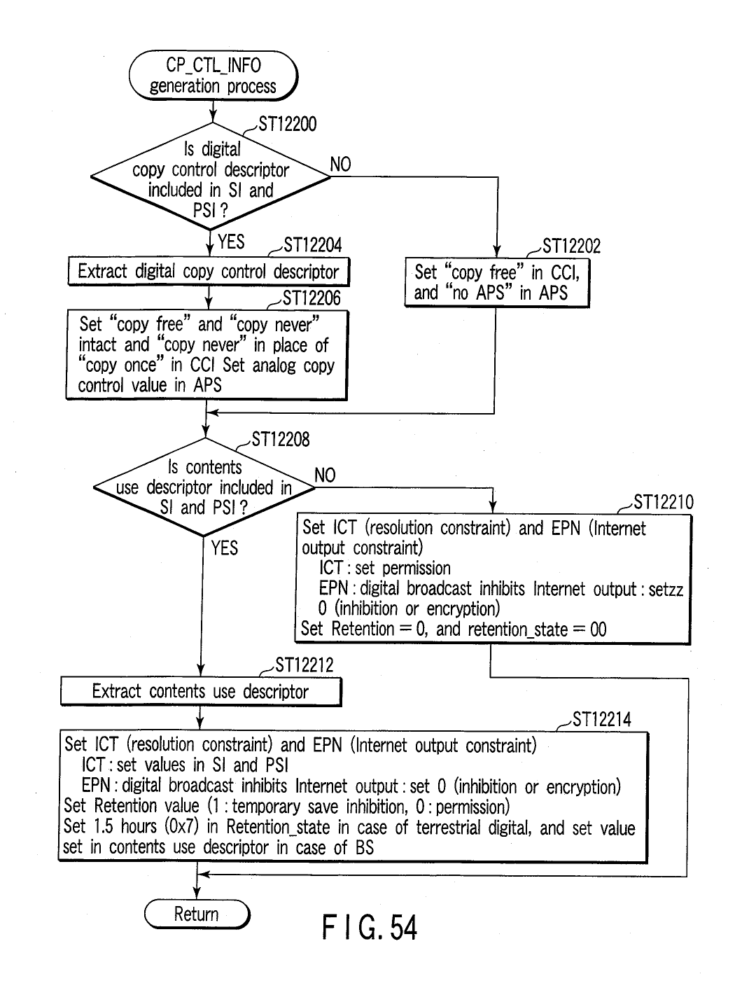

FIG. 54 is a flowchart for explaining the CP_CTL_INFO generation process (ST1220). The CP_CTL_INFO setting process will be described below.

k1) It is checked if the latest PMT and EIT include copy information (step ST12200). If copy information is found, copy information is generated based on that information (step ST12204, ST12206), and is set. The control then advances to k3).

k2) If no copy information is found, “copy free” is set (step ST12202).

k3) It is checked if the latest PMT and EIT include contents use descriptors (step ST12208). If the contents use descriptors are found, ICT and EPN are set based on their values (step ST12212, ST12214).

k4) If the received TS packet does not include any copy information, ICT and EPN are formed as “copy free”.

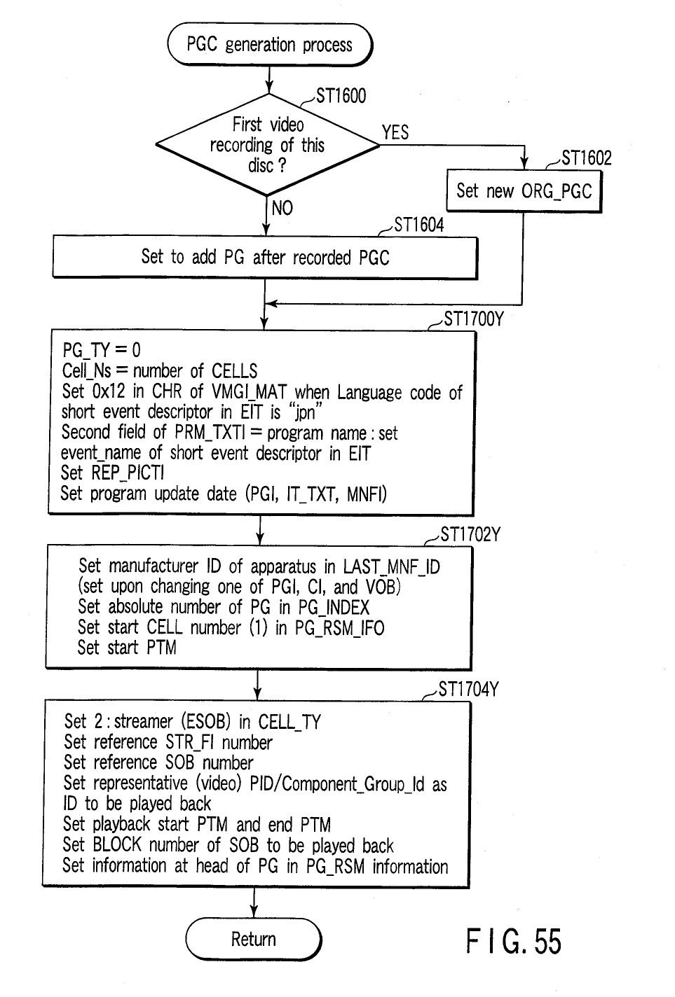

FIG. 55 is a flowchart for explaining an example of the program chain (PGC) generation process (including a program setting process) in the video recording end process (ST150). The PG generation process in this process will be described below.

m1) It is checked if a disc of interest undergoes the first video recording (step ST1600). If the disc of interest undergoes the first video recording, ORG_PGC is generated (step ST1602); otherwise, a setup is made to add PG information after the ORG_PGC (step ST1604).

m2) Erase permission: 0 is set in PG_TY, and the number of cells is set in Cell_Ns (step ST1700Y).

m3) In case of ARIB, if language_code in a short event descriptor in EIT is “jpn”, “0x12” is set in text information CHR in management information VMG_MAT, EVENT_NAME is set in the second field of primary text information PRM_TXTI, and representative picture information is set in REP_PICTI.

m4) The manufacturer ID of this apparatus is set in LAST_MNF_ID (step ST1702Y). As for this value, when PGI, CI, or RVOB has been changed, the manufacturer ID of the apparatus used to change such information is set to identify the manufacturer of the last apparatus used to execute edit and record processes. In this way, when the apparatus of another manufacturer is used to change the recorded contents of a disc, a reaction can be easily taken.

m5) The absolute number of PG is set in PG_INDEX (step ST1702Y) to allow another application software or the like to refer to each PG. Furthermore, this PG update date information is recorded. At this time, if MNFI and IT_TXT (with the same manufacturer code) supported by this apparatus are found, the update date information of corresponding data is also set.

m6) Information unique to each manufacturer is set in MNFI.

m7) Information (CELLI) indicating a streamer is set in CELL_TY (step ST1704Y).

m8) The reference ESOB number is set, the representative (video) PID or Component_Group_Id is set as the ID to be played back, and the number of pieces of EPI, playback start and end PTMs, and EPs are set (step ST1704Y).

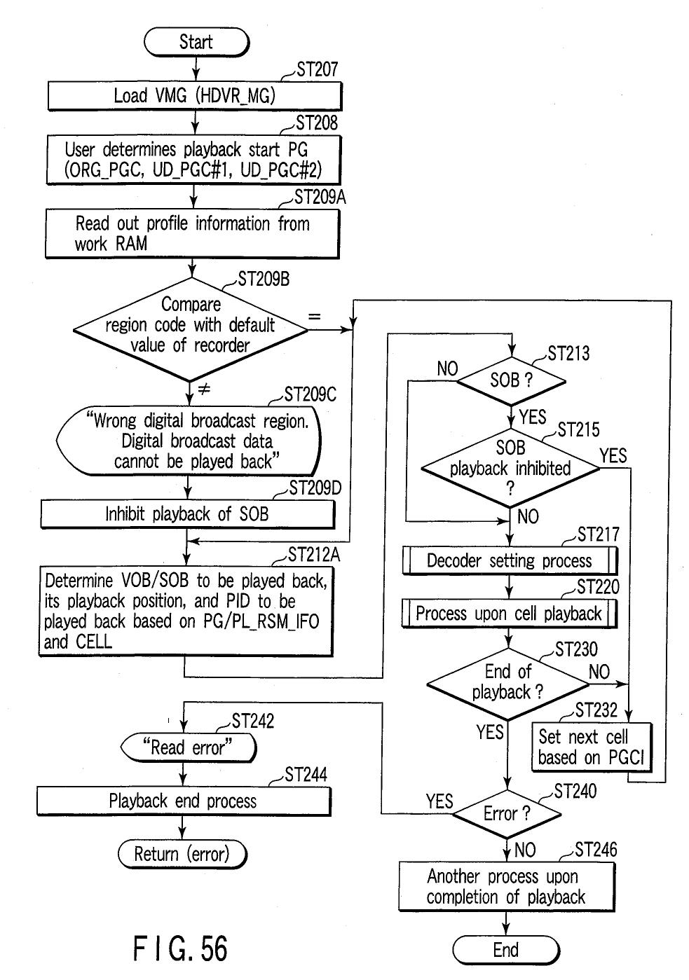

FIG. 56 is a flowchart (overall playback operation flow) for explaining an example of the playback operation of the apparatus in FIG. 42. The data processes upon playback are executed as follows (see FIGS. 56 to 65).

n1) The VMG file is loaded to determine programs to be played back (step ST207, ST208). The VMG information is stored in work RAM 80A in FIG. 42.

n2) If a playback process in the recorded order is selected, playback is made according to ORG_PGCI; if a playback process for respective programs is to be made, playback is made according to UD_PGC with a number corresponding to the program to be played back.

n3) The value of PKT_TY is read out to check if the broadcast scheme is supported. If the broadcast scheme is unsupported, a message that advises accordingly is displayed, and the process ends (or the control advances to process the next CELL).

n4) The ESOB/RVOB to be played back and the PID of that ES to be played back are determined based on PG/PL_RSM_IFO and CELLI (step ST212A), and playback start file pointer (logical address) FP is determined based on the playback start PTM. Furthermore, respective decoder units are set based on STI values to prepare for playback. Also, APS setups (e.g., APS=ON/OFF, APS type, and the like) are set in the video decoder based on CCI in the packet group header at the head position, and CGMSA setups are made in the video recorder based on digital copy control. Furthermore, if a digital output (IEEE1394, Internet, or the like) is available, 0: scramble ON or output inhibition or 1: direct output is set in the output IC based on the EPN value. If ICT=0, the image resolution is constrained, i.e., HD (high-resolution) is converted into SD (standard resolution); if ICT=1, “direct output” is set in the output IC. At this time, if the playback start frame is not I-picture data, the immediately preceding I-picture is read out and decoding starts from that I-picture, and display starts when the target frame is decoded, thus initiating normal playback.

n5) A process upon playback start is executed (step ST212A)

n6) Setups of respective decoders (to be described later) are made (step ST217).

n7) A cell playback process (to be described later) is executed (step ST220), and it is then checked if playback is to end (step ST230). If playback is to end, an error check process is executed (step ST240). If any error is found, a message that advises accordingly is displayed (step ST242); otherwise, a playback end process is executed (step ST244), thus ending this operation.

n8) If playback is not to end, the next cell is determined based on PGCI (step ST232), and the control returns to n7).

FIG. 57 is a flowchart for explaining the decoder setting process (ST217).

p1) A group to be played back is determined first, and ESs to be played back are determined in accordance with GPI (step ST2171).

p2) Attribute information (STI or ESI) is loaded (step ST2172).

p3) It is checked if the recorder can support the format of the ESs to be played back (step ST2173, ST2176). If the recorder can support the format, corresponding setups are made (step ST2174, ST2177); otherwise, mute setups are made (step ST2175, ST2178).

p4) CCI is set (step S2179).

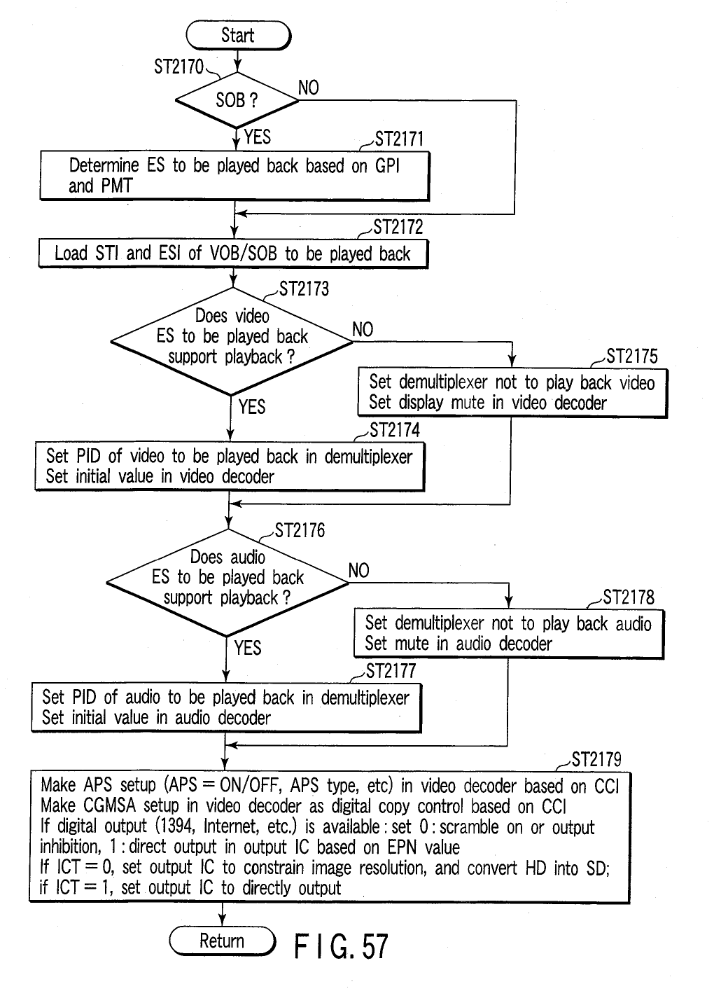

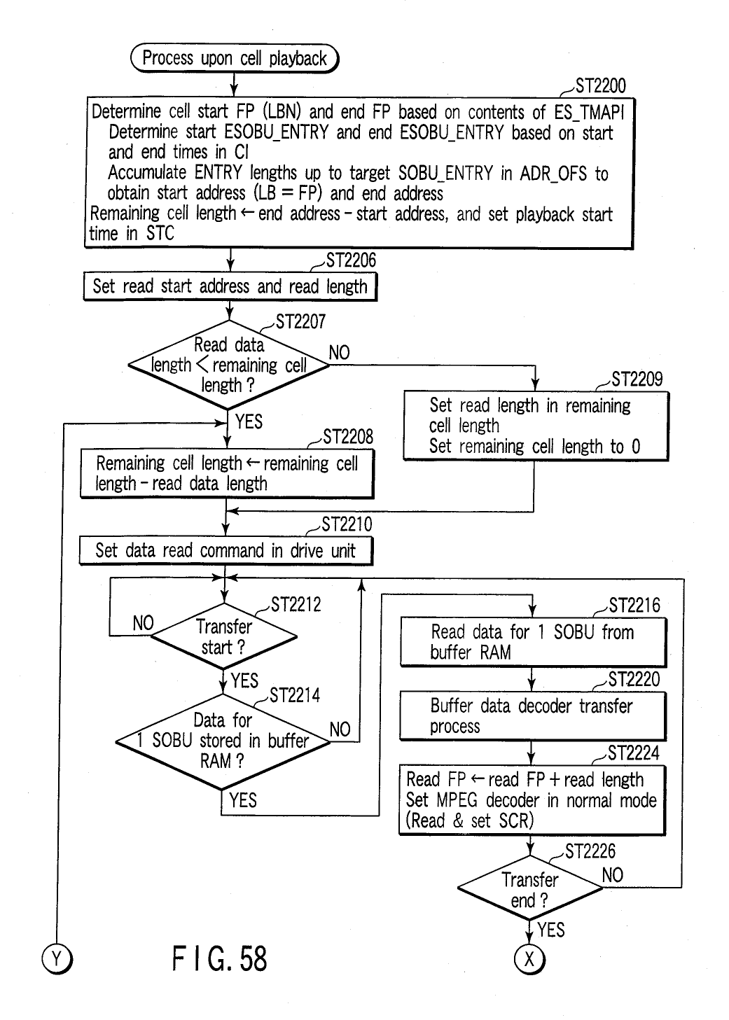

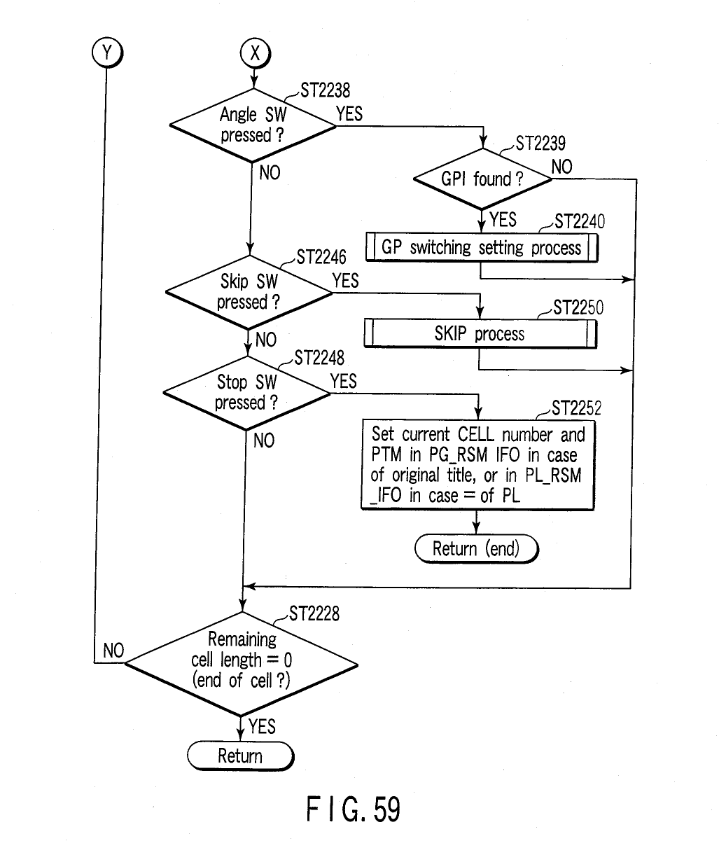

FIGS. 58 and 59 are flowcharts for explaining an example of the process (ST220) upon cell playback. The cell playback process is executed as follows.

q1) Start file pointer FP (logical block number LBN) and end address FP of a CELL are determined on the basis of the contents of TMAPI. Furthermore, start ESOBU_ENTRY and end ESOBU_ENTRY are determined based on the start and end times in CELLI, and the data lengths of ENTRIES until target ESOBU_ENTRY are accumulated in ADR_OFS, thus obtaining a start address (LB=FP) and end address. The remaining cell length is calculated by subtracting the start address from the end address, and the playback start time is set in the STC (step ST2200). The PID to be played back is determined and is set in the decoder (STB, digital tuner).

q2) A read process during playback is executed to determine the read address and read size based on the start file pointer (step ST2206).

q3) The read unit size to be read out is compared with the remaining cell length (step ST2207). If the remaining cell length is larger than the read unit size, a value obtained by subtracting the read unit size to be read out from the remaining cell length is set as the remaining cell length (step ST2208). If the remaining cell length is smaller than the read unit size, the read unit size is set to be the remaining cell length, and the remaining cell length is set to be zero (step ST2209).

q4) The read length is set to be a read unit length, and the read address, read length, and read command are set in the disc drive unit (step ST2210).

q5) The control waits until data for one ESOBU are stored. If data for one ESOBU are stored, a buffer decoder transfer process is executed (step ST2220), and the control advances to the next step.

q6) It is checked if transfer is complete (step ST2226). If transfer is complete, the control advances to the next step.

q7) It is checked if an angle key or the like has been pressed (step ST2238). If the angle key has been pressed, it is checked if GPI is available (step ST2239). If GPI is available, a GP switching process is executed (step ST2240); otherwise, the control advances to the next process without any process.

q8) It is checked if a Skip sw has been pressed (step ST2246). If the Skip sw has been pressed, a Skip process is executed (step ST2250), and the control advances to the next step.

q9) If a Stop key has been pressed (YES in step ST2248), an end process (a save process of resume information and the like) is executed (step ST2252), thus ending this process.

q10) The remaining cell length is checked (step ST2228). If the remaining cell length is not “00”, the control returns to q2); if it is “00”, this process ends.

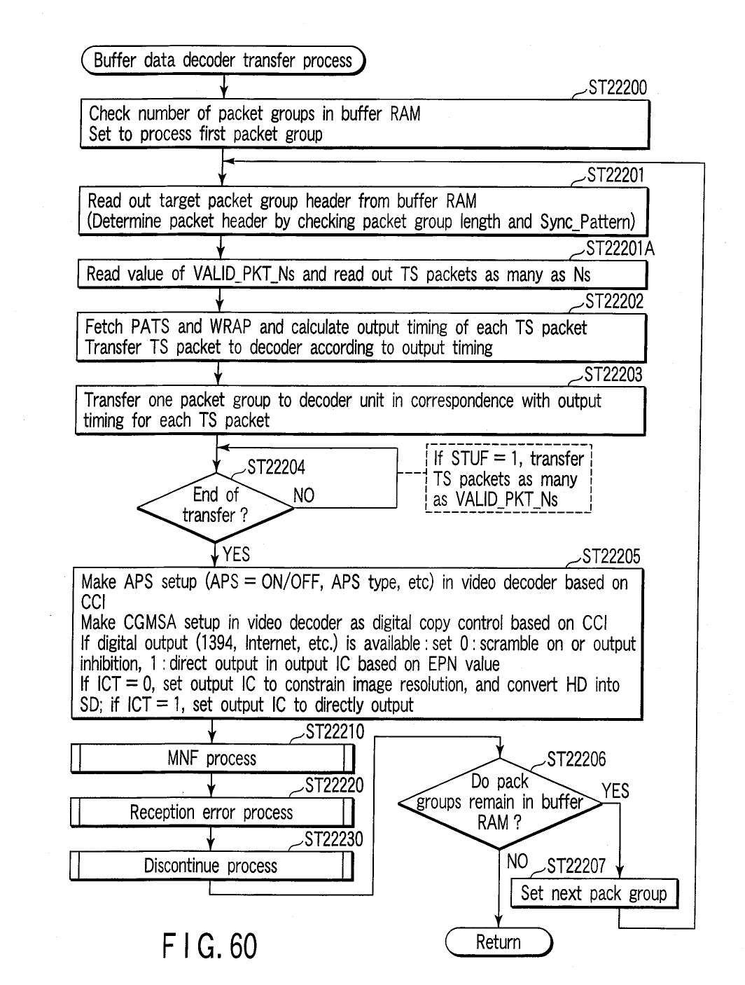

FIG. 60 is a flowchart for explaining the buffer data decoder transfer process (ST2220). The buffer data decoder transfer process will be described below.

r1) The number of packet groups in the buffer RAM is checked. If no packet group is found, this process ends. If one or more packet groups are stored, a setup is made to process the first packet group (step ST22200).

r2) A target packet group is read out from the buffer RAM (step ST22201). The head of the packet group is detected based on the packet group length and Sync_Pattern.

r3) PATS data in the packet group header is read out to check if PATS data is available (step ST22202). If no PATS is found, one packet group is sent to the decoder unit (STB, digital tuner) immediately (irrespective of time).

r4) PAT data (6 bytes) is set as the transfer time of each TS packet intact, and each TS packet is sent to the decoder unit (STB unit) at that time (step ST22203).

r5) The control waits for the end of transfer (YES in step ST22204). If transfer of TS packets is complete, APS setups (setups of APS=ON/OFF; APS type; and the like) are made in the video decoder on the basis of CCI, and digital copy control is also made based on CCI (e.g., CGMSA is set in the video decoder). Furthermore, if a digital output (IEEE1394, Internet, or the like) is available, “scramble ON”, “output inhibition”, or the like is set based on the EPN value. Moreover, the output IC of the apparatus is set to constrain the image resolution, i.e., to convert HD (high-resolution) into SD (standard resolution) if ICT=0; or to output original data if ICT=1 (step ST22205). After this output IC setup, it is checked if the packet groups remain stored in the buffer RAM (step ST22206). If no packet group remains (NO in step ST22206), this process ends.

r6) A setup is made to process the next packet group (step ST22207), and the control returns to r2).

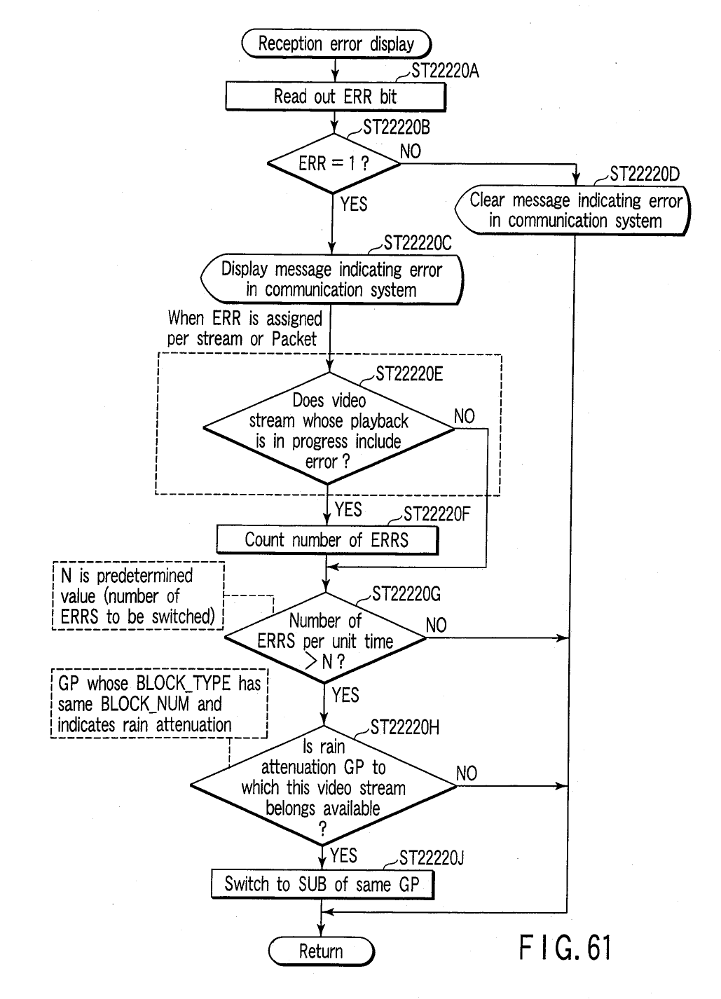

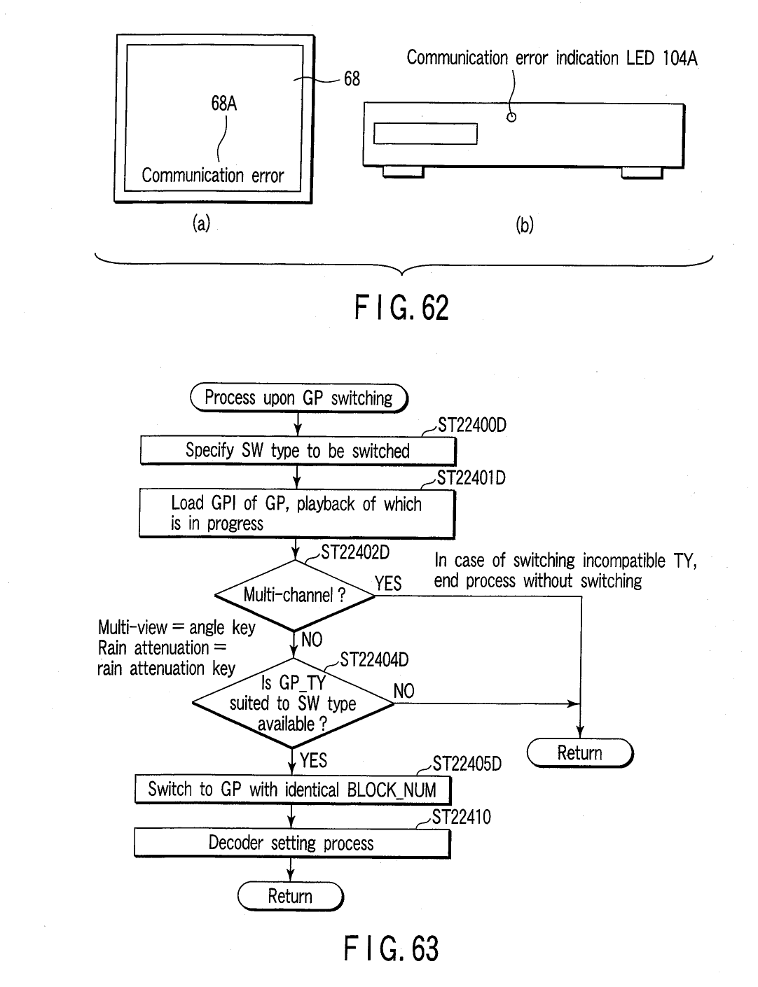

FIG. 61 is a flowchart for explaining an example of the reception error process (ST22220). FIG. 62 is a view for explaining a display example in the reception error process.

d1) ERR information in the Packet Group Header is checked (step ST22220B). If ERR is found, a message that advises accordingly is displayed for the user (step ST22220C; see 68A or 104A in FIG. 62) (when that function is enabled by an apparatus setup); otherwise, message display is turned off (step ST22220D).

d2) If ERR is set for each Packet or stream, the number of errors in a video stream, playback of which is in progress, is counted, or if ERR is set for each Packet Group, the number of errors for each Packet Group is counted (step ST22220F).

d3) If the number of errors per unit time is equal to or larger than a predetermined value (YES in step ST22220G), and if a rain attenuation GP is available (YES in step ST22220H), the video stream is switched to its SUB video (or video of a lower layer) (step ST22220J). As a result, communication errors can be distinguished from disc errors. In case of a disc error, indications of exchange of discs and cleaning of a pickup head can be given. In case of a communication error, since the control shifts to low-layer broadcast, the user can continue to watch a video (although the resolution drops). Also, in case of a chronic communication error, an indication of antenna adjustment or the like can be given. The error contents may be displayed either on a monitor (TV) or the display unit of the recorder main body.

FIG. 63 is a flowchart for explaining an example of the GP switching setting process (ST2240).

u1) The type of selector SW is checked (step ST22400D).

u2) GPI of the GP whose playback is currently in progress is loaded (step ST22401D).

u3) If the SW type is multi-channel broadcast (YES in step ST22402D), video attributes are likely to change, and the process ends without switching (in case of TY which does not support switching, the process ends without any process).

u4) If the SW type is not multi-channel broadcast (NO in step ST22402D), it is checked if GP_TY in the GP whose playback is currently in progress includes the SW type. If no SW type is available (NO in step ST22404D), the process ends without any process.

u5) If the SW type is included in GP_TY (YES in step ST22404D), it is checked if a GP with the same GP_NUM is present. If a GP with the same GP_NUM is found, GPI information is loaded to switch the current GP to that GP (step ST22405D), and a decoder setting process is executed (step ST22410).

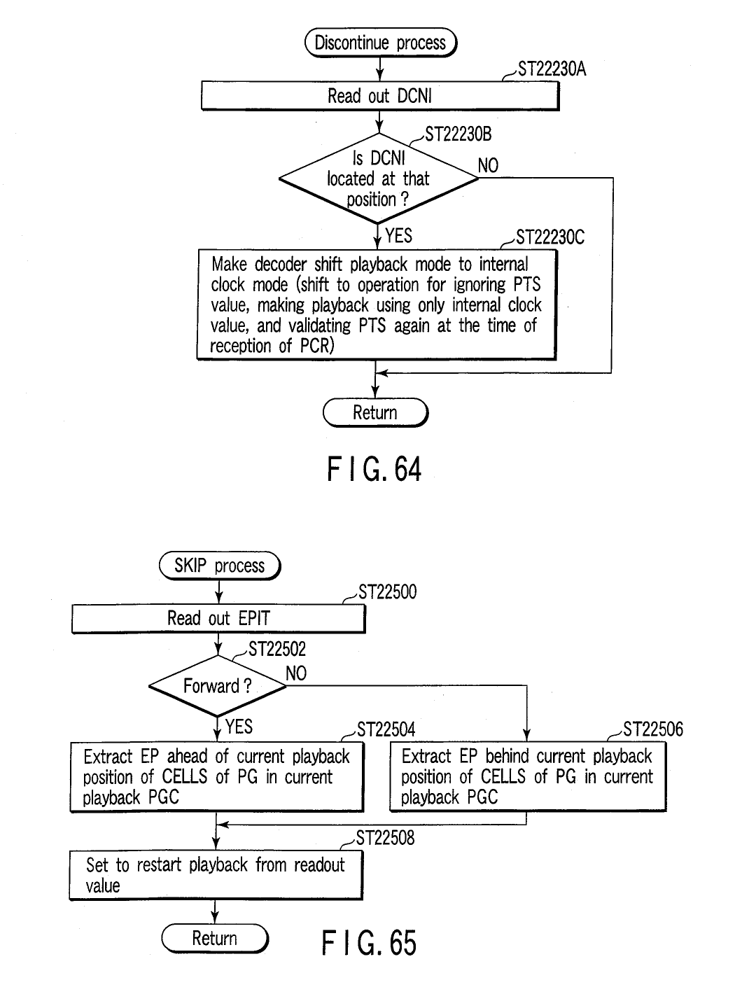

FIG. 64 is a flowchart for explaining the discontinue process (ST22230).

e1) DCNI is read out (step ST22230A) to check if the DCNI is located at the currently decoded packet position (step ST22230B). If the DCNI is located at that position, the playback mode of the decoder is shifted to an internal clock mode (step ST22230C) (an operation mode that ignores PTS values to execute playback based on only internal clock values, sets the STC based on the PCR, and enables the PTS values again: external sync mode), thus ending this process.

e2) If the DCNI is not located at that position, this process ends without any process, to thereby achieve the playback of recording in which different titles are sequentially recorded.

FIG. 65 is a flowchart for explaining an example of the SKIP process (ST2250). EPIT is read out (step ST22500). If a skip direction using marker information (EPIT) is a forward direction (YES in step ST22502), an entry point ahead of the currently played-back cell position of those of a PG in the currently played-back PGC is extracted (step ST22504). If the skip direction is a reverse direction (NO in step ST22502), an entry point behind the currently played-back cell position of those of a PG in the currently played-back PGC is extracted (step ST22506). A setup is made to start playback from a value pointed by the entry point extracted in this manner (step ST22508).

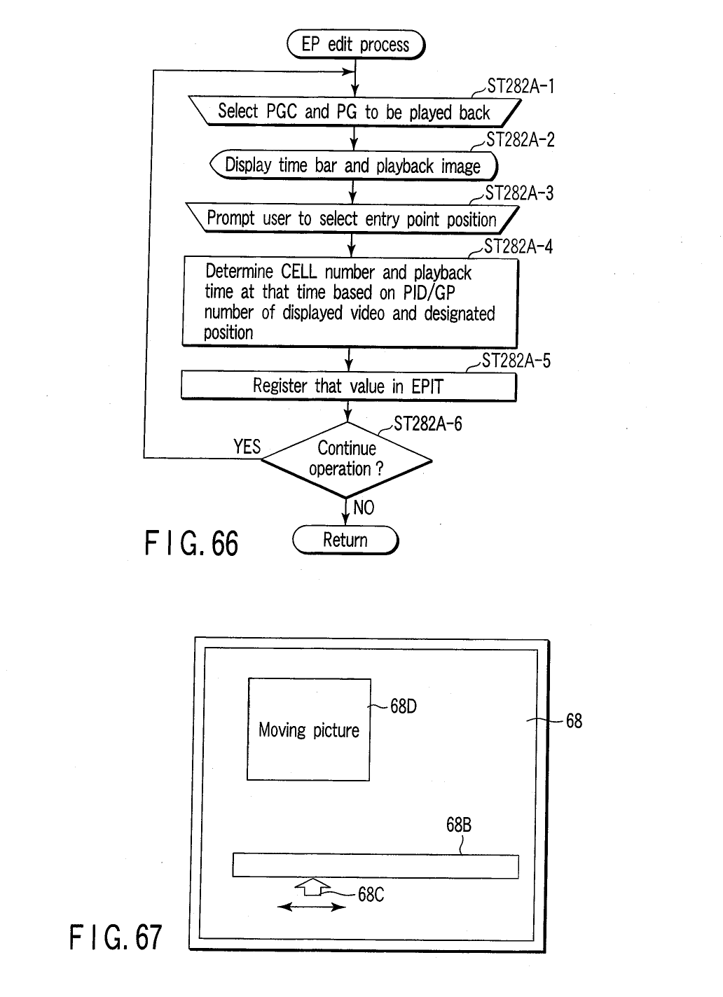

FIG. 66 is a flowchart for explaining EP edit process ST282A.

f1) A PGC and PG in which an EP is to be set is selected (step ST282A-1).

f2) The selected PG is displayed as sub-window 68D, as shown in FIG. 67, and is played back while pointing to the playback position by pointer 68C of time bar 68B (step ST282A-2).

f3) The control prompts the user to select a position where the EP is to be set (step ST282A-3).

f4) The selected position information (PGC number, PG number, CELL number, PTM, video PID) is set in EPIT (step ST282A-4, ST282A-5). In this case, if a text input is made, that value is set in PRM_TXT. Furthermore, if a thumbnail position is set, that value is set in REP_PIC_PTM. In this manner, the EP can be set.

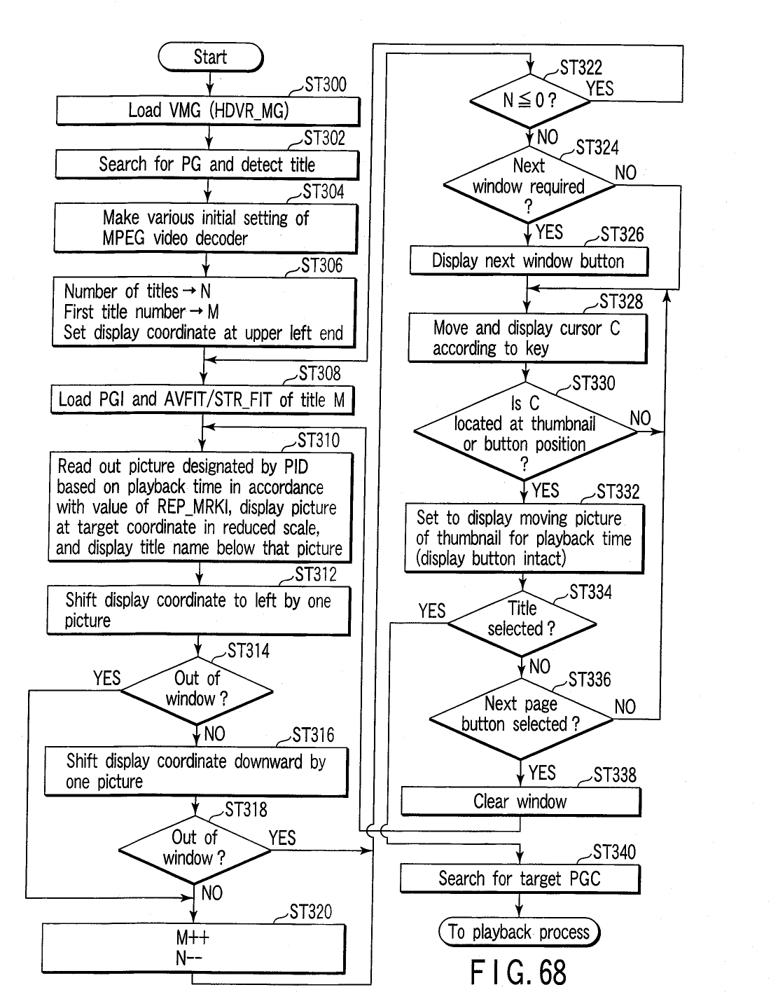

FIG. 68 is a flowchart for explaining the operation upon displaying a title menu.

v1) The VMG is read out (step ST300) to detect titles (PGs) that can be played back (step ST302).

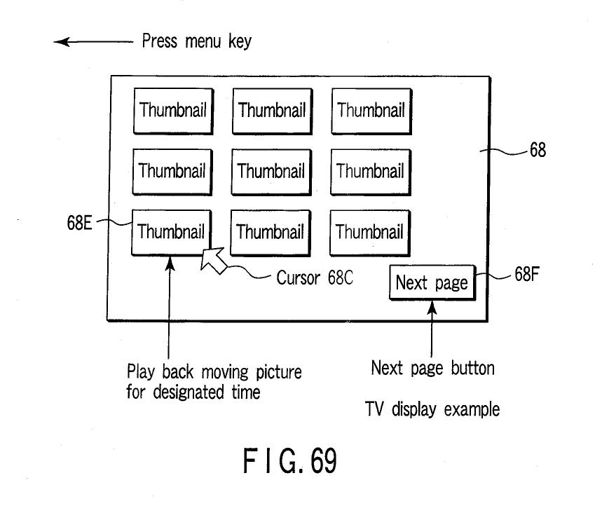

v2) Playback preparations (decoder setups, etc.) are made (steps ST304 to ST308) to set the number of titles. REP_MRKI is loaded for each title, and a video of that playback time is displayed in reduced scale at a target window position (68 in FIG. 69) (step ST310). At this time, playback is made using a video stream set by the PID.

v3) After display for one window is made, a thumbnail (68E in FIG. 69) where a cursor (68C in FIG. 69) is superposed is checked. Moving picture playback of the thumbnail superposed with the cursor is made for the playback time on that thumbnail area (step ST332).

v4) The control prompts the user to select a title. If the user selects a next page button (68F in FIG. 69) (YES in step ST336), the control returns to v2).

v5) A setup is made to play back the selected title (YES in step ST334), thus ending this process. In this manner, the flexible control operation compatible to digital broadcast can be implemented.

### SUMMARY OF EMBODIMENT

1. EPIT is recorded on an area independent from CELLI to reduce the load upon PGCI playback. In this case, PID and REP_PIC_INFO are set together with the playback position.

2. EPI is skipped in turn using the SKIP key.

### EFFECT ACCORDING TO EMBODIMENT

Marker information corresponding to each ES can be provided in stream recording.

Since the marker information is recorded on an area independent from PGCI, the load can be reduced upon editing a CELL in the PGCI process.

Note that the present invention is not limited to the aforementioned embodiments, and various modifications may be made on the basis of techniques available at that time without departing from the scope of the invention when it is practiced at present or in the future. The respective embodiments may be combined as needed as much as possible, and combined effects can be obtained in such case. Furthermore, the embodiments include inventions of various stages, and various inventions can be extracted by appropriately combining a plurality of required constituent elements disclosed in this application. For example, even when some required constituent elements are omitted from all the required constituent elements disclosed in the embodiments, an arrangement from which those required constituent elements are omitted can be extracted as an invention.

1. (canceled)

2. An information medium comprising one or more data areas configured to store object information, and a management area configured to store management information for managing the object information, wherein
one of said data areas is configured to record a stream object using a stream object unit in which are contained packet groups each including a packet group header and multiple pairs of packet arrival time information and MPEG transport stream packet, and
the management information to be stored in said management area includes stream cell information containing stream cell entry point information configured to describe a packet arrival time for an entry point within recorded contents of the stream object.

3. A method of recording information on an information medium comprising one or more data areas configured to store object information, and a management area configured to store management information for managing the object information, wherein one of said data areas is configured to record a stream object using a stream object unit in which are contained packet groups each including a packet group header and multiple pairs of packet arrival time information and MPEG transport stream packet, and the management information to be stored in said management area includes stream cell information containing stream cell entry point information configured to describe a packet arrival time for an entry point within recorded contents of the stream object, said method comprising:
recording the stream object on the data area, and
recording the management information on the management area.

4. A method of reproducing information from an information medium comprising one or more data areas configured to store object information, and a management area configured to store management information for managing the object information, wherein one of said data areas is configured to record a stream object using a stream object unit in which are contained packet groups each including a packet group header and multiple pairs of packet arrival time information and MPEG transport stream packet, and the management information to be stored in said management area includes stream cell information containing stream cell entry point information configured to describe a packet arrival time for an entry point within recorded contents of the stream object, said method comprising:
reproducing the management information from the management area, and
reproducing the stream object from the data area.

5. A recording apparatus for recording information on the information medium as defined in claim 2, said apparatus comprising:
a first recorder configured to record the stream object on the data area, and
a second recorder configured to record the management information on the management area.

6. A reproducing apparatus for reproducing information from the information medium as defined in claim 2, said apparatus comprising:
a first reproducer configured to reproduce the management information from the management area, and
a second reproducer configured to reproduce the stream object from the data area.
